(19) United States
(12) Patent Application Publication
(10) Pub. No.: US 2015/0045219 A1
(43) Pub. Date: Feb. 12, 2015

(54) ABIOTIC AND BIOTIC STRESS TOLERANCE PEPTIDES AND POLYNUCLEOTIDES, AND COMPOSITIONS AND METHODS COMPRISING THEM

(71) Applicant: New Biology, Inc., Burlingame, CA (US)

(72) Inventors: Barbara Scheer, Burlingame, CA (US); Justin Scheer, Burlingame, CA (US)

(21) Appl. No.: 14/454,374

(22) Filed: Aug. 7, 2014

Related U.S. Application Data
(60) Provisional application No. 61/863,139, filed on Aug. 7, 2013.
(60) Provisional application No. 61/951,142, filed on Mar. 11, 2014.

(51) Int. Cl. A01N 63/04; A01N 63/00; A01N 37/46

(52) U.S. Cl. CPC A01N 63/04; A01N 37/46; A01N 63/00
USPC 504/117; 504/319

(57) ABSTRACT

Compositions and methods for improving a plant's resistance to biotic and/or abiotic stress are provided, including methods of seed production comprising: (a) providing a plant or part thereof; (b) exposing the plant to a composition comprising one or more defense activators present in a concentration ranging from 0.01 mg/l to 25 g/l or from 0.25 nM to 10 mM and chosen from jasmonates, salicylic acid, chitin, acibenzolar-S-methyl, harpins, microbes, and one or more defense peptides comprising a consensus amino acid sequence:

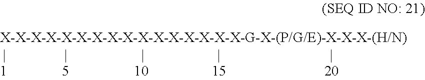

wherein:
X is an amino acid chosen from Alanine (A), Cysteine (C), Aspartic acid (D), Glutamic acid (E), Phenylalanine (F), Glycine (G), Histidine (H), Isoleucine (I), Lysine (K), Leucine (L), Methionine (M), Asparagine (N), Proline (P), Glutamine (Q), Arginine (R), Serine (S), Threonine (T), Valine (V), Tryptophan (W), or Tyrosine (Y); (c) growing the plant to produce developed seeds from the plant comprising defenses induced by the defense activators.

### CROSS-REFERENCE TO RELATED APPLICATIONS

The present application relies on the disclosure of and claims priority to and the benefit of the filing date of U.S. Provisional Application No. 61/863,139, filed Aug. 7, 2013, and U.S. Provisional Application No. 61/951,142, filed Mar. 11, 2014, the disclosure of each of which is hereby incorporated by reference herein in its entirety.

### REFERENCE TO SEQUENCE LISTING SUBMITTED IN COMPUTER READABLE FORM

The present application contains a Sequence Listing. A copy of the Sequence Listing has been submitted in ASCII format via EFS-Web and is hereby incorporated by reference herein in its entirety. The ASCII file, NEWB-101-US_ST25 was created Aug. 7, 2014, is 13.7 kilobytes in size, and is identical to the paper copy filed concurrently with this application.

### BACKGROUND OF THE INVENTION

1. Field of the Invention

The present invention relates generally to the field of improving plant health. Compositions and methods for improving a plant's resistance to biotic and/or abiotic stress are provided. More particularly, peptides and polynucleotides for increasing tolerance to abiotic and/or biotic stress in plants are provided, as well as compositions comprising them, and methods of making and using such peptides, polynucleotides, and compositions.

2. Description of Related Art

Agricultural production is limited by a combination of biotic stresses, abiotic stresses, and nutritional factors. Various studies have suggested that abiotic stress is the major factor limiting crop yields. While abiotic stress can include any environmental factor that may have an adverse effect on plant physiology, stresses due to drought, heat, cold, and salinity are thought to be most important and have been the subject of intense research. As a result of global climate change, research with the goal of making crops more resistant to drought and heat is seen as a key strategy for increasing future agricultural production. The impact of drought on the agricultural industry cannot be overstated; for example, the historic Texas drought of 2011 caused a record $5.2 billion in agricultural losses, making it the most costly drought in the world.

Genetic strategies to increase tolerance to abiotic stress in plants have primarily been conventional breeding, and more recently, genetic engineering. Conventional breeding exploits naturally-occurring genetic variability within crops or closely related wild relatives that are capable of interbreeding to provide enhanced physiological traits that provide resistance to particular stresses such as drought. In the age of genomics, plant breeders today also utilize molecular markers to assist with the breeding process. Genetic engineering is the process of isolating specific genes that confer favorable tolerance characteristics and inserting them into crops. However, both approaches have yielded limited success despite extensive research and development. For example, Pioneer Hybrid International has reported only a 5% yield advantage under drought conditions for conventionally-bred corn varieties. In addition, despite a dramatic increase in the number of field trials for genetically-engineered crops over the past 5 years, only one genetically-engineered drought-resistant corn variety has been improved (Monsanto's DroughtGuard, 2011). Monsanto reported a reduction of losses due to drought of around 6%. Further, these research and development approaches require a considerable investment in time, often taking 10-15 years before they are ready for commercialization or regulatory approval. Thus, there is a need for improved technologies for conferring drought resistance in crops.

Plants mount defenses to abiotic and biotic stressors by sensing a stress and responding with changes in signaling pathways that elicit the production of protective factors. Plants can use multiple signaling pathways in response to a stress, and they may be unique to a particular stress condition or used in response to multiple stress conditions. For example, the signaling molecule jasmonic acid is involved in responses to an array of biotic and abiotic stressors, and the 18 amino acid polypeptide hormone systemin has been shown in induce a number of defense genes in tomato and other members of the Solanaceae family. In contrast, transcriptome profiling studies have shown that plants subjected to different abiotic stress conditions including heat, drought, salt, light, cold, or mechanical stress had somewhat unique responses with little overlap in transcript expression between conditions. Drought stress in particular has been shown to rely on the interaction of multiple defense genes.

A number of plant defense peptides have been identified in non-Solanaceous species. These include AtPep1, described in U.S. Patent Published Application No. US 20130061352, which is incorporated herein by reference in its entirety. AtPep1 is a 23 amino acid peptide that has been characterized as having antipathogen activity. An ortholog in maize, ZmPep1, has been also identified as having antipathogen activity (Huffaker et al. (2005) Plant Physiol 155(3):1325-1338). ZmPep1 belongs to a five gene family, the peptide sequences and public accession numbers of which are shown in the table of FIG. 1. The Zea mays plant elicitor peptide (PEP) family consists of the 23 amino acid peptides ZmPep1-ZmPep5, and its family member ZmPep3 has been identified as regulating anti-herbivore responses (Huffaker et al. (2013) PNAS 110(14):5707-5712). ZmPep3 has several notable structural differences from AtPep1, including:

Position 12: ZmPep3 includes a glutamic acid residue (negatively charged side chain) at position 12. AtPep1 provides for an arginine (positively charged side chain), or alanine (hydrophobic side chain) at this position.

Position 9: ZmPep3 includes a cysteine at position 9. AtPep1 provides for a glycine at this position, which lacks a sulfhydyl group.

Position 23: ZmPep3 has an asparagine at position 23 and AtPep1 has a histidine.

However, there are no publications to date that teach or suggest abiotic stress tolerance activity of ZmPep1 or ZmPep3. Additionally, U.S. Pat. Nos. 5,776,860; 5,814,581; 6,093,683; 6,271,176; 8,013,226; 8,115,053; 8,507,756; and 8,563,839, as well as U.S. Published Patent Application Nos. 2009/0082453; 2009/0133166; and 2014/0066308, and as well as Japanese Patent No. 2002-047104 disclose compositions for and/or methods of treating plants, which may also be instructive.

### SUMMARY OF THE INVENTION

An embodiment provides for an isolated polynucleotide that encodes a ZmPep1 or ZmPep3 polypeptide. The polynucleotide may be isolated from genomic DNA, or synthesized based on genomic DNA. An additional embodiment provides for a transgenic plant comprising the isolated polynucleotide. In the context of this specification, the term “comprising” may be used to describe one or more features of embodiments of the invention, however, such embodiments are also understood as alternatively “consisting of” the recited features. For example, a polypeptide described in this specification as comprising certain amino acids is understood as alternatively being described as consisting of those amino acids.

According to another embodiment, the isolated polynucleotide may encode one more stress tolerance peptides including ZmPep1 or ZmPep3. An additional embodiment provides for a transgenic plant comprising one or more of the stress tolerance peptides.

According to another aspect, an isolated polypeptide is provided that comprises a 23 amino acid peptide motif, where the 23 amino acid peptide motif consists of a glutamic acid residue at position 12, a cysteine at position 9, and an asparagine at position 23, and the polypeptide causes a change of at least 0.2 pH units at a concentration of 25 nM/ml in a plant cell suspension. Embodiments also provide a transgenic plant comprising the isolated polypeptide.

According to another embodiment, the isolated polypeptide may encode one more stress tolerance peptides including ZmPep1 or ZmPep3. An additional embodiment provides for a transgenic plant comprising one or more of the stress tolerance peptides.

According to a further embodiment, the polypeptide is a propeptide. In a preferred embodiment, the propeptide may comprise one or more stress tolerance peptides including ZmPep1 or ZmPep3. Embodiments include a transgenic plant comprising the propeptide.

According to another embodiment, the propeptide may be processed in a plant to produced one or more stress tolerance peptides including ZmPep1 and ZmPep3.

According to another aspect, an isolated polynucleotide is provided that encodes a polypeptide comprising a stress tolerance peptide receptor protein, where the stress tolerance peptide receptor protein may include GRMZM2G011806 or GRMZM2G128602. An additional embodiment provides for a transgenic plant comprising the isolated polynucleotide.

According to an additional embodiment, an isolated polypeptide is provided that comprises a stress tolerance peptide receptor protein, where the stress tolerance peptide receptor protein may include GRMZM2G011806 or GRMZM2G128602. An additional embodiment provides for a transgenic plant comprising the isolated polypeptide.

According to a further embodiment, the transgenic plant may further comprise one or more stress tolerance peptides including ZmPep1 and ZmPep3. According to another embodiment, an isolated polynucleotide is provided that encodes a polypeptide comprising a 23 amino acid peptide motif, where the 23 amino acid peptide motif consists of a glutamic acid residue at position 12, a cysteine at position 9, and an asparagine at position 23, and the polypeptide causes a change of at least 0.2 pH units at a concentration of 25 pM/ml in a plant cell suspension, where the isolated polynucleotide further comprises a promoter, where the expression of the isolated polynucleotide in a cell of a plant causes the plant to exhibit an improvement compared to a control plant lacking the polynucleotide. The improvement for example may be an improved yield of plant product, reduced abiotic stress symptoms, or enhanced tolerance to abiotic stress.

According to an additional embodiment, a composition is provided comprising one or more stress tolerance peptides and a biologically acceptable carrier. The one or more stress tolerance peptides may include ZmPep1 or ZmPep3, or both ZmPep1 and ZmPep3, or one or more of their analogues, homologs, paralogs, orthologs, equivalogs, fragments, variants, fusion proteins (otherwise referred to as heterologous fusion polypeptide), peptidomimetics, or other derivatives, and combinations thereof. In a further embodiment, a plant is provided where the plant has been treated with one or more composition of the invention, such as where a surface of the plant has been treated. In yet a further embodiment, a seed is provided that has been treated with one or more composition of the invention, such as where the surface of a seed is treated.

According to embodiments, a method of protecting a plant against abiotic stress is provided, comprising contacting a plant with a composition comprising an effective amount of ZmPep1, ZmPep3, or both ZmPep1 and ZmPep3, or one or more of their analogues, homologs, paralogs, orthologs, equivalogs, fragments, variants, fusion proteins, peptidomimetics, or other derivatives, or combinations thereof.

Embodiments also provide, a method of protecting a plant against abiotic stress is provided, comprising contacting a seed of a plant with a composition comprising an effective amount of ZmPep1, ZmPep3, or both ZmPep1 and ZmPep3, or one or more of their analogues, homologs, paralogs, orthologs, equivalogs, fragments, variants, fusion proteins, peptidomimetics, or other derivatives, or combinations thereof.

Additional embodiments provide for a method of protecting a plant against abiotic stress is provided, comprising contacting a leaf of a plant with a composition comprising an effective amount of ZmPep1, ZmPep3, or both ZmPep1 and ZmPep3, or one or more of their analogues, homologs, paralogs, orthologs, equivalogs, fragments, variants, fusion proteins, peptidomimetics, or other derivatives, or combinations thereof.

According to an additional embodiment, a method of protecting a plant against abiotic stress is provided, comprising contacting a stem of a plant with a composition comprising an effective amount of ZmPep1, ZmPep3, or both ZmPep1 and ZmPep3, or one or more of their analogues, homologs, paralogs, orthologs, equivalogs, fragments, variants, fusion proteins, peptidomimetics, or other derivatives, or combinations thereof.

Other embodiments provide a method of protecting a plant against abiotic stress is provided, comprising contacting a root of a plant with a composition comprising an effective amount of ZmPep1, ZmPep3, or both ZmPep1 and ZmPep3, or one or more of their analogues, homologs, paralogs, orthologs, equivalogs, fragments, variants, fusion proteins, peptidomimetics, or other derivatives, or combinations thereof.

Embodiments further provide for a method of protecting a plant against abiotic stress is provided, comprising contacting a flower of a plant with a composition comprising an effective amount of ZmPep1, ZmPep3, or both ZmPep1 and ZmPep3, or one or more of their analogues, homologs, paralogs, orthologs, equivalogs, fragments, variants, fusion proteins, peptidomimetics, or other derivatives, or combinations thereof.

Methods of the invention also include protecting a plant against abiotic stress comprising contacting a fruit of a plant with a composition comprising an effective amount of ZmPep1, ZmPep3, or both ZmPep1 and ZmPep3, or one or more of their analogues, homologs, paralogs, orthologs, equivalogs, fragments, variants, fusion proteins, peptidomimetics, or other derivatives, or combinations thereof. The abiotic stress according to embodiments may include any or any combination of drought, salt stress, osmotic stress, cold stress, heat stress, variations in temperature such as great or extreme variations in temperature, unseasonable temperature, mechanical (e.g. wind) stress, extreme wetness, nutrient deficiency, nutrient excess, radiation stress (e.g. ultraviolet), atmospheric pollution (e.g. ozone), and soil pollution (e.g. heavy metals, herbicides). In a preferred embodiment of the invention, the abiotic stress is drought. Signs of stress exhibited by a plant may include one or more of wilting, browning, or a decrease in yield.

According to another aspect of embodiments of the invention, compositions are provided that comprise one or more isolated stress tolerance peptides that are 10 or more amino acid residues in length and that have substantial stress tolerance peptide activity. Such stress tolerance peptides may be longer, e.g., 15, 20, 23 or more amino acid residues in length. For example, they are more easily synthesized. According to various embodiments, the stress tolerance peptide can for example be from about 10 to about 50 amino acid residues in length, or from about 15 to about 50 amino acid residues in length, such as from about 20-30 amino acid residues in length. However, longer stress tolerance peptides may also be made and used in the practice of embodiments of the invention.

Compositions are provided that comprise one or more polypeptides that are processed in a plant cell to produce stress tolerance peptides, for example, a stress tolerance peptide that comprises a sequence having at least 60 percent homology, 70 percent homology, 75 percent homology, or 80 percent homology, or 85 percent homology, or 90 percent homology, or complete homology with a polypeptide selected from ZmPep1 and ZmPep3. Alternatively, the stress tolerance peptide comprises a sequence having at least 90 percent homology, or complete homology, with a dicot or monocot stress tolerance peptide consensus sequence.

Such compositions comprising peptide or polypeptide compositions may further comprise biologically acceptable carriers and/or other substances used in formulating peptides and polypeptides. For example, such compositions may be agricultural formulations that are suitable for application to plants. Accordingly, in another embodiment, plants or seeds of plants are provided that comprise such a composition applied to a plant or seed surface, respectively. When applied to plants under suitable conditions, such compositions induce the ability of the plant to survive abiotic stress including any or any combination of drought, salt stress, osmotic stress, cold stress, heat stress, great or extreme variations in temperature, unseasonable temperature, mechanical (e.g. wind) stress, extreme wetness, nutrient deficiency, nutrient excess, radiation stress (e.g. ultraviolet), atmospheric pollution (e.g. ozone), and soil pollution (e.g. heavy metals, herbicides). The compositions are particularly useful for inducing the ability of the plant to survive drought conditions.

According to another aspect, polynucleotides that express stress tolerance peptides (or polypeptides, including, for example, pro-forms of stress tolerance peptides that are processed in plant cells to produce stress tolerance peptides) in plants are provided. Transgenic expression of such stress tolerance peptides induces the plants' innate tolerance mechanisms. Accordingly, one embodiment is an isolated polynucleotide comprising a sequence that encodes a stress tolerance peptide (as described in this specification) operably linked to a plant promoter. Expression of the polynucleotide in a cell of a plant causes the plant to exhibit an improvement compared to a control plant lacking the polynucleotide that is selected from the group consisting of improved yield of plant product, and improved responses to stresses such drought, salt stress, osmotic stress, cold stress, heat stress, ultraviolet stress, and soil stress. The encoded stress tolerance peptide is 10 or more, or 15 or more, or 20 or more, or 23 or more, or 30 or more, or 50 or more amino acid residues in length. Alternatively, such a polynucleotide comprises a sequence that encodes a polypeptide that is processed in a plant cell to produce the stress tolerance peptide.

According to one embodiment, such polynucleotides encoding stress tolerance peptides have at least 70 percent, 80 percent, or at least 90 percent, or at least 95 percent, or complete sequence similarity to a polynucleotide sequence that encodes a plant stress tolerance peptide selected from ZmPep1 and ZmPep3.

According to another embodiment, an isolated polynucleotide is provided that comprises a sequence that encodes a stress tolerance peptide operably linked to a heterologous promoter. Polynucleotides for expression in plant, bacterial, fungal (including yeast), insect, and other types of cells are contemplated. In one embodiment, expression of the polynucleotide in a cell of a plant causes the plant to exhibit an improvement compared to a control plant lacking the polynucleotide that is selected from better stand establishment, improved yield of plant product, increased seedling survival, increased biomass in early development, reduced wilting, reduced senescence, reduced stress symptoms, and enhanced resistance to abiotic stress including any or any combination of drought, salt stress, osmotic stress, cold stress, heat stress, variations in temperature, unseasonable temperature, mechanical (e.g. wind) stress, extreme wetness, nutrient deficiency, nutrient excess, radiation stress (e.g. ultraviolet), atmospheric pollution (e.g. ozone), and soil pollution (e.g. heavy metals, herbicides). Preferably, expression of the polynucleotide in a cell of a plant causes the plant to exhibit an improved tolerance to drought conditions. Through increased stress tolerance by being exposed to compositions of the invention plants in some embodiments may exhibit an increased yield. An increase in yield can for example include increasing the number and/or size of the seed or fruit (e.g., for corn, wheat, apples, grapes, tomatoes, other fruit crops, etc.) as compared to plants that are not exposed to the compositions of the invention. For corn, or similar crops, increased yield may be characterized by for example an increase in corn cob weight, the number of kernels on an ear of corn, and/or kernel size. Alternatively or in addition the benefit of compositions of the invention can include that when a plant treated with a composition of the invention is exposed to a stressor such as drought the plant will exhibit a decrease in yield loss otherwise expected or characteristic of untreated plants. Treated plants may also exhibit an increase in yield when not exposed to drought conditions as compared with untreated plants.

An additional embodiment provides a transgenic plant comprising a polynucleotide encoding a stress tolerance peptide operably linked to a heterologous promoter.

The heterologous promoter may, for example, be a constitutive promoter or a non-constitutive promoter, including, but not limited to, an organ- or tissue-specific promoter or an inducible promoter. The heterologous promoter may also be a stress responsive promoter.

An additional embodiment provides a transgenic plant comprising a polynucleotide encoding a stress tolerance peptide operably linked to a stress responsive promoter.

According to another embodiment, cells are provided that comprise one or more of the above-mentioned polynucleotides, including, but not limited to, plant, bacterial, fungal (including yeast), and insect cells. According to another embodiment, plants that comprise such cells are provided, including, but not limited to, plants such as: acacia, alfalfa, aneth, apple, apricot, artichoke, arugula, asparagus, avocado, banana, barley, beans, beet, blackberry, blueberry, broccoli, brussels sprouts, cabbage, cantaloupe, carrot, cassaya, castorbean, cauliflower, celery, cherry, chicory, cilantro, citrus, clementines, clover, coconut, coffee, corn, cotton, cucumber, Douglas fir, eggplant, endive, escarole, eucalyptus, fennel, figs, garlic, gourd, grape, grapefruit, honey dew, jicama, kiwifruit, lettuce, leeks, lemon, lime, Loblolly pine, linseed, mango, melon, mushroom, nectarine, nut, oat, oil palm, oil seed rape, okra, olive, onion, orange, an ornamental plant, palm, papaya, parsley, parsnip, pea, peach, peanut, pear, pepper, persimmon, pine, pineapple, plantain, plum, pomegranate, poplar, potato, pumpkin, quince, radiata pine, radicchio, radish, rapeseed, raspberry, rice, rye, sorghum, Southern pine, soybean, spinach, squash, strawberry, sugarbeet, sugarcane, sunflower, sweet potato, sweetgum, tangerine, tea, tobacco, tomato, triticale, turf grass, turnip, a vine, watermelon, wheat, yams, and zucchini, as well as miscanthus, switchgrass, and cannabis.

According to another embodiment, such a plant exhibits reduced symptoms from, or enhanced resistance to, abiotic stress that may include any or any combination of drought, salt stress, osmotic stress, cold stress, heat stress, great variations in temperature, unseasonable temperature, mechanical (e.g. wind) stress, extreme wetness, nutrient deficiency, nutrient excess, radiation stress (e.g. ultraviolet), atmospheric pollution (e.g. ozone), and soil pollution (e.g. heavy metals, herbicides). According to a preferred embodiment, such a plant exhibits reduced symptoms from, or enhanced resistance to drought. An embodiment further encompasses parts of such plants, including, but not limited to, seeds, seed pods, flowers, fruit, tubers, stems, cuttings, leaves, roots, and pollen. Products resulting from processing of such plants or parts thereof are also encompassed.

Formulations of such polynucleotides are also provided. Therefore, according to another aspect, a composition is provided that comprises one or more of the above-described polynucleotides and a biologically acceptable carrier.

According to another embodiment, methods are provided for making a stress tolerance peptide comprising expressing in a cell a polynucleotide as described above. Included are, for example, plant cells, bacterial cells, fungal cells, and insect cells. Such methods may further comprise purifying the stress tolerance peptide.

According to an additional embodiment, methods are provided for making a transgenic plant, comprising introducing into a cell of a plant one or more of the above-described polynucleotides, thereby producing a transformed cell, and regenerating a transgenic plant from the transformed cell, wherein, compared to a control plant lacking the polynucleotide, the transgenic plant exhibits one or more characteristic selected from better stand establishment, improved yield of plant product, increased seedling survival, increased biomass in early development, reduced wilting, reduced senescence, reduced stress symptoms, and enhanced resistance to abiotic stresses including any or any combination of drought, salt stress, osmotic stress, cold stress, heat stress, great variations in temperature, unseasonable temperature, mechanical (e.g. wind) stress, extreme wetness, nutrient deficiency, nutrient excess, radiation stress (e.g. ultraviolet), atmospheric pollution (e.g. ozone), and soil pollution (e.g. heavy metals, herbicides). According to a preferred embodiment, the transgenic plant exhibits an enhanced resistance to drought. According to another embodiment, methods are provided for making a plant that comprises a transgene comprising a sequence that encodes a stress tolerance peptide operably linked to a plant promoter, such methods comprising sexually crossing a plant that comprises the transgene with a plant that lacks the transgene, thereby producing a plurality of progeny plants, and selecting a progeny plant comprising the transgene.

According to another embodiment, methods are provided for making a plant that comprises a transgene comprising a sequence that encodes a stress tolerance peptide operably linked to a plant promoter, the method comprising asexually reproducing a plant that comprises the transgene, thereby producing a plurality of progeny plants, and selecting a progeny plant comprising the transgene.

According to an additional embodiment, methods are provided for growing a plant comprising planting a seed that comprises one or more of the above-mentioned polynucleotides, and growing the seed to produce a plant, wherein, compared to a control plant lacking said polynucleotide sequence, the plant grown from the seed exhibits a characteristic selected from better stand establishment, improved yield of plant product, increased seedling survival, increased biomass in early development, reduced wilting, reduced senescence, reduced stress symptoms, and enhanced resistance to abiotic stress including any or any combination of drought, salt stress, osmotic stress, cold stress, heat stress, great variations in temperature, unseasonable temperature, mechanical (e.g. wind) stress, extreme wetness, nutrient deficiency, nutrient excess, radiation stress (e.g. ultraviolet), atmospheric pollution (e.g. ozone), and soil pollution (e.g. heavy metals, herbicides). According to a preferred embodiment, the plant grown from the seed may exhibit an enhanced resistance to drought conditions.

According to another embodiment, methods are provided for detecting a plant cell comprising one or more polynucleotide described in this specification in a biological sample, the method comprising contacting the biological sample with a probe that binds specifically to the polynucleotide, and detecting said binding. One such probe is a PCR primer, in which case the method comprises performing PCR on the sample and detecting said binding by detecting an amplification product diagnostic of the presence of the polynucleotide in the sample.

According to another embodiment, kits are provided for detecting a plant cell comprising a polynucleotide in a biological sample, the kit comprising one or more probes that bind specifically to the polynucleotide, or to the stress tolerance peptide encoded by the polynucleotide, and instructions for use.

According to another embodiment, methods are provided for detecting a plant cell comprising a polynucleotide in a biological sample, the method comprising contacting the biological sample with a probe that binds specifically to the polynucleotide, or with a probe that binds to the stress tolerance peptide encoded by the polypeptide (such as, for example, an antibody probe), and detecting said binding.

Plant cells are provided in embodiments that comprise an insertion of a foreign promoter upstream of a coding sequence for a stress tolerance protein, wherein the foreign promoter is operably linked to the coding sequence for the stress tolerance protein and the plant is characterized by a substantially enhanced resistance to abiotic stress compared to a control plant lacking the insertion of the foreign promoter.

Methods of making a transgenic plant are provided that comprise one or more of: (a) introducing into cells of a plant a polynucleotide that comprises a heterologous promoter, thereby producing a cell comprising an insertion of the heterologous promoter upstream of a coding sequence for a stress tolerance protein, wherein expression of the stress tolerance protein is controlled by the foreign promoter, and (b) regenerating a transgenic plant from said cell comprising the insertion.

According to embodiments, methods of identifying a stress tolerance peptide are provided, such methods comprising one or more of: (a) providing a plurality of candidate peptides having a length of at least 10 amino acids; (b) assaying said plurality of candidate peptides for stress tolerance peptide activity in an alkalinization assay; and (c) selecting a candidate peptide that has substantial stress tolerance peptide activity. The candidate peptides may be provided for such methods by, for example, chemically synthesizing the candidate peptides. Such methods may further comprise administering the candidate peptide to a plant by applying a composition comprising the candidate peptide to the plant. Alternatively, such methods may comprise administering the candidate peptide to a plant by expressing within a cell of the plant a polynucleotide that comprises a sequence that encodes the candidate peptide, thereby producing the candidate peptide within the cell of the plant.

According to another embodiment, methods are provided for identifying a substance that enhances a protective response of a plant against an abiotic stress comprising one or more of: (a) contacting an isolated ZmPep1 or ZmPep3 receptor with a plurality of candidate substances (e.g., peptides or non-peptide compounds); (b) selecting a candidate substance that has a detectable interaction with the isolated ZmPep1 or ZmPep3 receptor; and (c) applying the selected candidate substance to a plant to determine whether the selected candidate substance enhances a protective response of the plant against abiotic stress.

According to another embodiment, methods are provided for conferring on a plant cell a response to a plant stress tolerance peptide to which the plant cell would not normally respond, the method comprising expressing in the plant cell a polynucleotide comprising a sequence encoding a receptor for the plant stress tolerance peptide operably linked to a promoter that is expressible in the plant cell. The plant cell response could include, for example, alkalinization of the plant cell in response to administration of the plant stress tolerance peptide, transcription of stress response genes, enhanced resistance to an abiotic stress, etc.

According to another embodiment, plant cells are provided that comprise a polynucleotide comprising a sequence encoding a receptor for the plant stress tolerance peptide operably linked to a promoter that is expressible in the plant cell, wherein expression of the polynucleotide confers on the plant cell a response to a plant stress tolerance peptide to which the plant cell would otherwise be unresponsive.

Included within embodiments of the invention is an isolated polypeptide comprising or consisting of a consensus amino acid sequence:

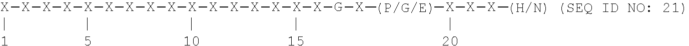

wherein:

X is an amino acid chosen from Alanine (A), Cysteine (C), Aspartic acid (D), Glutamic acid (E), Phenylalanine (F), Glycine (G), Histidine (H), Isoleucine (I), Lysine (K), Leucine (L), Methionine (M), Asparagine (N), Proline (P), Glutamine (Q), Arginine (R), Serine (S), Threonine (T), Valine (V), Tryptophan (W), or Tyrosine (Y);

or a 10, 11, 12, 13, 14, 15, 16, 17, 18, 19, 20, 21, or 22 amino acid fragment of such consensus amino acid sequence, wherein the amino acid fragment is capable of increasing a plant's resistance to drought. Peptides where one or more substitution(s) of any amino acid are made to one or more of residues 17, 19, or 23, which are conservative or not conservative substitutions, are also included within the scope of the invention.

For example, included within embodiments of the invention is an isolated polypeptide comprising or consisting of a consensus amino acid sequence:

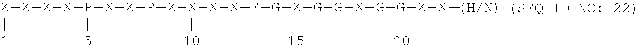

wherein:

X is an amino acid chosen from Alanine (A), Cysteine (C), Aspartic acid (D), Glutamic acid (E), Phenylalanine (F), Glycine (G), Histidine (H), Isoleucine (I), Lysine (K), Leucine (L), Methionine (M), Asparagine (N), Proline (P), Glutamine (Q), Arginine (R), Serine (S), Threonine (T), Valine (V), Tryptophan (W), or Tyrosine (Y);

or a 10, 11, 12, 13, 14, 15, 16, 17, 18, 19, 20, 21, or 22 amino acid fragment of such consensus amino acid sequence, wherein the amino acid fragment is capable of increasing a plant's resistance to drought. Peptides where one or more substitution(s) of any amino acid are made to one or more of residues 5, 8, 13, 14, 16, 17, 19, 20, or 23, which are conservative or not conservative substitutions, are also included within the scope of the invention.

Further, for example, included within embodiments of the invention is an isolated polypeptide comprising or consisting of a consensus amino acid sequence:

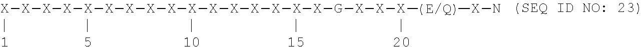

wherein:

residue 7 and 11 are independently Lysine, Glycine, or Arginine;

residue 12 is Threonine, Proline, or Serine;

residue 14 is Leucine, Isoleucine, or Valine;

residue 15 is Serine, Threonine, Glycine;

residue 19 is Glutamic acid, Glycine, or Proline; and

residue 22 is Histidine, Isoleucine, or Asparagine;

X is an amino acid chosen from Alanine (A), Cysteine (C), Aspartic acid (D), Glutamic acid (E), Phenylalanine (F), Glycine (G), Histidine (H), Isoleucine (I), Lysine (K), Leucine (L), Methionine (M), Asparagine (N), Proline (P), Glutamine (Q), Arginine (R), Serine (S), Threonine (T), Valine (V), Tryptophan (W), or Tyrosine (Y);

or a 10, 11, 12, 13, 14, 15, 16, 17, 18, 19, 20, 21, or 22 amino acid fragment of such consensus amino acid sequence, wherein the amino acid fragment is capable of increasing a plant's resistance to drought. Peptides where one or more substitution(s) of any amino acid are made to one or more of residues 7, 11, 12, 14, 15, 17, 19, 21, 22, or 23, which are conservative or not conservative substitutions, are also included within the scope of the invention.

Preferred are methods employing and compositions comprising one or more of ZmPep1, ZmPep2, ZmPep3, ZmPep4, ZmPep5, GmPep1, GmPep2, and/or GmPep3 as the defense polypeptide, for example, for the purpose of protecting a plant or seed against biotic or abiotic stress, including but not limited to drought. Additional defense peptides that can be used in any method or composition embodiment of the invention described in this specification can include those described in International Patent Application Publication No. WO 2006/081301 and U.S. Published Patent Application Nos. 2009/0119793, 2009/0300802, 2013/20061352 (now U.S. Pat. No. 8,686,224), and/or 2014/0137298 entitled “Plant Defense Signal Peptides” which list Clarence A. Ryan and others as inventors. These publications are incorporated by reference herein in their entireties.

Compositions comprising any one or more of the isolated polypeptides enumerated in this specification are also included within the scope of the invention. For example, such compositions can be formulated in a biologically or agriculturally acceptable carrier such that the effective amount of polypeptide is purposefully selected to protect the plant against drought stress through multiple applications of the composition separated by a period of time.

Methods of using compositions described in this specification are also included within the scope of the invention. Methods comprising contacting one or more composition comprising a polypeptide described in this specification with a plant or part thereof in a manner, and with an effective amount of polypeptide, sufficient to protect the plant against drought stress or sufficient to reduce symptoms of drought stress in the plant or part thereof are included, optionally with qualitatively or quantitatively measuring any symptoms of drought stress.

For example, such polypeptides for use in methods of treating disclosed in this application can include any of the compositions or compounds described above, or below, or in the claims, including for example any one or more of the following (alone or in combination):

A recombinant polypeptide comprising:

i) a consensus amino acid sequence:

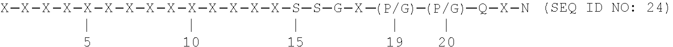

wherein

X is any amino acid;

residue 19 is Pro or Gly;

residue 20 is Pro or Gly;

and residues 1-14 include at least one Lys or Arg

or

ii) an amino acid carboxy terminal fragment of said consensus amino acid sequence comprising at least 10 amino acids;

Such as the recombinant polypeptide described just above, wherein said consensus amino acid sequence has a sequence selected from the group consisting of:

(SEQ ID NO: 25)
VARLT RRRPR PP-YS SGQPG QIN,
(SEQ ID NO: 26)
PTERR GRPPS RPKVG SGPPP QNN,
(SEQ ID NO: 27)
DAAVS ALARR TPPVS RGGGG QTN,
(SEQ ID NO: 28)
DLVMA VNAPP RPSLT PGSGA QIN,
(SEQ ID NO: 29)
ASLMA TRGSR GSKIS DGSGP QHN,
(SEQ ID NO: 30)
LSSMG RGGPR RTPLT QGPPP QHN,
(SEQ ID NO: 31)
EKVRE KQKKG EDGES VGRPG KKN,
(SEQ ID NO: 32)
ATKVKAKQRGKEKVSSGRPGQHN,
(SEQ ID NO: 33)
AVTVS ALARR TPPVS SGSGG QIN,
and
(SEQ ID NO: 34)
RGLTR RPPPP RGPIS SGGGG QTN;

A recombinant polypeptide of SEQ ID NOS. 24-34, wherein said recombinant polypeptide is a heterologous fusion polypeptide.

Additional embodiments of the invention are provided as the Enumerated Embodiments and specific Aspects identified in more detail below.

### Enumerated Embodiment 1

An isolated peptide or polypeptide comprising the amino acid sequence of SEQ ID NO: 1 or SEQ ID NO: 3.

### Enumerated Embodiment 2

An isolated peptide or polypeptide comprising an amino acid sequence at least 60%, 65%, 70%, 75%, 80%, 85%, 90%, or 95% identical to the amino acid sequence of SEQ ID NO: 1 or SEQ ID NO: 3 with ZmPep1 or ZmPep3 receptor binding activity.

### Enumerated Embodiment 3

An isolated peptide or polypeptide comprising an amino acid sequence at least 60%, 65%, 70%, 75%, 80%, 85%, 90%, or 95% identical to the amino acid sequence of SEQ ID NO: 1 or SEQ ID NO: 3 with activity in an in vitro or in vivo plant stress tolerance assay.

### Enumerated Embodiment 4

An isolated peptide or polypeptide that is an analogue, homolog, paralog, ortholog, equivalog, or variant of a polypeptide comprising an amino acid sequence of SEQ ID NO: 1 or SEQ ID NO: 3 with ZmPep1 or ZmPep3 receptor binding activity.

### Enumerated Embodiment 5

An isolated peptide or polypeptide that is an analogue, homolog, paralog, ortholog, equivalog, or variant of a polypeptide comprising an amino acid sequence of SEQ ID NO: 1 or SEQ ID NO: 3 that has activity in an in vitro or in vivo plant stress tolerance assay.

### Enumerated Embodiment 6

An isolated peptide comprising a partial sequence of the amino acid sequence of SEQ ID NO: 1 or SEQ ID NO: 3, wherein the partial sequence is at least 10, 11, 12, 13, 14, 15, 16, 17, 18, 19, 20, 21, or 22 amino acids in length with ZmPep1 or ZmPep3 receptor binding activity.

### Enumerated Embodiment 7

An isolated peptide comprising a partial sequence of the amino acid sequence of SEQ ID NO: 1 or SEQ ID NO: 3, wherein the partial sequence is at least 10, 11, 12, 13, 14, 15, 16, 17, 18, 19, 20, 21, or 22 amino acids in length and has activity in an in vitro or in vivo plant stress tolerance assay.

### Enumerated Embodiment 8

A fusion protein comprising a peptide comprising an amino acid sequence at least 60%, 65%, 70%, 75%, 80%, 85%, 90%, or 95% identical to the amino acid sequence of SEQ ID NO: 1 or SEQ ID NO: 3 that has ZmPep1 or ZmPep3 receptor binding activity.

### Enumerated Embodiment 9

A fusion protein comprising a peptide comprising an amino acid sequence at least 60%, 65%, 70%, 75%, 80%, 85%, 90%, or 95% identical to the amino acid sequence of SEQ ID NO: 1 or SEQ ID NO: 3 that has activity in an in vitro or in vivo plant stress tolerance assay.

### Enumerated Embodiment 10

An isolated polynucleotide comprising the peptide or polypeptide or fusion protein of any of enumerated embodiments 1-9.

### Enumerated Embodiment 11

A peptidomimetic derived from the amino acid sequence of SEQ ID NO: 1 or SEQ ID NO: 3 with ZmPep1 or ZmPep3 receptor binding activity.

### Enumerated Embodiment 12

A peptidomimetic derived from the amino acid sequence of SEQ ID NO: 1 or SEQ ID NO: 3 that has activity in an in vitro or in vivo plant stress tolerance assay.

### Enumerated Embodiment 13

The isolated polynucleotide of enumerated embodiment 10, operably linked to a heterologous promoter.

### Enumerated Embodiment 14

The isolated polynucleotide of enumerated embodiment 13, wherein the heterologous promoter is a constitutive promoter, a non-constitutive promoter, an organ-specific promoter, a tissue-specific promoter, an inducible promoter, or a stress responsive promoter.

### Enumerated Embodiment 15

A vector comprising the isolated polynucleotide of enumerated embodiment 10.

### Enumerated Embodiment 16

A transgenic plant comprising the isolated peptide or polypeptide of any of enumerated embodiments 1-7.

### Enumerated Embodiment 17

A transgenic plant comprising the fusion protein of enumerated embodiments 8 or 9.

### Enumerated Embodiment 18

A transgenic plant comprising the isolated polynucleotide of enumerated embodiment 10.

### Enumerated Embodiment 19

A transgenic plant comprising the isolated polynucleotide of enumerated embodiment 13.

### Enumerated Embodiment 20

A transgenic plant comprising the vector of enumerated embodiment 15.

### Enumerated Embodiment 21

A composition comprising a peptide, polypeptide, fusion protein, or peptidomimetic of any of enumerated embodiments 1-11 and a biologically or agriculturally acceptable carrier.

### Enumerated Embodiment 22

The composition of enumerated embodiment 21, wherein the peptide, polypeptide, fusion protein, or peptidomimetic is present in a concentration ranging from about 0.01 and 1.0 g/l, such as from about 0.05 to 0.95 g/l, or from about 0.1 to 0.9 g/l, for example from about 0.15 to 0.85 g/l, or from about 0.2 to 0.80 g/l, such as from about 0.25 to 0.75 g/l, or from about 0.3 to 0.7 g/l, or from about 0.35 to 0.65 g/l, such as from about 0.4 to 0.6 g/l, such as from about 0.45 to 0.55 g/l, or about 0.5 g/l, for example. Indeed, any concentration can be used to achieve desired results for a particular application and can include concentrations ranging from 0.01 mg/L to about 25 g/L, such as from 1 mg/L to 20 g/L, or from about 2 mg/L to 15 g/L, or from 5 mg/L to 10 g/L, such as from 10 mg/L to 5 g/L, or from about 15 mg/L to 1 g/L, such as from 25 mg/L to 900 mg/L, or from 50 mg/L to 750 mg/L, or from about 100 mg/L to 500 mg/L, or from 200 mg/L to 400 mg/L, or about 300 mg/L.

### Enumerated Embodiment 23

The composition of enumerated embodiment 21, wherein the peptide, polypeptide, fusion protein, or peptidomimetic is present in a concentration ranging from about 0.01 to 0.1 g/l.

### Enumerated Embodiment 24

The composition of enumerated embodiment 21, wherein the peptide, polypeptide, fusion protein, or peptidomimetic is present in a concentration ranging from about 0.015 to 0.09 g/1.

### Enumerated Embodiment 25

The composition of enumerated embodiment 21, wherein the peptide, polypeptide, fusion protein, or peptidomimetic is present in a concentration ranging from about 0.02 to 0.08 g/1.

### Enumerated Embodiment 26

The composition of enumerated embodiment 21, wherein the peptide, polypeptide, fusion protein, or peptidomimetic is present in a concentration ranging from about 0.03 to 0.07 g/1.

### Enumerated Embodiment 27

The composition of enumerated embodiment 21, wherein the peptide, polypeptide, fusion protein, or peptidomimetic is present in a concentration ranging from about 0.035 to 0.06 g/1.

### Enumerated Embodiment 28

The composition of enumerated embodiment 21, wherein the peptide, polypeptide, fusion protein, or peptidomimetic is present in a concentration ranging from about 0.04 to 0.05 g/1.

### Enumerated Embodiment 29

The composition of enumerated embodiment 21, wherein the peptide, polypeptide, fusion protein, or peptidomimetic is present in a concentration ranging from about 0.01 to 0.025 g/1.

### Enumerated Embodiment 30

The composition of enumerated embodiment 21, wherein the peptide, polypeptide, fusion protein, or peptidomimetic is present in a concentration ranging from about 0.025 to 0.05 g/1.

### Enumerated Embodiment 31

The composition of enumerated embodiment 21, wherein the peptide, polypeptide, fusion protein, or peptidomimetic is present in a concentration ranging from about 0.05 to 0.075 g/1.

### Enumerated Embodiment 32

The composition of enumerated embodiment 21, wherein the peptide, polypeptide, fusion protein, or peptidomimetic is present in a concentration ranging from about 0.075 g/l to 0.10 g/1.

### Enumerated Embodiment 33

The composition of enumerated embodiment 21, wherein the peptide, polypeptide, fusion protein, or peptidomimetic is present in a concentration ranging from about 0.1 to 1.0 g/1.

### Enumerated Embodiment 34

The composition of enumerated embodiment 21, wherein the peptide, polypeptide, fusion protein, or peptidomimetic is present in a concentration ranging from about 0.15 to 0.9 g/l.

### Enumerated Embodiment 35

The composition of enumerated embodiment 21, wherein the peptide, polypeptide, fusion protein, or peptidomimetic is present in a concentration ranging from about 0.2 to 0.8 g/l.

### Enumerated Embodiment 36

The composition of enumerated embodiment 21, wherein the peptide, polypeptide, fusion protein, or peptidomimetic is present in a concentration ranging from about 0.3 to 0.7 g/l.

### Enumerated Embodiment 37

The composition of enumerated embodiment 21, wherein the peptide, polypeptide, fusion protein, or peptidomimetic is present in a concentration ranging from about 0.35 to 0.6 g/l.

### Enumerated Embodiment 38

The composition of enumerated embodiment 21, wherein the peptide, polypeptide, fusion protein, or peptidomimetic is present in a concentration ranging from about 0.4 to 0.5 g/l.

### Enumerated Embodiment 39

The composition of enumerated embodiment 21, wherein the peptide, polypeptide, fusion protein, or peptidomimetic is present in a concentration ranging from about 0.1 to 0.25 g/l.

### Enumerated Embodiment 40

The composition of enumerated embodiment 21, wherein the peptide, polypeptide, fusion protein, or peptidomimetic is present in a concentration ranging from about 0.25 to 0.5 g/l.

### Enumerated Embodiment 41

The composition of enumerated embodiment 21, wherein the peptide, polypeptide, fusion protein, or peptidomimetic is present in a concentration ranging from about 0.5 to 0.75 g/l.

### Enumerated Embodiment 42

The composition of enumerated embodiment 21, wherein the peptide, polypeptide, fusion protein, or peptidomimetic is present in a concentration ranging from about 0.75 g/l to 1.0 g/l.

### Enumerated Embodiment 43

The composition of enumerated embodiment 21, wherein the peptide, polypeptide, fusion protein, or peptidomimetic is present in a concentration ranging from about 0.25 nM to 25 nM. Preferred concentrations that can be used include for example from about 0.01 mg/L to about 25 g/L, such as from 0.05 mg/L to about 20 g/L, or from about 0.1 mg/L to about 15 g/L, or from 0.4 mg/L to about 10 g/L, or from 0.8 mg/L to about 8 g/L, or from about 1 mg/L to about 5 g/L, such as from 2 mg/L to about 3 g/L, or from 4 mg/L to about 2 g/L, such as from 5 mg/L to about 1 g/L, or from 10 mg/L to 800 mg/L, or from 20 mg/L to about 500 mg/L, or from 50 mg/L to about 300 mg/L, or from 100 mg/L to 200 mg/L. As with any range provided in this specification, all numbers within the ranges provided are also understood as being included within the scope of the invention. Even further, the concentrations provided for various compositions of the invention can be used in the methods of the invention as well and the concentrations listed as applicable to the methods can also be used in formulating the compositions.

### Enumerated Embodiment 44

The composition of enumerated embodiment 21, wherein the peptide, polypeptide, fusion protein, or peptidomimetic is present in a concentration ranging from about 0.25 to 2.5 nM.

### Enumerated Embodiment 45

The composition of enumerated embodiment 21, wherein the peptide, polypeptide, fusion protein, or peptidomimetic is present in a concentration ranging from about 2.5 nM to 25 nM.

### Enumerated Embodiment 46

The composition of enumerated embodiment 21, wherein the peptide, polypeptide, fusion protein, or peptidomimetic is present in a concentration ranging from about 25 nM to 500 μM.

### Enumerated Embodiment 47

The composition of enumerated embodiment 21, wherein the peptide, polypeptide, fusion protein, or peptidomimetic is present in a concentration ranging from about 25 nM to 250 nM.

### Enumerated Embodiment 48

The composition of enumerated embodiment 21, wherein the peptide, polypeptide, fusion protein, or peptidomimetic is present in a concentration ranging from about 250 nM to 2.5 μM.

### Embodiment 49

The composition of enumerated embodiment 21, wherein the peptide, polypeptide, fusion protein, or peptidomimetic is present in a concentration ranging from about 2.5 μM to 25 μM.

### Enumerated Embodiment 50

The composition of enumerated embodiment 21, wherein the peptide, polypeptide, fusion protein, or peptidomimetic is present in a concentration ranging from about 25 μM to 100 μM.

### Enumerated Embodiment 51

The composition of enumerated embodiment 21, wherein the peptide, polypeptide, fusion protein, or peptidomimetic is present in a concentration ranging from about 100 μM to 500 μM.

### Enumerated Embodiment 52

A plant comprising the composition of enumerated embodiment 21 applied to the plant, for example, to a surface of said plant. In embodiments, the composition can alternatively or in addition be introduced inside the plant, for example, by scratching the surface of the plant and applying the composition in a manner that would introduce the composition to the scratch.

### Enumerated Embodiment 53

A seed comprising the composition of enumerated embodiment 21 applied to the seed, for example, the surface of said seed. In embodiments, the compositions can be applied to developing seeds, or applied to parent plants that are growing and developing the seeds or will develop seed, such as at a stage of growth prior to developing seeds. Methods of seed production can include applying the compositions to developing seeds in a manner that provides for obtaining mature seeds comprising the compositions of the invention, whether on the surface of the seeds or otherwise incorporated into the developed seed. Higher levels of molecular defenses could also be obtained in this mature seed that could lead to greater stress tolerance in the resulting seedlings and plants grown from the seed, or higher levels of certain defense molecules in the seed or resulting plant that were induced by the treatment with defense activator. For example, the levels of proteinase inhibitors in the developed seed or plant germinated from the seed can be quantified. Seeds/plants can also be treated by planting a seed in soil, then applying the composition to the soil such that the seed/plant grows and develops while being exposed to the composition by way of the soil. Methods of seed production can also include exposing a plant to one or more defense activators during development of the plant in a manner that provides for obtaining seeds comprising the defense activators and/or one or more molecular defenses induced by the treatment with defense activators in an amount sufficient to protect progeny of the seed against one or more biotic or abiotic stressors. The defense activators can be applied to, absorbed by, and/or incorporated into a growing plant in a concentration and in a number of applications sufficient to produce from the plant seedlings comprising the defense activators. The concentrations of peptides disclosed in this specification for compositions and/or methods of treating plants and seeds can be used for methods of producing seeds in this manner. Defense activators in the context of this specification can include for example molecules or compounds that activate plant defenses, such as by way of jasmonic acid dependent or independent pathways and/or by way of salicylic acid dependent or independent pathways. Such defense activators can be used to treat developing seeds (or propagules) and/or plants, from which seeds (or propagules) and their progeny would then be more resistant to biotic and/or abiotic stress and lead to plants with greater productivity. Examples of defense activators that can be used according to embodiments of the invention can include but are not limited to jasmonates, such as methyl jasmonate, methyl dihydrojasmonate, jasmonic acid, and/or derivatives of jasmonates; salicylic acid and derivatives; chitin; acibenzolar-S-methyl; harpins; microbes; and defense peptides, especially one or more defense peptides described in this specification.

### Enumerated Embodiment 54

A method of protecting a plant or part thereof against biotic and/or abiotic stress or reducing symptoms of biotic and/or abiotic stress in a plant or part thereof, comprising contacting said plant or part thereof with a composition comprising an effective amount of a stress tolerance peptide, polypeptide, protein, or peptidomimetic.

### Enumerated Embodiment 55

The method of enumerated embodiment 54, wherein the part thereof is a leaf, a stem, a seed, a root, a flower, or a fruit.

### Enumerated Embodiment 56

The method of enumerated embodiment 54, wherein the abiotic stress is any or any combination of drought, salt stress, osmotic stress, cold stress, heat stress, great variations in temperature, unseasonable temperature, mechanical stress, extreme wetness, nutrient deficiency, nutrient excess, radiation stress, atmospheric pollution, and soil pollution.

### Enumerated Embodiment 57

The method of enumerated embodiment 54, wherein the stress tolerance peptide, polypeptide, protein, or peptidomimetic is a peptide, polypeptide, protein, or peptidomimetic of any of enumerated embodiments 1-12.

### Enumerated Embodiment 58

The peptide of enumerated embodiments 4 or 5, wherein the ortholog or paralog comprises an amino acid sequence of SEQ ID NOS: 6-20.

### Enumerated Embodiment 59

A method for making a transgenic plant, comprising introducing into a cell of a plant one or more of the polynucleotides of enumerated embodiment 10, thereby producing a transformed cell, and regenerating a transgenic plant from the transformed cell.

### Enumerated Embodiment 60

A method for making a transgenic plant, comprising one or more of: (a) introducing into cells of a plant a polynucleotide that comprises a heterologous promoter, thereby producing a cell comprising an insertion of the heterologous promoter upstream of a coding sequence for a stress tolerance protein, wherein expression of the stress tolerance protein is controlled by the foreign promoter, and (b) regenerating a transgenic plant from said cell comprising the insertion. Enumerated Embodiment 61. The composition of enumerated embodiment 21 comprising ZmPep1 and ZmPep3.

Aspects of embodiments of the invention further include Aspect 1, which is a synthetic peptide or polypeptide comprising an amino acid sequence that differs from a wild type amino acid sequence as a result of one or more insertions, deletions, substitutions, or additions of at least one amino acid, wherein: (i) the wild-type amino acid sequence is the amino acid sequence depicted in any of SEQ ID NOS: 1-34, such as SEQ ID NO: 1 or SEQ ID NO: 3; and/or (ii) the amino acid sequence of the synthetic peptide or polypeptide is between 60% and 99%, inclusive, identical to the amino acid sequence depicted in any of SEQ ID NOS: 1-34, such as SEQ ID NO: 1 or SEQ ID NO: 3; and/or (iii) the amino acid sequence of the synthetic peptide or polypeptide is not identical to any other wild-type sequence; and/or (iv) the synthetic peptide or polypeptide has ZmPep1 or ZmPep3 receptor binding activity or activity in an in vitro or in vivo plant stress tolerance assay, or both activities. For example, the amino acid sequence of the synthetic peptide or polypeptide can be 50%, 56%, 57%, 60%, 61%, 65%, 70%, 74%, 75%, 78%, 80%, 83%, 87%, 91%, 95%, 96% identical to the amino acid sequence depicted in any of SEQ ID NOS: 1-34.

Embodiments also include Aspect 2, a synthetic peptide comprising a partial sequence of the amino acid sequence depicted in SEQ ID NO: 1 or SEQ ID NO: 3, wherein the partial sequence is at least 10, 11, 12, 13, 14, 15, 16, 17, 18, 19, 20, 21, or 22, amino acids in length and has ZmPep1 or ZmPep3 receptor binding activity or has activity in an in vitro or in vivo plant stress tolerance assay, or both activities.

Aspect 3 is a synthetic peptide comprising an amino acid sequence that is at least 10 amino acids in length and is at least 60% identical to a partial sequence of the amino acid sequence depicted in SEQ ID NO: 1 or SEQ ID NO: 3 that has ZmPep1 or ZmPep3 receptor binding activity or has activity in an in vitro or in vivo plant stress tolerance assay, or both activities.

Aspect 4 is a heterologous fusion polypeptide comprising the synthetic peptide of Aspect 1, wherein the heterologous fusion polypeptide has ZmPep1 or ZmPep3 receptor binding activity or activity in an in vitro or in vivo plant stress tolerance assay, or both activities.

Aspect 5 is a heterologous fusion polypeptide comprising the synthetic peptide of Aspect 2, wherein the heterologous fusion polypeptide has ZmPep1 or ZmPep3 receptor binding activity or activity in an in vitro or in vivo plant stress tolerance assay, or both activities.

Aspect 6 is a heterologous fusion polypeptide comprising the synthetic peptide of Aspect 3, wherein the heterologous fusion polypeptide has ZmPep1 or ZmPep3 receptor binding activity or activity in an in vitro or in vivo plant stress tolerance assay, or both activities.

Aspect 7 includes a peptidomimetic derived from the amino acid sequence depicted in SEQ ID NO: 1 or SEQ ID NO: 3 that has ZmPep1 or ZmPep3 receptor binding activity or activity in an in vitro or in vivo plant stress tolerance assay, or both activities.

Aspect 8 is a synthetic polynucleotide encoding the synthetic peptide or synthetic polypeptide or heterologous fusion polypeptide of any of Aspects 1-6, wherein the polynucleotide lacks at least one wild type intron sequence.

Aspect 9 is the synthetic polynucleotide of Aspect 8, operably linked to a heterologous promoter.

Aspect 10 is the synthetic polynucleotide of Aspect 9, wherein the heterologous promoter is a constitutive promoter, a non-constitutive promoter, an organ-specific promoter, a tissue-specific promoter, an inducible promoter, or a stress responsive promoter.

Aspect 11 is a vector comprising the synthetic polynucleotide of Aspect 8.

Aspect 12 is a host cell comprising the vector of Aspect 11.

Aspect 13 is a transgenic plant comprising the synthetic polynucleotide of Aspect 8.

Aspect 14 is a transgenic plant comprising a peptide, polypeptide, or heterologous fusion polypeptide encoded by the synthetic polynucleotide of Aspect 8.

Aspect 15 is a transgenic plant comprising the vector of Aspect 11.

Aspect 16 is a composition comprising a synthetic peptide, synthetic polypeptide, heterologous fusion polypeptide, or peptidomimetic of any of Aspects 1-7 and a biologically or agriculturally acceptable carrier.

Aspect 17 is a composition comprising a peptide, polypeptide, or heterologous fusion polypeptide encoded by the synthetic polynucleotide of Aspect 8 and a biologically or agriculturally acceptable carrier.

Aspect 18 is a composition comprising a peptide comprising any of the amino acid sequences depicted in SEQ ID NOS:1-34 and a biologically or agriculturally acceptable carrier.

Aspect 19 is a composition comprising a peptide, polypeptide, or heterologous fusion polypeptide encoded by the synthetic polynucleotide of Aspect 8 or a peptide comprising any of the amino acid sequences depicted in SEQ ID NOS:1-34 and a biologically or agriculturally acceptable carrier.

Aspect 20 is the composition of any of Aspects 17-19, further comprising a lysate of a bacterial cell expressing the peptide, polypeptide, or heterologous fusion polypeptide.

Aspect 21 is the composition of Aspect 19, wherein the peptide, polypeptide, or heterologous fusion polypeptide is present in the composition in a concentration of between 0.01 g/l and 1.0 g/l, inclusive.

Aspect 22 is the composition of Aspect 19, wherein the peptide, polypeptide, or heterologous fusion polypeptide is present in the composition in a concentration of between 0.01 g/l and 0.1 g/l, inclusive.

Aspect 23 is the composition of Aspect 19, wherein the peptide, polypeptide, or heterologous fusion polypeptide is present in the composition in a concentration of between 0.015 g/l and 0.09 g/l, inclusive.

Aspect 24 is the composition of Aspect 19, wherein the peptide, polypeptide, or heterologous fusion polypeptide is present in the composition in a concentration of between 0.02 g/l and 0.08 g/l, inclusive.

Aspect 25 is the composition of Aspect 19, wherein the peptide, polypeptide, or heterologous fusion polypeptide is present in the composition in a concentration of between 0.03 g/l and 0.07 g/l, inclusive.

Aspect 26 is the composition of Aspect 19, wherein the peptide, polypeptide, or heterologous fusion polypeptide is present in the composition in a concentration of between 0.035 g/l and 0.06 g/l, inclusive.

Aspect 27 is the composition of Aspect 19, wherein the peptide, polypeptide, or heterologous fusion polypeptide is present in the composition in a concentration of between 0.04 g/l and 0.05 g/l, inclusive.

Aspect 28 is the composition of Aspect 19, wherein the peptide, polypeptide, or heterologous fusion polypeptide is present in the composition in a concentration of between 0.01 g/l and 0.025 g/l, inclusive.

Aspect 29 is the composition of Aspect 19, wherein the peptide, polypeptide, or heterologous fusion polypeptide is present in the composition in a concentration of between 0.025 g/l and 0.05 g/l, inclusive.

Aspect 30 is the composition of Aspect 19, wherein the peptide, polypeptide, or heterologous fusion polypeptide is present in the composition in a concentration of between 0.05 g/l and 0.075 g/l, inclusive.

Aspect 31 is the composition of Aspect 19, wherein the peptide, polypeptide, or heterologous fusion polypeptide is present in the composition in a concentration of between 0.075 g/l and 0.10 g/l, inclusive.

Aspect 32 is the composition of Aspect 19, wherein the peptide, polypeptide, or heterologous fusion polypeptide is present in the composition in a concentration of between 0.1 g/l and 1.0 g/l, inclusive.

Aspect 33 is the composition of Aspect 19, wherein the peptide, polypeptide, or heterologous fusion polypeptide is present in the composition in a concentration of between 0.15 g/l and 0.9 g/l, inclusive.

Aspect 34 is the composition of Aspect 19, wherein the peptide, polypeptide, or heterologous fusion polypeptide is present in the composition in a concentration of between 0.2 g/l and 0.8 g/l, inclusive.

Aspect 35 is the composition of Aspect 19, wherein the peptide, polypeptide, or heterologous fusion polypeptide is present in the composition in a concentration of between 0.3 g/l and 0.7 g/l, inclusive.

Aspect 36 is the composition of Aspect 19, wherein the peptide, polypeptide, or heterologous fusion polypeptide is present in the composition in a concentration of between 0.35 g/l and 0.6 g/l, inclusive.

Aspect 37 is the composition of Aspect 19, wherein the peptide, polypeptide, or heterologous fusion polypeptide is present in the composition in a concentration of between 0.4 g/l and 0.5 g/l, inclusive.

Aspect 38 is the composition of Aspect 19, wherein the peptide, polypeptide, or heterologous fusion polypeptide is present in the composition in a concentration of between 0.1 g/l and 0.25 g/l, inclusive.

Aspect 39 is the composition of Aspect 19, wherein the peptide, polypeptide, or heterologous fusion polypeptide is present in the composition in a concentration of between 0.25 g/l and 0.5 g/l, inclusive.

Aspect 40 is the composition of Aspect 19, wherein the peptide, polypeptide, or heterologous fusion polypeptide is present in the composition in a concentration of between 0.5 g/l and 0.75 g/l, inclusive.

Aspect 41 is the composition of Aspect 19, wherein the peptide, polypeptide, or heterologous fusion polypeptide is present in the composition in a concentration of between 0.75 g/l and 1.0 g/l, inclusive.

Aspect 42 is the composition of Aspect 19, wherein the peptide, polypeptide, or heterologous fusion polypeptide is present in a concentration between 0.25 nM and 25 nM, inclusive.

Aspect 43 is the composition of Aspect 19, wherein the peptide, polypeptide, or heterologous fusion polypeptide is present in the composition in a concentration of between 0.25 nM and 2.5 nM, inclusive.

Aspect 44 is the composition of Aspect 19, wherein the peptide, polypeptide, or heterologous fusion polypeptide is present in a concentration between 2.5 nM and 25 nM, inclusive.

Aspect 45 is the composition of Aspect 19, wherein the peptide, polypeptide, or heterologous fusion polypeptide is present in the composition in a concentration of between 25 nM and 500 μM, inclusive.

Aspect 46 is the composition of Aspect 19, wherein the peptide, polypeptide, or heterologous fusion polypeptide is present in the composition in a concentration of between 25 nM and 250 nM, inclusive.

Aspect 47 is the composition of Aspect 19, wherein the peptide, polypeptide, or heterologous fusion polypeptide is present in the composition in a concentration of between 250 nM and 2.5 μM, inclusive.

Aspect 48 is the composition of Aspect 19, wherein the peptide, polypeptide, or heterologous fusion polypeptide is present in the composition in a concentration of between 2.5 μM and 25 μM, inclusive.

Aspect 49 is the composition of Aspect 19, wherein the peptide, polypeptide, or heterologous fusion polypeptide is present in the composition in a concentration of between 25 μM and 100 μM, inclusive.

Aspect 50 is the composition of Aspect 19, wherein the peptide, polypeptide, or heterologous fusion polypeptide is present in the composition in a concentration of between 100 μM and 500 μM, inclusive.

Aspect 51 is a plant comprising the composition of Aspect 19 applied to a plant, such as on a surface of the plant.

Aspect 52 is a seed comprising the composition of Aspect 19 applied to a seed, such as on a surface of the seed.

Aspect 53 is a method of protecting a plant or part thereof against biotic and/or abiotic stress or reducing symptoms of biotic and/or abiotic stress in a plant or part thereof, comprising contacting said plant or part thereof with a composition comprising an effective amount of a stress tolerance peptide, polypeptide, heterologous fusion polypeptide, or peptidomimetic.

Aspect 54 is the method of Aspect 53, wherein the part thereof is a leaf, a stem, a seed, a root, a flower, or a fruit.

Aspect 55 is the method of Aspects 53 or 54, wherein the abiotic stress is any or any combination of drought, salt stress, osmotic stress, cold stress, heat stress, great variations in temperature, unseasonable temperature, mechanical stress, extreme wetness, nutrient deficiency, nutrient excess, radiation stress, atmospheric pollution, and soil pollution.

Aspect 56 is the method of any of Aspects 53-55, wherein the stress tolerance peptide, polypeptide, heterologous fusion polypeptide, or peptidomimetic is a synthetic peptide, synthetic polypeptide, heterologous fusion polypeptide, or peptidomimetic of any of Aspects 1-7.

Aspect 57 is the method of any of Aspects 53-56, wherein the stress tolerance peptide, polypeptide, heterologous fusion polypeptide is encoded by the synthetic polynucleotide of Aspect 8.

Aspect 58 is the method of Aspect 53, wherein the stress tolerance peptide is a peptide comprising any of the amino acid sequences depicted in SEQ ID NOS: 1-34.

Aspect 59 is a method for making a transgenic plant, comprising introducing into a cell of a plant a synthetic polynucleotide of Aspect 8, thereby producing a transformed cell, and regenerating a transgenic plant from the transformed cell.

Aspect 60 is a method for making a transgenic plant, comprising introducing into cells of a plant a polynucleotide that comprises a heterologous promoter, thereby producing a cell comprising an insertion of the heterologous promoter upstream of a coding sequence for a stress tolerance protein, wherein expression of the stress tolerance protein is controlled by the foreign promoter, and (b) regenerating a transgenic plant from said cell comprising the insertion.

Aspect 61 is the composition of Aspect 19, comprising ZmPep1 and ZmPep3.

Aspect 62 is the heterologous fusion polypeptide of Aspect 4, comprising one or both of the amino acid sequences depicted in SEQ ID NO: 1 and SEQ ID NO: 3.

Aspect 63 is the heterologous fusion polypeptide of Aspect 4, comprising the amino acid sequence depicted in SEQ ID NO: 1 and any one or more of the amino acid sequences depicted in SEQ ID NOS: 6-34.

Aspect 64 is the heterologous fusion polypeptide of Aspect 4, comprising the amino acid sequence depicted in SEQ ID NO: 3 and any one or more of the amino acid sequences depicted in SEQ ID NOS: 6-34.

Aspect 65 is a synthetic polynucleotide encoding a peptide comprising any one or more of the amino acid sequence depicted in SEQ ID NOS:1-34, wherein the polynucleotide lacks a wild type intron sequence.

Aspect 66 is the synthetic polynucleotide of Aspect 65, operably linked to a heterologous promoter.

Aspect 67 is the synthetic polynucleotide of Aspect 66, wherein the heterologous promoter is a constitutive promoter, a non-constitutive promoter, an organ-specific promoter, a tissue-specific promoter, an inducible promoter, or a stress responsive promoter.

Aspect 68 is a vector comprising the synthetic polynucleotide of Aspect 65.

Aspect 69 is a host cell comprising the vector of Aspect 68.

Aspect 70 is a transgenic plant comprising the synthetic polynucleotide of Aspect 65.

Aspect 71 is a method for making a transgenic plant, comprising introducing into a cell of a plant a synthetic polynucleotide of Aspect 65, thereby producing a transformed cell, and regenerating a transgenic plant from the transformed cell.

The foregoing and other aspects of the preferred embodiments will become more apparent from the following detailed description, accompanying drawings, and the claims.

Unless otherwise defined, all technical and scientific terms used herein have the same meaning as commonly understood by one of ordinary skill in the art. Although methods and materials similar or equivalent to those described herein can be used in the practice or testing of the present embodiments, suitable methods and materials are described below. In addition, the materials, methods, and examples are illustrative only and not intended to be limiting.

### BRIEF DESCRIPTION OF THE DRAWINGS

FIG. 1 is a table that shows the amino acid sequences and public accession numbers of the Zea mays plant elicitor peptide (PEP) family, ZmPep1-ZmPep5, as well as those of exemplary orthologs and paralogs.

### BRIEF DESCRIPTION OF THE SEQUENCE LISTING

SEQ ID NO: 1 represents the Zea mays ZmPep1 amino acid sequence (public accession number GRMZM2G055447).

SEQ ID NO: 2 represents the Zea mays ZmPep2 amino acid sequence (public accession number GRMZM2G177412)

SEQ ID NO: 3 represents the Zea mays ZmPep3 amino acid sequence (public accession number GRMZM2G339117).

SEQ ID NO: 4 represents the Zea mays ZmPep4 amino acid sequence (public accession number GRMZM2G141133).

SEQ ID NO: 5 represents the Zea mays ZmPep5 amino acid sequence (public accession number GRMZM2G141071).

SEQ ID NO: 6 represents the Oryza sativa OsPep1 amino acid sequence (public accession number Os04g54590).

SEQ ID NO: 7 represents the Oryza sativa OsPep2 amino acid sequence (public accession number Os08g07600).

SEQ ID NO: 8 represents the Oryza sativa OsPep3 amino acid sequence (public accession number Os08g07630).

SEQ ID NO: 9 represents the Sorghum bicolor SbPep1 amino acid sequence (public accession number CW229591).

SEQ ID NO: 10 represents the Sorghum bicolor SbPep2 amino acid sequence (public accession number EI692236).

SEQ ID NO: 11 represents the Sorghum bicolor SbPep3 amino acid sequence (public accession number CW315024).

SEQ ID NO: 12 represents the Solanum melongena SmPep1 amino acid sequence (public accession number FS022013).

SEQ ID NO: 13 represents the Capsicum annum CaPep1 amino acid sequence (public accession number CA519466).

SEQ ID NO: 14 represents the Solanum tuberosum StPep1 amino acid sequence (public accession number CV505388).

SEQ ID NO: 15 represents the Glycine max GmPep1 amino acid sequence (public accession number CD401281).

SEQ ID NO: 16 represents the Glycine max GmPep2 amino acid sequence (public accession number FK591447).

SEQ ID NO: 17 represents the Glycine max GmPep3 amino acid sequence (public accession number BE475125).

SEQ ID NO: 18 represents the Medicago truncatula MtPep1 amino acid sequence (public accession number BI311441).

SEQ ID NO: 19 represents the Medicago truncatula MtPep2 amino acid sequence (public accession number CU633466).

SEQ ID NO: 20 represents the Arachis hypogeal AhPep amino acid sequence (public accession number EE126324).

SEQ ID NO: 21 represents a consensus amino acid sequence of defense peptides of embodiments of the invention.

SEQ ID NO: 22 represents a consensus amino acid sequence of defense peptides of embodiments of the invention.

SEQ ID NO: 23 represents a consensus amino acid sequence of defense peptides of embodiments of the invention.

SEQ ID NO: 24 represents a consensus amino acid sequence of defense peptides of embodiments of the invention.

SEQ ID NO: 25 represents the Brassica napus BnPep1 amino acid sequence.

SEQ ID NO: 26 represents the Solanum tuberosum StPep1 amino acid sequence.

SEQ ID NO: 27 represents the Populus balsamifera PbPep1 amino acid sequence.

SEQ ID NO: 28 represents the Betula spp. BePep1 amino acid sequence.

SEQ ID NO: 29 represents the Glycine max GmPep1 amino acid sequence.

SEQ ID NO: 30 represents the Medicago sativa MsPep1 amino acid sequence.

SEQ ID NO: 31 represents the Vitis vinifera VvPep1 amino acid sequence.

SEQ ID NO: 32 represents the Arabidopsis thaliana AtPep1 amino acid sequence.

SEQ ID NO: 33 represents the Populus balsamifera PtPep2 amino acid sequence.

SEQ ID NO: 34 represents the Helianthus annus HaPep2 amino acid sequence.

### DETAILED DESCRIPTION OF VARIOUS EMBODIMENTS OF THE INVENTION

Reference will now be made in detail to various exemplary embodiments of the invention. Embodiments described in the description and shown in the figures are illustrative only and are not intended to limit the scope of the invention, and changes may be made in the specific embodiments described in this specification and accompanying drawings that a person of ordinary skill in the art will recognize are within the scope and spirit of the invention.

The following definitions and methods are provided to better define the preferred embodiments and to guide those of ordinary skill in the art in the practice of the disclosed embodiments. Unless otherwise noted, terms are to be understood according to conventional usage by those of ordinary skill in the relevant art. Definitions of common terms in molecular biology may also be found in Rieger et al., Glossary of Genetics: Classical and Molecular, 5th edition, Springer-Verlag: New York, 1991; and Lewin, Genes V, Oxford University Press: New York, 1994, while nomenclature for DNA bases as set forth at 37 CFR 1.822 is used, which references are incorporated by reference herein in their entireties. The standard one- and three-letter nomenclature for amino acid residues is used.

Polynucleotides.

“Polynucleotide.” The term “polynucleotide” refers to a polymer of nucleotide monomers, including but not limited to ribonucleotides or deoxyribonucleotides or nucleotide analogs. Polynucleotides include, for example, DNA and RNA molecules, including cDNA, genomic DNA, primers, probes, vectors, and so on, and include single- and double-stranded forms thereof. Polynucleotides may be chemically modified by well known methods by labeling, coupling to solid supports, etc.

“Stress Tolerance Peptide (or polypeptide) polynucleotide”. The term “stress tolerance peptide polynucleotide” refers to a polynucleotide that encodes a stress tolerance peptide, and a “stress tolerance polypeptide polynucleotide” refers to a polynucleotide that encodes a stress tolerance polypeptide (i.e., a polypeptide that, when processed in a plant cell, produces a stress tolerance peptide), whether a cDNA or genomic sequence or synthetic (e.g., man made or otherwise not naturally occurring) form thereof. Such polynucleotides may comprise wild type polynucleotides sequences encoding stress tolerance polypeptides, such as ZmPep1 and ZmPep3, operably linked to a heterologous promoter, i.e., a promoter not associated in nature with such native, or wild type, polynucleotide sequences. Alternatively, such polynucleotides may comprise non-naturally occurring recombinant polynucleotides that comprise a sequence that encodes a stress tolerance peptide operably linked to a suitable promoter. For expression of stress tolerance peptides for exogenous application to plants, a stress tolerance peptide polynucleotide may be operably linked to a promoter suitable for expression in a bacterial, fungal, insect, or other suitable cell. For transformation of plants or plant cells or tissues, a stress tolerance peptide may be operably linked to a promoter suitable for expression in a plant cell, i.e., a plant promoter. According to another embodiment, a heterologous promoter may be introduced into a plant or a plant cell or tissue for insertion into the genome, thereby producing an insertion of the promoter upstream of a sequence that encodes a stress tolerance peptide, operably linking the sequence encoding the stress tolerance peptide to the heterologous promoter. Such an expression unit, including the heterologous promoter and the sequence encoding the stress tolerance peptide, is another embodiment of a stress tolerance peptide (or polypeptide) polynucleotide.

“Abiotic stress.” As used herein, “abiotic stress” is defined as the negative impact of non-living factors on the living organisms in a specific environment, and includes but is not limited to any or any combination of drought, oxidative stress, salt stress, osmotic stress, cold stress, heat stress, variations in temperature such as great or extreme variations in temperature, unseasonable temperature, mechanical (e.g. wind) stress, extreme wetness, nutrient deficiency, nutrient excess, radiation stress (e.g. ultraviolet), atmospheric pollution (e.g. ozone), and soil pollution (e.g. heavy metals, herbicides). In other aspects of the invention, the abiotic stress is drought. In still other aspects of the invention, the abiotic stress is high salinity. In additional embodiments of the invention, the abiotic stress is high temperature.

“Biotic stress.” As used herein, “biotic stress” is defined as the result of damage to plants caused by living organisms. Biotic stress factors can for example include bacteria, viruses, fungi, parasites, insects, weeds, and other plants. In some cases, it may be difficult to determine whether a symptom of stress is the result of abiotic or biotic stress, as damage caused by both living organisms and nonliving stress factors can present in a similar manner. For example, browning of leaves may be a symptom of either or both biotic or abiotic stress. Damage to plants caused by pathogens can include for example pathogens from the genera Alternaria, Ascochyta, Aspergillus, Botrytis, Cercospora, Colletotrichum, Diplodia, Erwinia, Erysiphe, Fusarium, Gaeumanomyces, Helminthosporium, Macrophomina, Magnaporthe, Mycosphaerella, Nectria, Peronospora, Phoma, Phymatotrichum, Phytophthora, Plasmopara, Podosphaera, Pseudomonas, Puccinia, Puthium, Pyrenophora, Pyricularia, Pythium, Rhizoctonia, Scerotium, Sclerotinia, Septoria, Thielaviopsis, Uncinula, Venturia, Verticillium, and Xanthomonas to name a few. In some cases, plants can be treated to prevent microbial infections by applying fungi, bacteria, or other microbes to the plant or soil, such as is disclosed in U.S. Pat. No. 7,754,203, which methods and compositions can be used in combination with methods and compositions disclosed in this application, as well as in combination with any microbe, such as one or more fungus or bacteria.

As one of skill in the art would recognize, at any one time, a plant may be exposed to one or more abiotic stresses. (Mittler, R., Trends Plant Sci. 11(1) (2006)). Thus, in some embodiments of the invention, the term abiotic stress refers to a combination of any one or more stresses, including abiotic and/or biotic stresses. Such combinations of stresses include, but are not limited to, drought and high temperature; drought and radiation stress; drought and high salinity; drought and cold temperature; radiation stress, high temperature, and drought; drought, high temperature, and salinity; and the like. Thus, in some particular embodiments, the combination of abiotic stresses is drought and high temperature. In other embodiments, the combination of abiotic stresses is high temperature, radiation stress, and drought. In still further embodiments, the combination of abiotic stresses is radiation stress and drought. In yet other embodiments, the combination of abiotic stresses is cold temperature or chilling and drought.

“Drought.” The term “drought” includes “Meteorological Drought”, “Agricultural Drought”, “Hydrological Drought”, and “Socioeconomic Drought”, as defined in Wilhite, D. A.; and M. H. Glantz (1985), Understanding the Drought Phenomenon: The Role of Definitions, Water International 10(3):111-120, which reference is incorporated by reference herein in its entirety. Meteorological drought is defined usually on the basis of the degree of dryness (in comparison to some “normal” or average amount) and the duration of the dry period, and is typically region-specific. Agricultural drought links various characteristics of meteorological (or hydrological) drought to agricultural impacts, focusing on precipitation shortages, differences between actual and potential evapotranspiration, soil water deficits, reduced groundwater or reservoir levels, and so forth. Hydrological drought is associated with the effects of periods of precipitation (including snowfall) shortfalls on surface or subsurface water supply (i.e., streamflow, reservoir and lake levels, groundwater), and its frequency and severity is often defined on a watershed or river basin scale. Socioeconomic definitions of drought associate the supply and demand of some economic good with elements of meteorological, hydrological, and agricultural drought.

“Native.” The term “native” refers to a naturally-occurring (“wild type”) polynucleotide, polypeptide or peptide.

“Isolated.” An “isolated” polynucleotide is one that has been substantially separated or purified away from other polynucleotide sequences in the cell of the organism in which the polynucleotide naturally occurs, i.e., other chromosomal and extrachromosomal DNA and RNA, by conventional purification methods. The term also embraces recombinant polynucleotides (including promoter insertions operably linked to a stress tolerance peptide gene) and chemically synthesized polynucleotides.

“Heterologous.” A heterologous polynucleotide is one that is not normally present in a particular context. For example, with reference to a cell, tissue or organism, heterologous polynucleotide sequence is one that is not found in such a cell, tissue or organism in nature unless introduced into such cell, tissue or organism. As another example, a heterologous promoter is a promoter not associated in nature with a particular protein coding sequence.

Fragments, Probes, and Primers.

A fragment of a polynucleotide is a portion of a polynucleotide that is less than full-length and comprises at least a minimum length capable of hybridizing specifically with a native polynucleotide sequence under stringent hybridization conditions. The length of such a fragment is preferably at least 15 nucleotides, more preferably at least 20 nucleotides, and most preferably at least 30 nucleotides of a native polynucleotide sequence.

A “probe” is an isolated polynucleotide to which is attached a conventional detectable label or reporter molecule, e.g., a radioactive isotope, ligand, chemiluminescent agent, or enzyme. “Primers” are isolated polynucleotides that are annealed to a complementary target DNA strand by nucleic acid hybridization to form a hybrid between the primer and the target DNA strand, then extended along the target DNA strand by a polymerase, e.g., a DNA polymerase. Primer pairs can be used for amplification of a polynucleotide sequence, e.g., by the polymerase chain reaction (PCR) or other conventional nucleic-acid amplification methods.

Probes and primers are generally 15 nucleotides or more in length, preferably 20 nucleotides or more, more preferably 25 nucleotides, and most preferably 30 nucleotides or more. Such probes and primers hybridize specifically to the target polynucleotide sequence under high stringency hybridization conditions under at least moderately stringent conditions.

Methods for preparing and using probes and primers are described, for example, in Molecular Cloning: A Laboratory Manual, 2nd ed., vol. 1-3, ed. Sambrook et al., Cold Spring Harbor Laboratory Press, Cold Spring Harbor, N.Y., 1989 (hereinafter, “Sambrook et al., 1989”); Current Protocols in Molecular Biology, ed. Ausubel et al., Greene Publishing and Wiley-Interscience, New York, 1992 (with periodic updates) (hereinafter, “Ausubel et al., 1992”); and Innis et al., PCR Protocols: A Guide to Methods and Applications, Academic Press: San Diego, 1990, which references are incorporated by reference herein in their entireties. PCR-primer pairs can be derived from a known sequence, for example, by using computer programs intended for that purpose such-as Primer (Version 0.5, 1991, Whitehead Institute for Biomedical Research, Cambridge, Mass.).

Primers and probes based on the native stress tolerance polypeptide polynucleotide sequences that are disclosed herein can be used to confirm (and, if necessary, to correct) the disclosed polynucleotide sequences by conventional methods, e.g., by re-cloning and re-sequencing.

“Substantial similarity.” A first polynucleotide is “substantially similar” to a second polynucleotide if, when optimally aligned (with appropriate nucleotide insertions or deletions) with the other polynucleotide (or its complementary strand), there is at least about 75% nucleotide sequence identity, preferably at least about 80% identity, more preferably at least about 85% identity, and most preferably at least about 90% identity, such as at least about 91%, 92%, 93%, 94%, 95%, 96%, 97%, 98%, or 99% identity. In embodiments, sequence similarity can be determined by comparing the nucleotide sequences of two polynucleotides using sequence analysis software such as the Sequence Analysis Software Package of the Genetics Computer Group, University of Wisconsin Biotechnology Center, Madison, Wis.

Alternatively or in addition, two polynucleotides are substantially similar if they hybridize under stringent conditions.

“Operably Linked.” A first nucleic-acid sequence is “operably linked” with a second nucleic-acid sequence when the first nucleic-acid sequence is placed in a functional relationship with the second nucleic-acid sequence. For instance, a promoter is operably linked to a coding sequence if the promoter affects the transcription or expression of the coding sequence. Generally, operably linked DNA sequences are contiguous and, where necessary to join two protein coding regions, in reading frame.

“Recombinant.” A “recombinant” polynucleotide is made by an artificial combination of two otherwise separated segments of sequence, e.g., by chemical synthesis or by the manipulation of isolated segments of polynucleotides by genetic engineering techniques. Techniques for nucleic-acid manipulation are well-known (see, e.g., Sambrook et al., 1989, and Ausubel et al., 1992), which reference is incorporated by reference herein in its entirety. Methods for chemical synthesis of polynucleotides are discussed, for example, in Beaucage and Carruthers, Tetra. Letts. 22:1859-1862, 1981, and Matteucci et al., J. Am. Chem. Soc. 103:3185, 1981, which references are incorporated by reference herein in their entireties. Chemical synthesis of polynucleotides can be performed, for example, on commercial automated oligonucleotide synthesizers.

Preparation of Recombinant or Chemically Synthesized Polynucleotides; Vectors, Transformation, Host Cells.

Natural or synthetic polynucleotides according to the present disclosure can be incorporated into recombinant nucleic-acid constructs, typically DNA constructs, capable of introduction into and replication in a host cell. Such a construct preferably is a vector that includes a replication system and sequences that are capable of transcription and translation of a polypeptide-encoding sequence in a given host cell.

For the practice of the present embodiments, conventional compositions and methods for preparing and using vectors and host cells are employed, as discussed, inter alia, in Sambrook et al., 1989, or Ausubel et al., 1992, which is incorporated by reference herein in its entirety.

A cell, tissue, organ, or organism into which has been introduced a foreign polynucleotide, such as a recombinant vector, is considered “transformed”, “transfected”, or “transgenic.” A “transgenic” or “transformed” cell or organism also includes progeny of the cell or organism and progeny produced from a breeding program employing such a “transgenic” plant as a parent in a cross and exhibiting an altered phenotype resulting from the presence of a recombinant polynucleotide construct.

A number of vectors suitable for stable transfection of plant cells or for the establishment of transgenic plants have been described in, e.g., Pouwels et al., Cloning Vectors: A Laboratory Manual, 1985, supp. 1987); Weissbach and Weissbach, Methods for Plant Molecular Biology, Academic Press, 1989; and Gelvin et al., Plant Molecular Biology Manual, Kluwer Academic Publishers, 1990, which references are incorporated by reference herein in their entireties. Typically, plant expression vectors include, for example, one or more cloned plant genes under the transcriptional control of 5′ and 3′ regulatory sequences and a dominant selectable marker. Such plant expression vectors also can contain a promoter regulatory region (e.g., a regulatory region controlling inducible or constitutive, environmentally- or developmentally-regulated, or cell- or tissue-specific expression), a transcription initiation start site, a ribosome binding site, an RNA processing signal, a transcription termination site, and/or a polyadenylation signal.

Examples of constitutive plant promoters include, but are not limited to, the cauliflower mosaic virus (CaMV) 35S promoter, which confers constitutive, high-level expression in most plant tissues (see, e.g., Odel et al., Nature 313:810, 1985), including monocots (see, e.g., Dekeyser et al., Plant Cell 2:591, 1990; Terada and Shimamoto, Mol. Gen. Genet. 220:389, 1990); the nopaline synthase promoter (An et al., Plant Physiol. 88:547, 1988) and the octopine synthase promoter (Fromm et al., Plant Cell 1:977, 1989), which references are incorporated by reference herein in their entireties.

A variety of plant gene promoters that are regulated in response to environmental, hormonal, chemical, and/or developmental signals, also can be used for expression of stress tolerance peptides in plant cells, including promoters regulated by (1) heat (Callis et al., Plant Physiol. 88:965, 1988), (2) light (e.g., pea rbcS-3A promoter, Kuhlemeier et al., Plant Cell 1:471, 1989; maize rbcS promoter, Schaffner and Sheen, Plant Cell 3:997, 1991; or chlorophyll a/b-binding protein promoter, Simpson et al., EMBO J. 4:2723, 1985), (3) hormones, such as abscisic acid (Marcotte et al., Plant Cell 1:969, 1989), (4) wounding (e.g., wunl, Siebertz et al., Plant Cell 1:961, 1989); or (5) chemicals such as methyl jasmonate, salicylic acid, or Safener. It may also be advantageous to employ (6) organ-specific promoters (e.g., Roshal et al., EMBO J. 6:1155, 1987; Schernthaner et al., EMBO J. 7:1249, 1988; Bustos et al., Plant Cell 1:839, 1989) (which references are incorporated by reference herein in their entireties), including promoters that express specifically in the root, leaf, seed, etc.

To minimize the negative effects of transgene overexpression on growth and productivity while improving stress-tolerance of plants, the use of stress-responsive promoters has been demonstrated to be a promising approach (Su et al. (1998) Plant Physiol 117:913-922; Kasuga et al. (1999), Nat Biotechnol 17: 287-291; Garg et al. (2002), Proc Natl Acad Sci USA 99: 15898-15903; Lee et al. (2003), Plant Cell Environ 26: 1181-1190; Fu et al. (2007), Plant Cell Rep (in press)), which references are incorporated by reference herein in their entireties. As used herein, the term “stress-responsive promoter” refers to a promoter that provides a control point for regulated gene transcription in response to an abiotic stress signal. The regulated gene transcription in response to an abiotic stress signal can be achieved by any gene regulation mechanism. For example, a stress-responsive promoter can be involved in gene transcription activated by a signal that is present during an abiotic stress, resulting in gene expression during the abiotic stress. A stress-responsive promoter can also be involved in gene transcription repressed by a signal that is absent during an abiotic stress, thus also resulting in gene expression during the abiotic stress.

Abscisic acid (ABA) regulates the expression of many genes that may function in the adaptation of vegetative tissues to several abiotic stresses as well as in seed maturation and dormancy (Himmelbach et al. (2003), Curr Opin Plant Biol 6: 470-479; Shinozaki et al. (2003), Curr Opin Plant Biol 6: 410-417; Taiz and Zeiger (2006) Chapter 23, In: Plant Physiology, 4th edition. Sinauer Associates, Inc., pp. 594-613; Yamaguchi-Shinozaki and Shinozaki (2006). Annu Rev Plant Biol 57: 781-803). Many ABA-inducible genes contain a conserved ABA responsive cis-acting element with an ACGT core, designated as ABRE or G box, in their promoters (Guiltinan et al. (1990), Science 250:267-271; Skriver et al. (1991), Proc Natl Acad Sci USA 88: 7266-7270; Shen et al. (1993), J Biol Chem 268:23652-23660). Promoter studies of two barley ABA inducible genes, HVA1 and HVA22, indicated that ABRE and another cis-acting coupling element (CE), together forming an ABA response complex (ABRC), are required for high-level ABA-induced gene transcription (Straub et al. (1994), Plant Mol Biol 26: 617-630; Shen and Ho (1995), Plant Cell 7: 295-307; Shen et al. (1996), Plant Cell 8: 1107-1119), which references are incorporated by reference herein in their entireties.

The ABRC from HVA22 (ABRC1) is composed of ABRE3 or A3 and a downstream coupling element CE1 (A3-CE1). The ABRC from HVA1 (ABRC3) is composed of ABRE2 or A2 and an upstream coupling element CE3 (CE3-A2) (Shen et al. (1996), above). Studies with a barley aleurone transient expression assay system indicated that the ABRE3 (A3) from HVA22 is interchangeable with the ABRE2 from HVA1 for conferring ABA inducible response, suggesting that both ABREs could interact with either CE1 from HVA22 or CE3 from HVA1, while CE1 from HVA22 is not fully exchangeable with CE3 from HVA1 (Shen et al. (1996), above). Nevertheless, the presence of both CE1 and CE3 accompanying ABRE2 (A2) or ABRE3 has a synergistic effect on the absolute activity as well as on the ABA induction of a promoter (Shen et al. (1996), above). Furthermore, in both leaves and aleurone tissues, the HVA1 ABRC3 has a higher absolute activity and is more responsive to ABA as compared to the HVA22 ABRC1 (Shen et al. (1996), above).

Both ABRC1 and ABRC3 have been used to control stress-inducible expression of foreign genes in both monocot and dicot transgenic plants. For example, fusion of one or four copies of ABRC 1 to the rice Act1 minimal promoter confers induced expression of a reporter gene in a transgenic rice plant, a monocot plant, by ABA, dehydration or salt (Su et al. (1998), above). Expression of two E. coli trehalose biosynthetic genes in a transgenic rice plant, under the control of a promoter containing four copies of ABRC1, led to accumulation of trehalose and improved growth of these plants under salt, drought and low-temperature stress conditions (Garg et al. (2002), above). Expression of an Arabidopsis transcription factor CBF1 in a transgenic tomato plant, a dicot plant, under the control of a promoter containing three copies of ABRC1 fused to the barley α-amylase gene (Amy64) minimal promoter, has also been shown to improve plant growth under chilling, dehydration and salt conditions, while maintain normal growth and productivity under normal growth conditions (Lee et al. (2003), above). Expression of HVA1 in transgenic creeping bentgrass, under the control of a promoter containing two copies of ABRC3, also led to the accumulation of HVA1 and lessened water-deficit injury in these plants (Fu et al. (2007), above).

Plant expression vectors optionally include RNA processing signals, e.g., introns, which may be positioned upstream or downstream of a polypeptide-encoding sequence in the transgene. In addition, the expression vectors may also include additional regulatory sequences from the 3′-untranslated region of plant genes (Thornburg et al., Proc. Natl. Acad. Sci. USA 84:744 (1987); An et al., Plant Cell 1:115 (1989), which references are incorporated by reference herein in their entireties), for example, a 3′ terminator region to increase mRNA stability of the mRNA, such as the PI-II terminator region of potato or the octopine or nopaline synthase 3′ terminator regions.

Useful dominant selectable marker genes include genes encoding antibiotic resistance genes (e.g., resistance to hygromycin, kanamycin, bleomycin, G418, streptomycin, or spectinomycin); and herbicide resistance genes (e.g., phosphinothricin acetyltransferase). A useful strategy for selection of transformants for herbicide resistance is described, e.g., in Vasil, Cell Culture and Somatic Cell Genetics of Plants, Vols. I-III, Laboratory Procedures and Their Applications Academic Press, New York, 1984, which reference is incorporated by reference herein in its entirety.

An expression vector for expression of a stress tolerance peptide or polypeptide in a plant may also comprise a gene encoding another polypeptide, including a herbicide-tolerance gene (e.g., tolerance to glyphosate, glufosinate, etc.); a polypeptide conferring insect resistance (e.g., a Bacillus thuringensis insecticidal protein or a Xenorhabdus insecticidal protein); a pathogen protein (e.g., virus coat protein); a trait for improving yield, drought resistance, cold tolerance, etc.; a trait for modifying the oil, protein or starch composition of seeds; or another gene that has a desirable activity when expressed in a plant. U.S. Pat. No. 5,571,706, which is incorporated by reference herein in its entirety, describes the introduction of the N gene into tobacco to confer resistance to tobacco mosaic virus; WO 95/28423, which is incorporated by reference herein in its entirety, describes the expression of the Rps2 gene from Arabidopsis thaliana in plants as a means of creating resistance to bacterial pathogens including Pseudomonas syringae; WO 98/02545, which is incorporated by reference herein in its entirety, describes the introduction of the Prf gene into plants to obtain broad-spectrum pathogen resistance; and U.S. Pat. No. 6,762,285, which is incorporated by reference herein in its entirety, describes the expression of the Bs2 resistance proteins in plants to confer resistance to Xanthomonas campestris. Such plant defense genes may also be co-expressed on the same or a different expression vector with a stress tolerance polypeptide or peptide.

Nucleic-Acid Hybridization; “Stringent Conditions”; “Specific”.

The term “stringent conditions” is functionally defined with regard to the hybridization of a nucleic-acid probe to a target polynucleotide (i.e., to a particular nucleic-acid sequence of interest) by the specific hybridization procedure discussed in Sambrook et al., 1989, at 9.52-9.55; see also, Sambrook et al., 1989 at 9.47-9.52, 9.56-9.58; Kanehisa, Nucl. Acids Res. 12:203-213, 1984; and Wetmur and Davidson, J. Mol. Biol. 31:349-370, 1968, which references are incorporated by reference herein in their entireties.

Regarding the amplification of a target nucleic-acid sequence (e.g., by PCR) using a particular amplification primer pair, “stringent conditions” are conditions that permit the primer pair to hybridize only to the target nucleic-acid sequence to which a primer having the corresponding wild type sequence (or its complement) would bind and preferably to produce a unique amplification product.

The term “specific for (a target sequence)” indicates that a probe or primer hybridizes under given hybridization conditions only to the target sequence in a sample comprising the target sequence.

Nucleic-Acid Amplification.

As used herein, “amplified DNA” refers to the product of nucleic-acid amplification of a target nucleic-acid sequence. Nucleic-acid amplification can be accomplished by any of the various nucleic-acid amplification methods known in the art, including the polymerase chain reaction (PCR). A variety of amplification methods are known in the art and are described, inter alia, in U.S. Pat. Nos. 4,683,195 and 4,683,202 and in PCR Protocols: A Guide to Methods and Applications, ed. Innis et al., Academic Press, San Diego, 1990, which references are incorporated by reference herein in their entireties. See also the examples below regarding RT-PCR, for example.

Nucleotide-Sequence Variants of Native Stress Tolerance Polypeptide Polynucleotides and Amino Acid Sequence Variants of Native Stress Tolerance Proteins and Peptides.

Using the nucleotide and the amino-acid sequences disclosed herein, those skilled in the art can create DNA molecules, polypeptides, and peptides that have minor variations in their nucleotide or amino acid sequence, respectively.

“Variant” DNA molecules are DNA molecules containing minor changes in a native sequence, i.e., changes in which one or more nucleotides of a native sequence is deleted, added, and/or substituted, preferably while substantially maintaining a desired biological activity. Variant DNA molecules can be produced, for example, by standard DNA mutagenesis techniques or by chemically synthesizing the variant DNA molecule or a portion thereof. Such variants preferably do not change the reading frame of the protein-coding region of the polynucleotide and preferably encode a protein having no change, only a minor reduction, or an increase in a desired biological activity.

Amino-acid substitutions are preferably substitutions of single amino-acid residues. DNA insertions are preferably of about 1 to 10 contiguous nucleotides and deletions are preferably of about 1 to 30 contiguous nucleotides. Insertions and deletions are preferably insertions or deletions from an end of the protein-coding or non-coding sequence and are preferably made in adjacent base pairs. Substitutions, deletions, insertions or any combination thereof can be combined to arrive at a final construct.

Preferably, variant polynucleotides according are “silent” or “conservative” variants. “Silent” variants are variants of a native sequence or a homolog thereof in which there has been a substitution of one or more base pairs but no change in the amino-acid sequence of the polypeptide or peptide encoded by the sequence. “Conservative” variants are variants of a native (or consensus) sequence in which at least one codon in the protein-coding region of the gene has been changed, resulting in a conservative change in one or more amino acid residues of the encoded polypeptide encoded, i.e., an amino acid substitution. A number of conservative amino acid substitutions are listed below. In addition, one or more codons encoding cysteine residues can be substituted for, resulting in a loss of a cysteine residue and affecting disulfide linkages in the polypeptide.

TABLE 1
Conservative Amino-Acid Substitutions.

| Original Residue | Conservative Substitutions |
|---|---|
| Ala | Ser |
| Arg | Lys |
| Asn | Gln, His |
| Asp | Glu |
| Cys | Ser |
| Gln | Asn |
| Glu | Asp |
| Gly | Pro |
| His | Asn; Gln |
| Ile | Leu; Val |
| Leu | Ile; Val |
| Lys | Arg; Gln; Glu |
| Met | Leu; Ile |
| Phe | Met; Leu; Tyr |
| Ser | Thr |
| Thr | Ser |
| Trp | Tyr |
| Tyr | Trp; Phe |
| Val | Ile; Leu |

Substantial changes in function are made by selecting substitutions that are less conservative than those listed above, e.g., causing changes in one or more of: (a) the structure of the polypeptide backbone in the area of the substitution; (b) the charge or hydrophobicity of the polypeptide at the target site; or (c) the bulk of an amino acid side chain. Substitutions generally expected to produce the greatest changes in protein properties are those in which: (a) a hydrophilic residue, e.g., seryl or threonyl, is substituted for (or by) a hydrophobic residue, e.g., leucyl, isoleucyl, phenylalanyl, valyl, or alanyl; (b) a cysteine or proline is substituted for (or by) any other residue; (c) a residue having an electropositive side chain, e.g., lysyl, arginyl, or histadyl, is substituted for (or by) an electronegative residue, e.g., glutamyl or aspartyl; or (d) a residue having a bulky side chain, e.g., phenylalanine, is substituted for (or by) one not having a side chain, e.g., glycine. Peptides of the invention include any substitution made to the peptides of SEQ ID NOS.: 1-34, such as conservative substitutions, or any other substitution that is not considered a conservative substitution. For example, peptides of the invention include one or more substitution made to a peptide of SEQ ID NOS.: 1-34, by replacing Alanine with an amino acid other than Serine or by replacing Arginine with an amino acid other than Lysine, such as by replacing Alanine or Arginine with Glutamic acid. Additionally, or alternatively, a substitution can be made to a peptide of SEQ ID NOS.: 1-34, by replacing Glycine with an amino acid other than Proline, such as Cysteine.

Polypeptides and Peptides.

For the polypeptide and peptide sequences presented herein, either the three-letter code or the one-letter code may be used for representing amino acid residues, as provided in Table 2 below.

TABLE 2
Three-letter Code and One-letter Code for Amino Acids.

| Amino Acid | Three-Letter Code | One-Letter Code |
|---|---|---|
| Alanine | Ala | A |
| Cysteine | Cys | C |
| Aspartic acid | Asp | D |
| Glutamic acid | Glu | E |
| Phenylalanine | Phe | F |
| Glycine | Gly | G |
| Histidine | His | H |
| Isoleucine | Ile | I |
| Lysine | Lys | K |
| Leucine | Leu | L |
| Methionine | Met | M |
| Asparagine | Asn | N |
| Proline | Pro | P |
| Glutamine | Gln | Q |
| Arginine | Arg | R |
| Serine | Ser | S |
| Threonine | Thr | T |
| Valine | Val | V |
| Tryptophan | Trp | W |
| Tyrosine | Tyr | Y |
| Unknown or Unspecified | Xaa | X |

“Stress Tolerance Polypeptide”; “Stress Tolerance Peptide.”

In general, a peptide is considered a short polypeptide. The term “stress tolerance polypeptide” (or protein) refers to a polypeptide encoded by a stress tolerance protein polynucleotide, including, but not limited to a polynucleotide encoding ZmPep1 and ZmPep3, and other polynucleotides that encode orthologs, paralogs, homologs, equivalogs, fragments, and variants of ZmPep1 and ZmPep3. Stress tolerance peptides result from the processing of a native stress tolerance polypeptide, such as ZmPROPEP1 and ZmPROPEP3, in a plant cell. As a result, a native stress tolerance polypeptide includes sequences in addition to stress tolerance peptide sequences. Recombinant polypeptides that are not processed intracellularly, but that have stress tolerance peptide activity, are also considered stress tolerance polypeptides or peptides.

Recombinant fusion polypeptides may be made that, when processed in a plant cell, result in the production of more than one stress tolerance peptide, or in the production of a stress tolerance peptide and another biologically active polypeptide or peptide.

The term “stress tolerance peptide” refers to a peptide about 10 or more amino acids in length that has substantial stress tolerance peptide activity in an experiment, test, or assay described herein or other experiment, test, or assay for stress tolerance peptide activity. Such stress tolerance peptides may have a length of 11, 12, 13, 14, 15, 16, 17, 18, 19, 20, 21, 22, 23, or more amino acids. ZmPep1 and ZmPep3 are native stress tolerance peptides from Zea mays that are 23 amino acids in length, although sequences within ZmPep1 as short as 10 amino acids are encompassed by the invention, as well as stress tolerance peptides longer than 23 amino acids. The term “stress tolerance peptide” also includes orthologs, paralogs, homologs, equivalogs, fragments, variants, fusion proteins, peptidomimetics, and other derivatives of ZmPep1 and ZmPep3, as well as combinations of any of one or more of these. Stress tolerance peptides up to about 160 amino acid residues, or 100, or 90, or 80, or 70, or 60, or 50, or 40, or 30, or 23, or 20 amino acid residues are included among the stress tolerance peptides disclosed herein.

Stress tolerance peptides may be produced by expression of a polynucleotide that encodes such a peptide intracellularly, e.g., in a plant cell, or in a non-plant cell, e.g., a bacterial, fungal, insect, or other cell used in recombinant production of polypeptides. Alternatively, stress tolerance peptides may be produced by chemical synthesis. Techniques for chemical synthesis of polypeptides are described, for example, in Merrifield, J. Amer. Chem. Soc. 85:2149-2156, 1963, which reference is incorporated by reference herein in its entirety, and peptide synthesizers are commercially available. For chemical synthesis, shorter forms of the stress tolerance peptides are preferable to longer forms, including but not limited to, stress tolerance peptides between about 10 and about 30 amino acids in length.

Polypeptide Sequence Homology.

Ordinarily, stress tolerance peptides encompassed by the present disclosure are at least about 60 percent homologous to a native stress tolerance peptide, including but not limited to ZmPep or ZmPep3, or a dicot or monocot consensus stress tolerance peptide sequence, or at least about 65 percent, 70 percent, 75 percent, 80 percent, 85 percent, 90 percent, or 100 percent (complete) homology, and have substantial stress tolerance peptide activity. Such homology is considered to be “substantial homology,” although more important than shared amino-acid sequence homology is the possession of characteristic structural features and highly conserved amino acid residues from the C-terminal region of native stress tolerance peptides or consensus sequences.

Polypeptide homology is typically analyzed using sequence analysis software such as the Sequence Analysis Software Package of the Genetics Computer Group, University of Wisconsin Biotechnology Center, Madison, Wis.). Polypeptide sequence analysis software matches homologous sequences using measures of homology assigned to various substitutions, deletions, substitutions, and other modifications.

“Isolated,” “Purified,” “Homogeneous” Polypeptides and Peptides.

An “isolated” polypeptide or peptide has been separated from the cellular components (polynucleotides, lipids, carbohydrates, and other polypeptides) that naturally accompany it. Such a polypeptide or peptide can also be referred to as “pure” or “homogeneous” or “substantially” pure or homogeneous. Thus, a polypeptide that is chemically synthesized is isolated. A stress tolerance peptide or polypeptide is also considered “isolated” if it is the product of the expression of a recombinant polynucleotide (even if expressed in a homologous cell type). Thus, if ZmPep1, for example, is recombinantly expressed in a Zea Mays plant, it is considered “isolated” if the polynucleotide that encodes it is under the control of a promoter that is different from the native ZmPep1 promoter, or if the polynucleotide encodes a polypeptide other than the wild type, or native, ZmPep1 polypeptide but, when processed in a plant cell produces a native ZmPep1 peptide, or the ZmPep1 peptide produced by expression of the polynucleotide and processing of the encoded polypeptide differs from that of the native ZmPep1 peptide in any way, for example in length or sequence.

A monomeric polypeptide or peptide is isolated when at least 60% by weight of a sample is composed of the polypeptide or peptide, such as at least 65% by weight, or at least 70% by weight, or at least 75% by weight, or at least 80% by weight, or at least 85% by weight, or at least 90% by weight, or at least 95% or more by weight, such as at least 99% by weight. Protein purity or homogeneity can be indicated, e.g., by polyacrylamide gel electrophoresis of a protein sample, followed by visualization of a single polypeptide band upon staining the polyacrylamide gel; high pressure liquid chromatography; or other conventional methods.

Protein Purification.

The polypeptides and peptides of the present disclosure can be purified by any of the means known in the art. Various methods of protein purification are described, e.g., in Guide to Protein Purification, ed. Deutscher, Meth. Enzymol. 185, Academic Press, San Diego, 1990; and Scopes, Protein Purification: Principles and Practice, Springer Verlag, New York, 1982, which references are incorporated by reference herein in their entireties.

Variant and Modified Forms of Stress Tolerance Peptides and Polypeptides.

Encompassed by the stress tolerance peptides and polypeptides of the present disclosure are variant peptides and polypeptides in which there have been substitutions, deletions, insertions or other modifications of a native (i.e., wild type) peptide or polypeptide. The variants substantially retain structural characteristics and biological activities of a corresponding native peptide or polypeptide and are preferably silent or conservative substitutions of one or a small number of contiguous amino acid residues.

Regarding the terms “paralog” and “ortholog”, homologous polynucleotide sequences and homologous polypeptide sequences may be paralogs or orthologs of the claimed polynucleotide or polypeptide sequence. Orthologs and paralogs are evolutionarily related genes that have similar sequence and similar functions. Orthologs are structurally related genes in different species that are derived by a speciation event. Paralogs are structurally related genes within a single species that are derived by a duplication event. Sequences that are sufficiently similar to one another will be appreciated by those of skill in the art and may be based upon percentage identity of the complete sequences, percentage identity of a conserved domain or sequence within the complete sequence, percentage similarity to the complete sequence, percentage similarity to a conserved domain or sequence within the complete sequence, and/or an arrangement of contiguous nucleotides or peptides particular to a conserved domain or complete sequence. Sequences that are sufficiently similar to one another will also bind in a similar manner to the same DNA binding sites of transcriptional regulatory elements using methods well known to those of skill in the art.

The term “equivalog” describes members of a set of homologous proteins that are conserved with respect to function since their last common ancestor. Related proteins are grouped into equivalog families, and otherwise into protein families with other hierarchically defined homology types. This definition is provided at the Institute for Genomic Research (TIGR) website, “tigr.org” under the heading “Terms associated with TIGRFAMs”.

“Allelic variant” or “polynucleotide allelic variant” refers to any of two or more alternative forms of a gene occupying the same chromosomal locus. Allelic variation arises naturally through mutation, and may result in phenotypic polymorphism within populations. Gene mutations may be “silent” or may encode polypeptides having altered amino acid sequence. The terms “allelic variant” and/or “polypeptide allelic variant” may also be used with respect to polypeptides, and in this case the terms refer to a polypeptide encoded by an allelic variant of a gene.

“Splice variant” or “polynucleotide splice variant” as used in the context of this specification refers to alternative forms of RNA transcribed from a gene. Splice variation naturally occurs as a result of alternative sites being spliced within a single transcribed RNA molecule or between separately transcribed RNA molecules, and may result in several different forms of mRNA transcribed from the same gene. Thus, splice variants may encode polypeptides having different amino acid sequences, which may or may not have similar functions in the organism. “Splice variant” or “polypeptide splice variant” may also refer to a polypeptide encoded by a splice variant of a transcribed mRNA.

As used herein, “polynucleotide variants” may also refer to polynucleotide sequences that encode paralogs and orthologs of the presently disclosed polypeptide sequences. “Polypeptide variants” may refer to polypeptide sequences that are paralogs and orthologs of the presently disclosed polypeptide sequences.

A native stress tolerance peptide or polypeptide sequence can be modified by conventional methods, e.g., by acetylation, carboxylation, phosphorylation, glycosylation, ubiquitination, and labeling, whether accomplished by in vivo or in vitro enzymatic treatment or by the synthesis of a stress tolerance peptide or polypeptide using modified amino acids.

Labeling.

There are a variety of conventional methods and reagents for labeling polypeptides and fragments thereof. Typical labels include radioactive isotopes, ligands or ligand receptors, fluorophores, chemiluminescent agents, and enzymes. Methods for labeling and guidance in the choice of labels appropriate for various purposes are discussed, e.g., in Sambrook et al., 1989 and Ausubel et al., 1992, which reference is incorporated by reference herein in its entirety.

Peptide Fragments.

The present disclosure also encompasses fragments of a stress tolerance peptide that lacks at least one residue of a native full-length stress tolerance peptide. Preferably, such a fragment retains substantial stress tolerance peptide activity, including but not limited to substantial activity in an alkalinization assay and/or the ability to enhance abiotic stress resistance in a plant.

“Stress Tolerance Peptide Activity”; Biological Activity of Polypeptides or Peptides.

The terms “biological activity”, “biologically active”, “activity” and “active” refer primarily to the characteristic biological activity or activities of a native stress tolerance peptide or polypeptide. Stress tolerance peptide activity includes activity in an alkalinization assay. Substantial stress tolerance peptide activity in an alkalinization assay includes a change of at least 0.2 pH units when a 10 microliter aliquot of a solution having a concentration of 25 nM of the peptide is added to 1 mL of plant cells in the assay. More substantial stress tolerance peptide activity in the assay is the observation of a change in pH of at least 0.2 pH units using a solution having concentrations of 2.5 nM or 0.25 nM of the peptide, or when a change of at least 0.5 pH units are observed at a given peptide concentration, or when the activity is at least 25 percent, or 50 percent, or 75 percent that of a native stress tolerance polypeptide.

For the alkalinization assay, cells suspensions can be grown in a volume of 40 ml in a 125 ml flask. Plant cells are typically grown for about 3-21 days, such as from 5-10 days, or from about 7-14 days. Tobacco and Arabidopsis cells for example are typically grown for 3-5 days before use. Tomato cells are typically grown for 4-7 days before use. Soybean cells are generally grown for 3-7 days before use. Preferably, cells are in mid to log or log phase when they are to be used for the alkalinization assay. A 1 ml pipette tip with the end cut off (to prevent clogging of the tip with the cells) is used to aliquot 1 ml of the cells from the suspension into a well in a 24-well culture cluster plate. The flask is swirled between aliquots to ensure that the cells remain evenly dispersed throughout the cell suspension and an roughly equivalent number of cells is provided to each well. The plate(s) are then shaken at 160 rpm for 1 hour. Small aliquots (1-10 ml) of extracted peptide fractions are then added to the wells. After 20 min, the pH of the cell media is measured and recorded.

Alternatively, a substantial stress tolerance peptide activity is the ability to enhance plant stress tolerance and substantially improve yield of plant product, with enhancement of plant stress tolerance evidenced by reduced stress symptoms, etc., when a stress tolerance peptide is applied to a plant exogenously or recombinantly expressed within a plant. A stress tolerance peptide substantially enhances stress tolerance of a plant if it increases the tolerance of a plant to a stress of between 0 and 300% as compared to a control plant under similar conditions, such as at least 2%, or at least 5%, or at least 7%, or at least 10 percent or more substantially, of at least about 15, 20, 25, 30, 35, 40, 45, or 50, 55, 60, 65, 70, or 75, 80, 85, 90, 95, or 100 percent and higher, such from 150-200 percent or from 250-300 percent, or as measured by standard quantitative measures of plant stress tolerance as described further below.

Abiotic stress effects can manifest themselves in various ways and can be recognized by comparing plants exposed to a specific abiotic stress factor whose leaves, stems, roots, flowers, fruit, or seeds have been treated with stress tolerance peptides according to the invention with plants exposed to the same specific abiotic stress factor, but whose leaves, stems, roots, flowers, fruit, or seeds have not been treated with such stress tolerance peptides.

Naturally, the comparison must be carried out under pathogen-free conditions since otherwise the untreated plants might, as the result of infection, display symptoms which correspond to the abiotic stress effects or are similar thereto.

The abiotic stress effect manifests itself for example in that seeds which have been exposed to a specific abiotic stress factor germinate more poorly. Poorer germination means that the same number of seeds gives rise to fewer seedlings in comparison with seeds which have not been exposed to the same specific abiotic stress factor.

Alternatively, or additionally, the abiotic stress effect may manifest itself in reduced emergence. “Emergence” is understood as meaning that the seedling appears from the soil (or, in other words, that the coleoptil or the cotyledons or the shoot or the leaf break through the soil surface). Reduced emergence means that fewer seedlings appear from the soil from the same number of seeds in comparison with other seeds, such as seeds which have not been exposed to the same specific abiotic stress factor or seeds that have not been treated with compositions of the invention. Increased or no change in emergence means that the same or more seedlings appear as compared with other seeds, such as seeds not treated with compositions of the invention or seeds not exposed to the same stress factor.

In some plant species, germination and emergence may coincide, i.e. the first cotyledon already appears from the soil, and thus may be evaluated individually. Since this is not the case with all plants, however, germination and emergence may also be evaluated separately.

Alternatively or in addition, the abiotic stress effect can manifest itself in reduced growth of the hypocotyl, i.e. the stalk does not grow as long as expected, and, possibly, leaves and apex lie on the ground. In some plants, this characteristic is not necessarily disadvantageous since it reduces or prevents lodging; in some plant species, however, it is entirely undesirable.

Alternatively or in addition, the abiotic stress effect can manifest itself in reduced length of the plant's root. A reduced root length implies less nutrient uptake from the soil and less resistance to temperature extremes, in particular drought.

Globally, abiotic stress may manifest itself in diminished vitality of the plants (e.g. plant vigor). A change in vitality, such as diminished vitality, can be ascertained by comparison with other plants, such as with plants whose seeds have not been exposed to the same specific abiotic stress factor. The vitality of a plant manifests itself in a variety of factors. Examples of factors which are manifestations of the plant's vitality are: (a) overall visual appearance; (b) root growth and/or root development; (c) size of the leaf area; (d) intensity of the leaves' green coloration; (e) number of dead leaves in the vicinity of the ground; (f) plant height; (g) plant weight; (h) growth rate; (i) appearance and/or number of fruits; (j) quality of the fruits; (k) plant stand density; (l) germination behavior; (m) emergence behavior; (n) shoot number; (o) shoot type (quality and productivity); (p) toughness of the plant, for example resistance to biotic or abiotic stress; (q) presence of necroses; and/or (r) senescence behavior.

Accordingly, abiotic stress can manifest itself in a worsening of at least one of the abovementioned factors, for example in: (a) a poorer overall visual appearance; (b) poorer root growth and/or poorer root development (see hereinabove); (c) reduced size of the leaf area; (d) less intense green coloration of the leaves; (e) more dead leaves in the vicinity of the ground; (f) lower plant height (“stunting” of the plant, see also hereinabove); (g) lower plant weight; (h) poorer growth rate; (i) poorer appearance and/or lower number of fruits; (j) diminished quality of the fruits; (k) lower plant stand density; (l) poorer germination behavior (see hereinabove); (m) poorer emergence behavior (see hereinabove); (n) fewer shoots; (o) shoots in lower quality (for example weak shoots), less productive shoots; (p) reduced toughness of the plant, for example reduced resistance to biotic or abiotic stress; (q) presence of necroses; and/or (r) poorer senescence behavior (earlier senescence).

Abiotic stress is triggered for example by extreme temperatures such as heat, chill, great variations in temperature, or unseasonal temperatures, drought, extreme wetness, high salinity, radiation (for example increased UV radiation as the result of the diminishing ozone layer), increased amount of ozone in the vicinity of the soil and/or organic and inorganic pollution (for example as the result of phytotoxic amounts of pesticides or contamination with heavy metals). Abiotic stress leads to a reduced quantity and/or quality of the stressed plant and its fruits. Thus, for example, the synthesis and accumulation of proteins is mainly adversely affected by temperature stress, while growth and polysaccharide synthesis are reduced by virtually all stress factors. This leads to biomass losses and to a reduced nutrient content of the plant product. Extreme temperatures, in particular cold and chill, moreover delay germination and emergence of the seedlings and reduce the plant's height and its root length. A delayed germination and emergence often implicates a generally delayed development of the plant and for example a belated ripening. A reduced root length of the plant implies less nutrient uptake from the soil and less resistance to oncoming temperature extremes, in particular drought.

In a preferred embodiment, the polynucleotides, peptides, compositions, and methods of the invention serve for increasing the tolerance of a plant or of a plant's seed to drought.

Alternatively, a substantial stress tolerance peptide activity is present where the peptide, when applied to a plant exogenously or recombinantly expressed within a plant, confers a substantial change in any resistance to an abiotic stress that modulates the jasmonate/ethylene or salicylic acid pathways, or any of the following polypeptides described below, as measured by standard methods.

Yield/Stress tolerance: Yield improvement resulting from improved plant growth and development by helping plants to tolerate stressful growth conditions. Polypeptides that the polynucleotides, peptides, compositions, and methods of the invention may modulate for improved stress tolerance under a variety of stress conditions can include but are not limited to polypeptides involved in gene regulation, such as serine/threonine-protein kinases, MAP kinases, MAP kinase kinases, and MAP kinase kinase kinases; polypeptides that act as receptors for signal transduction and regulation, such as receptor protein kinases; intracellular signaling proteins, such as protein phosphatases, GTP binding proteins, and phospholipid signaling proteins; polypeptides involved in arginine biosynthesis; polypeptides involved in ATP metabolism, including for example ATPase, adenylate transporters, and polypeptides involved in ATP synthesis and transport; polypeptides involved in glycine betaine, jasmonic acid, flavonoid or steroid biosynthesis. Enhanced or reduced activity of such polypeptides in transgenic plants in embodiments may provide changes in the ability of a plant to respond to a variety of abiotic stresses, such as chemical stress, drought stress and pest stress.

Cold tolerance: Polypeptides that the polynucleotides, peptides, compositions, and methods of embodiments of the invention may modulate for improving plant tolerance to cold or freezing temperatures can for example include polypeptides involved in biosynthesis of trehalose or raffinose, polypeptides encoded by cold induced genes, fatty acyl desaturases and other polypeptides involved in glycerolipid or membrane lipid biosynthesis, which find use in modification of membrane fatty acid composition, alternative oxidase, calcium-dependent protein kinases, LEA proteins and uncoupling protein.

Heat tolerance: Polypeptides that the polynucleotides, peptides, compositions, and methods of embodiments of the invention may modulate for improving plant tolerance to heat can for example include polypeptides involved in biosynthesis of trehalose, polypeptides involved in glycerolipid biosynthesis or membrane lipid metabolism (for altering membrane fatty acid composition), heat shock proteins and mitochondrial NDK.

Osmotic tolerance: Polypeptides that the polynucleotides, peptides, compositions, and methods of embodiments of the invention may modulate for improving plant tolerance to extreme osmotic conditions can for example include polypeptides involved in proline biosynthesis.

Drought tolerance: Polypeptides that the polynucleotides, peptides, compositions, and methods of embodiments of the invention may modulate for improving plant tolerance to drought conditions can for example include aquaporins, polypeptides involved in biosynthesis of trehalose or wax, LEA proteins and invertase.

Salt and drought stress signal transduction consist of ionic and osmotic homeostasis signaling pathways. The ionic aspect of salt stress is signaled via the SOS pathway where a calcium-responsive SOS3-SOS2 protein kinase complex controls the expression and activity of ion transporters such as SOS 1. The pathway regulating ion homeostasis in response to salt stress has been reviewed recently by Xiong and Zhu (2002) Plant Cell Environ. 25: 131-139, which reference is incorporated by reference herein in its entirety.

The osmotic component of salt stress involves complex plant reactions that overlap with drought and/or cold stress responses. Indeed, any of the mechanisms of action mentioned in this specification may be possible for a particular application, however, other mechanism may also exist and the invention should be understood as not being limited to any one particular mechanism or the particular mechanisms described.

Common aspects of drought, cold and salt stress response have been reviewed recently by Xiong and Zhu (2002) supra), which include: (a) transient changes in the cytoplasmic calcium levels very early in the signaling event (Knight, (2000) Int. Rev. Cytol. 195: 269-324; Sanders et al. (1999) Plant Cell 11: 691-706); (b) signal transduction via mitogen-activated and/or calcium dependent protein kinases (CDPKs; see Xiong et al., 2002) and protein phosphatases (Merlot et al. (2001) Plant J. 25: 295-303; Tähtiharju and Palva (2001) Plant J. 26: 461-470); (c) increases in abscisic acid levels in response to stress triggering a subset of responses (Xiong et al. (2002) supra, and references therein); (d) inositol phosphates as signal molecules (at least for a subset of the stress responsive transcriptional changes (Xiong et al. (2001) Genes Dev. 15: 1971-1984); (e) activation of phospholipases which in turn generate a diverse array of second messenger molecules, some of which might regulate the activity of stress responsive kinases (phospholipase D functions in an ABA independent pathway, Frank et al. (2000) Plant Cell 12: 111-124); (f) induction of late embryogenesis abundant (LEA) type genes including the CRT/DRE responsive COR/RD genes (Xiong and Zhu (2002) supra); (g) increased levels of antioxidants and compatible osmolytes such as proline and soluble sugars (Hasegawa et al. (2000) Annu. Rev. Plant Mol. Plant Physiol. 51: 463499); and (h) oxidative stress, measured by accumulation of reactive oxygen species such as superoxide, hydrogen peroxide, and hydroxyl radicals (Hasegawa et al. (2000) supra), which references are incorporated by reference herein in their entireties.

Abscisic acid biosynthesis is regulated by osmotic stress at multiple steps. Both ABA-dependent and -independent osmotic stress signaling first modify constitutively expressed transcription factors, leading to the expression of early response transcriptional activators, which then activate downstream stress tolerance effector genes.

Based on the commonality of many aspects of cold, drought and salt stress responses, it can be concluded that genes that increase tolerance to cold or salt stress can also improve drought stress protection. In fact this has already been demonstrated for transcription factors (in the case of AtCBF/DREB1) and for other genes such as OsCDPK7 (Saijo et al. (2000) Plant J. 23: 319-327), or AVP1 (a vacuolar pyrophosphatase-proton-pump, Gaxiola et al. (2001) Proc. Natl. Acad. Sci. USA 98: 11444-11449), which references are incorporated by reference herein in their entireties.

Fusion Polypeptides.

The present disclosure also provides fusion polypeptides including, for example, heterologous fusion polypeptides in which a stress tolerance polypeptide coding sequence is joined to a heterologous promoter (i.e., a promoter from gene other than the promoter that is operably linked to that coding sequence in nature), or in which the coding sequence for the stress tolerance peptide is joined to a fusion partner, i.e., a protein-coding sequence other than sequences with which the coding sequence for the stress tolerance peptide is joined in nature. Such fusion polypeptides can exhibit biological properties (such as substrate or ligand binding, enzymatic activity, antigenic determinants, etc.) derived from each of the fused sequences.

Polypeptide Sequence Determination.

The sequence of a polypeptide of the present disclosure can be determined by any of the various methods known in the art.

Polypeptide Coupling to a Solid-Phase Support.

The polypeptides of the present disclosure can be free in solution or coupled to a solid-phase support, e.g., nitrocellulose, nylon, column packing materials (e.g., Sepharose beads), magnetic beads, or glass wool, by conventional methods.

Antibodies.

The present disclosure also encompasses polyclonal and/or monoclonal antibodies capable of specifically binding to a particular stress tolerance peptide and/or fragments thereof. Such antibodies are raised against a stress tolerance peptide or fragment thereof and are capable of distinguishing a stress tolerance peptide from other polypeptides, i.e., are specific for the particular stress tolerance peptide.

For the preparation and use of antibodies according to the present disclosure, including various immunoassay techniques and applications, see, e.g., Goding, Monoclonal Antibodies: Principles and Practice, 2d ed, Academic Press, New York, 1986; and Harlow and Lane, Antibodies: A Laboratory Manual, Cold Spring Harbor Laboratory, Cold Spring Harbor, N.Y., 1988, which references are incorporated by reference herein in their entireties. Stress tolerance peptide-specific antibodies are useful, for example in: purifying a stress tolerance peptide polypeptide from a biological sample, such as a host cell expressing a recombinant stress tolerance peptide; in cloning a paralog, ortholog, or homolog from an expression library; as antibody probes for protein blots and immunoassays; etc.

Antibodies can be labeled by any of a variety of conventional methods. Suitable labels include, but are not limited to, radionucleotides, enzymes, substrates, cofactors, inhibitors, fluorescent agents, chemiluminescent agents, magnetic particles, etc.

Obtaining Paralogs, Orthologs, and Homologs of Stress Tolerance Peptides.

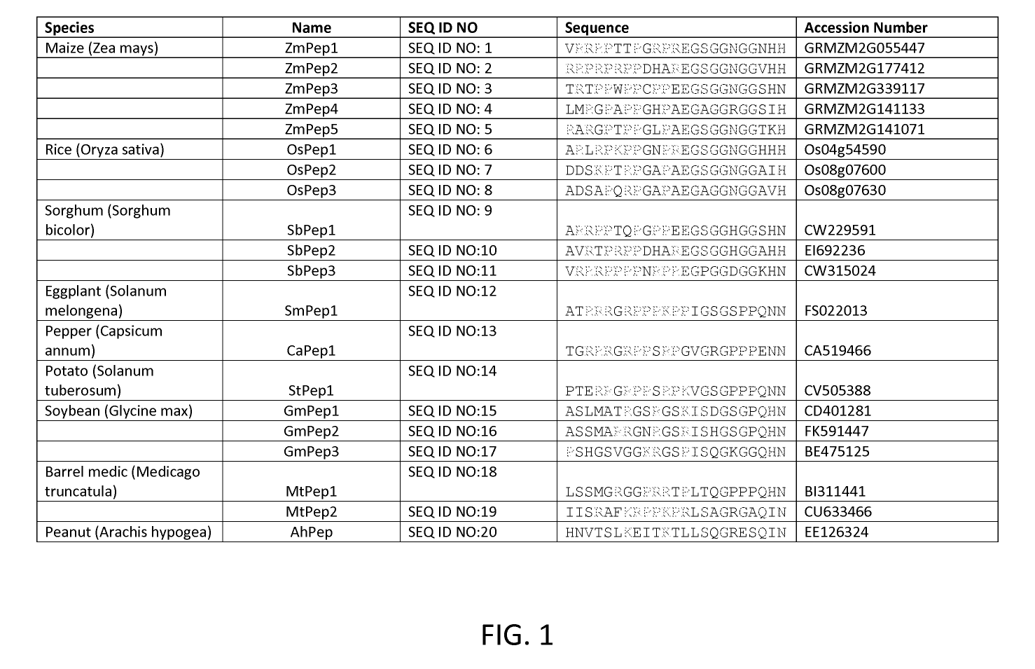

As shown in the table in FIG. 1, stress tolerance peptides homologous to ZmPep1 or ZmPep3 and other stress tolerance peptides exist in many plant species. Based upon the availability of the stress tolerance peptide and polypeptide sequences and their corresponding gene sequences disclosed herein, paralogs and orthologs can be obtained by conventional methods, e.g., by screening a cDNA or genomic library with a probe that specifically hybridizes to a native stress tolerance peptide sequence under at least moderately stringent conditions, by PCR or another amplification method using a primer or primers that specifically hybridize to a native stress tolerance peptide or polypeptide sequence under at least moderately stringent conditions, or by screening an expression library using stress tolerance peptide-specific antibodies.

Obtaining Analogues, Peptidomimetics, and Other Derivatives of Stress Tolerance Peptides.

Various analogues of ZmPep1 and ZmPep3 are encompassed by the stress tolerance peptides of the invention and may be synthesized using solid-phase instrumentation such as a peptide synthesizer. After synthesis, the polypeptides may be purified using C18 reverse-phase, high-performance liquid chromatography (HPLC), as previously described (Pearce and Ryan, J. Biol. Chem. 278:30044-30050, 2003; Pearce et al., Proc. Natl. Acad. Sci. USA 98:12843-12847, 2001; Pearce et al., Nature 411:817-820, 2001; Scheer and Ryan, The Plant Cell 11:1525-1535, 1999; Shevchenko et al., Anal. Chem. 68:850-858, 1996), which references are incorporated by reference herein in their entireties. Substitutions of 1, 2, 3, 4, 5, 6, 7, 8, 9, 10, 11, 12, 13, 14, 15, 16, 17, 18, 19, 20, 21, 22 or more amino acids may be introduced into the secondary structures of ZmPep1 and ZmPep3. Alternatively, one or more amino acids may be introduced on the amino end (N-terminal), the carboxy end (C-terminal), or both. For example, one embodiment of the invention includes a ZmPep1 or ZmPep3 peptide with a cysteine residue added to the n-terminal. Alternatively, one or more amino acids may be inserted into or deleted from the sequences of ZmPep1 and ZmPep3.

Peptidomimetics of the stress tolerance peptides of the invention are also encompassed by embodiments of the invention. As used herein, the term “peptidomimetic” refers to a compound containing non-peptidic structural elements that is capable of mimicking or antagonizing the biological action(s) of a natural parent peptide. In accordance with the invention, peptidomimetics based on ZmPep1 or ZmPep3 may be designed to confer various favorable characteristics such as increased stability, increased solubility, increased protease resistance, or increased bioavailability. For example, ZmPep1 or ZmPep3 may be blocked with a c-terminal acetyl group and n-terminal amide group, modified by cyclization, or modified by pegylation. Similar modifications are well known in the art.

Plant Transformation and Regeneration; Transformed Plant Cells, Plants, and Parts and Products of Transformed Plants.

Various polynucleotide constructs that include a sequence that encodes a stress tolerance polypeptide or a stress tolerance peptide are useful for producing plants having enhanced resistance to abiotic stresses including any or any combination of drought, salt stress, osmotic stress, cold stress, heat stress, great variations in temperature, unseasonable temperature, mechanical (e.g. wind) stress, extreme wetness, nutrient deficiency, nutrient excess, radiation stress (e.g. ultraviolet), atmospheric pollution (e.g. ozone), and soil pollution (e.g. heavy metals, herbicides) or resistance or enhanced resistance to another abiotic stress that involves the jasmonate/ethylene or salicylic acid pathways. In a preferred embodiment, the stress tolerance polypeptide or a stress tolerance peptide is useful for producing plants having enhanced resistance to drought.

Polynucleotides that comprise a sequence that encodes a stress tolerance polypeptide or a stress tolerance peptide can be expressed in plants or plant cells under the control of an operably linked promoter that is capable of expression in the plant or plant cell. Any well-known method can be employed for plant cell transformation, culture, and regeneration in the practice of the present disclosure with regard to a particular plant species. Conventional methods for introduction of foreign DNA into plant cells include, but are not limited to: (1) Agrobacterium-mediated transformation (Lichtenstein and Fuller In: Genetic Engineering, Vol 6, Rigby, ed., London, Academic Press, 1987; and Lichtenstein and Draper, in: DNA Cloning, Vol II, Glover, ed., Oxford, IRI Press, 1985); (2) particle delivery (see, e.g., Gordon-Kamm et al., Plant Cell 2:603, 1990; or BioRad Technical Bulletin 1687), (3) microinjection (see, e.g., Green et al., Plant Tissue and Cell Culture, Academic Press, New York, 1987), (4) polyethylene glycol (PEG) procedures (see, e.g., Draper et al., Plant Cell Physiol. 23:451, 1982); Zhang and Wu, Theor. Appl. Genet. 76:835, 1988), (5) liposome-mediated DNA uptake (see, e.g., Freeman et al., Plant Cell Physiol. 25:1353, 1984), (6) electroporation (see, e.g., Fromm et al., Nature 319:791, 1986); and (7) vortexing method (see, e.g., Kindle, Proc. Natl. Acad. Sci. USA 87:1228, 1990), which references are incorporated by reference herein in their entireties.

Once a transformed plant cell or tissue has been obtained, it is possible to regenerate a full-grown plant from it. Means for regeneration vary from species to species. In one approach a suspension of transformed protoplasts or a petri plate containing transformed explants is first provided. Callus tissue is formed and shoots may be induced from callus and subsequently rooted. Alternatively, embryo formation can be induced in the callus tissue. These embryos germinate as natural embryos to form plants. The culture media will generally contain various amino acids and hormones, such as auxin and cytokinins. Efficient regeneration will depend on the medium, on the genotype, and on the history of the culture. If these three variables are controlled, then regeneration is usually reproducible and repeatable. Plant regeneration is described, for example, in Evans, et al., Handbook of Plant Cell Cultures, Vol. 1: (MacMillan Publishing Co., New York, 1983); and Vasil I. R. (ed.), Cell Culture and Somatic Cell Genetics of Plants, Acad. Press, Orlando, Vol. I, 1984, and Vol. III, 1986), which references are incorporated by reference herein in their entireties. Practically all plants can be regenerated from cultured cells or tissues, including monocots, dicots, gymnosperms, etc.

After the DNA construct is stably incorporated in transgenic plants, it can be transferred to other plants by sexual crosses or by asexual propagation. With respect to sexual crossing, any of a number of standard breeding techniques can be used depending upon the species to be crossed. Cultivars can be propagated in accord with common agricultural procedures known to those in the field.

The term “plant” includes whole plants, shoot vegetative organs/structures (for example, leaves, stems and tubers), roots, flowers and floral organs/structures (for example, bracts, sepals, petals, stamens, carpels, anthers and ovules), seed (including embryo, endosperm, and seed coat) and fruit (the mature ovary), plant tissue (for example, vascular tissue, ground tissue, and the like) and cells (for example, guard cells, egg cells, and the like), and progeny of any of these. The class of plants that can be used in the method of the invention is generally as broad as the class of higher and lower plants amenable to transformation techniques, including angiosperms (monocotyledonous and dicotyledonous plants), gymnosperms, ferns, horsetails, psilophytes, lycophytes, bryophytes, and multicellular algae.

A “control plant” as used in the present invention refers to a plant cell, seed, plant component, plant tissue, plant organ or whole plant used to compare against transgenic or genetically modified plant or treated plant for the purpose of enhancing stress tolerance in the transgenic or genetically modified or treated plant. A control plant may in some cases be a transgenic plant line that comprises an empty vector or marker gene, but does not contain the recombinant polynucleotide of the present invention that is expressed in the transgenic or genetically modified plant being evaluated. In other cases, a control plant may be plant treated with a vehicle that is used to apply a stress tolerance peptide to a treated plant. In general, a control plant is a plant of the same line or variety as the transgenic or genetically modified plant or treated plant being tested. A suitable control plant would include a genetically unaltered or non-transgenic plant of the parental line used to generate a transgenic plant herein.

A “transgenic plant” refers to a plant that contains genetic material not found in a wild-type plant of the same species, variety or cultivar. The genetic material may include a transgene, an insertional mutagenesis event (such as by transposon or T-DNA insertional mutagenesis), an activation tagging sequence, a mutated sequence, a homologous recombination event or a sequence modified by chimeraplasty. Typically, the foreign genetic material has been introduced into the plant by human manipulation, but any method can be used as one of skill in the art recognizes.

A transgenic plant may contain an expression vector or cassette. The expression cassette typically comprises a polypeptide-encoding sequence operably linked (i.e., under regulatory control of) to appropriate inducible or constitutive regulatory sequences that allow for the controlled expression of polypeptide. The expression cassette can be introduced into a plant by transformation or by breeding after transformation of a parent plant. A plant refers to a whole plant as well as to a plant part, such as seed, fruit, leaf, or root, plant tissue, plant cells or any other plant material, e.g., a plant explant, as well as to progeny thereof, and to in vitro systems that mimic biochemical or cellular components or processes in a cell.

“Wild type” or “wild-type”, as used herein, refers to a plant cell, seed, plant component, plant tissue, plant organ or whole plant that has not been genetically modified or treated in an experimental sense. Wild-type cells, seed, components, tissue, organs or whole plants may be used as controls to compare levels of expression and the extent and nature of trait modification with cells, tissue or plants of the same species in which a transcription factor expression is altered, e.g., in that it has been knocked out, overexpressed, or ectopically expressed.

A “trait” refers to a physiological, morphological, biochemical, or physical characteristic of a plant or particular plant material or cell. In some instances, this characteristic is visible to the human eye, such as seed or plant size, or can be measured by biochemical techniques, such as detecting the protein, starch, or oil content of seed or leaves, or by observation of a metabolic or physiological process, e.g. by measuring tolerance to water deprivation or particular salt or sugar concentrations, or by the observation of the expression level of a gene or genes, e.g., by employing Northern analysis, RT-PCR, microarray gene expression assays, or reporter gene expression systems, or by agricultural observations such as hyperosmotic stress tolerance or yield. Any technique can be used to measure the amount of, comparative level of, or difference in any selected chemical compound or macromolecule in the transgenic plants, however.

“Trait modification” refers to a detectable difference in any characteristic, such as morphological characteristics, in a plant ectopically expressing a polynucleotide or polypeptide of the present invention relative to a plant not doing so, such as a wild-type plant. In some cases, the trait modification can be evaluated quantitatively. For example, the trait modification can entail at least about a 2% increase or decrease, or an even greater difference, in an observed trait as compared with a control or wild-type plant. For example, a trait modification in a plant can be characterized by a 1%, 5%, 10%, 15%, 20%, 25%, 30%, 35%, 40%, 45%, 50%, 55%, 60%, 65%, 70%, 75%, 80%, 85%, 95% or higher increase or decrease when compared to a control or wild-type plant. It is known that there can be a natural variation in the modified trait. Therefore, the trait modification observed entails a change of the normal distribution and magnitude of the trait in the plants as compared to control or wild-type plants.

When two or more plants have “similar morphologies”, “substantially similar morphologies”, “a morphology that is substantially similar”, or are “morphologically similar”, the plants have comparable forms or appearances, including analogous features such as overall dimensions, height, width, mass, root mass, shape, glossiness, color, stem diameter, leaf size, leaf dimension, leaf density, internode distance, branching, root branching, number and form of inflorescences, and other macroscopic characteristics, and the individual plants are not readily distinguishable based on morphological characteristics alone. Typically, such morphologic similarity can be characterized by a difference in one or more of these morphologic characteristics ranging from 0-25%, such as from 1-5%, or from about 2-10%, or from about 3-15%, or from about 4-20%, or from about 5-25%, for example.

“Modulates” refers to a change in activity (biological, chemical, or immunological) or lifespan resulting from specific binding between a molecule and either a nucleic acid molecule or a protein.

A “reproductive unit” of a plant is any totipotent part or tissue of the plant from which one can obtain a progeny of the plant, including, for example, seeds, cuttings, tubers, buds, bulbs, somatic embryos, cultured cells (e.g., callus or suspension cultures), etc.

According to one aspect of the disclosure, plant cells are provided that comprise a polynucleotide sequence that comprises a sequence that encodes a stress tolerance peptide or polypeptide operably linked to a plant promoter. Another aspect of the disclosure is directed to plants comprising such cells, i.e., transformed or transgenic plants. Another aspect is a part or product of such plants.

Agronomically and commercially important products and/or compositions of matter derived from transgenic plants or treated plants according to the disclosure include, but are not limited to, animal feed, commodities, products and by-products that are intended for use as food for human consumption or for use in compositions and commodities that are intended for human consumption, including but not limited to plant parts, including but not limited to seeds, seed pods, flowers (including flower buds), fruit, tubers, stems, cuttings, pollen, and products derived from processing such plant parts, including but not limited to flour, meal, syrup, oil, starch, cakes, cereals, and the like. Such compositions may be defined as containing detectable amounts of a polynucleotide sequence as set forth herein, and thus are also diagnostic for any transgenic event containing such nucleotide sequences. These products are more likely to be derived from crops propagated with fewer pesticides and organophosphates as a result of their incorporation of the nucleotides of the present disclosure for protecting plants against abiotic stress. For example, such commodities and commodity products can be produced from seed produced from a transgenic plant, wherein the transgenic plant comprises cells that express a stress tolerance peptide or polypeptide of the present disclosure.

Identifying Transgenic Plants and Parts and Products Thereof.

Transgenic plants according to the present disclosure, parts of such plants, and products derived from the processing of such plants, can be readily identified by using probes and primers to specifically identify the presence of a transgene that encodes a stress tolerance peptide or the presence of a specific stress tolerance peptide. In order to perform such an identification, a biological sample thought to contain such a plant, part or product is contacted with a probe that binds specifically to the transgene containing a stress tolerance peptide- or polypeptide-encoding polynucleotide (such as one or more PCR primers, cDNA probe, etc.), and detecting such binding (e.g., by identifying the production of an amplification product of a diagnostic size after gel electrophoresis, or by autoradiography). Alternatively or in addition, one may use a probe that binds specifically to the stress tolerance peptide or polypeptide itself, such as an antibody probe, wherein binding can be detected by an enzyme-linked immunosorbent assay (ELISA), etc.

Conferring Resistance to Abiotic Stresses to Plants and Enhancing Plant Growth.

As one aspect of the disclosure, resistance to abiotic stress including any or any combination of drought, salt stress, osmotic stress, cold stress, heat stress, great variations in temperature, unseasonable temperature, mechanical stress (e.g. wind), extreme wetness, nutrient deficiency, nutrient excess, radiation stress (e.g. ultraviolet), atmospheric pollution (e.g. ozone), and soil pollution (e.g. heavy metals, herbicides) or to another abiotic stress that involves for example the jasmonate/ethylene pathway or the salicylic acid pathway, is conferred on a plant, or resistance may be enhanced in the plant, or growth of the plant is enhanced, by expression of polynucleotides that encode one or more stress tolerance peptides in cells of the plant. It is important to note that the jasmonate/ethylene pathway or salicylic acid pathway may not always correlate with abiotic stress and that other pathways may alternatively or in addition be involved.

As another aspect of the disclosure, methods are provided that comprise growing a seed into a plant, wherein the plant comprises cells comprising a polynucleotide sequence comprising a sequence that encodes a stress tolerance peptide or polypeptide, wherein the plant exhibits one or more of the following: better stand establishment, improved yield of plant product, increased seedling survival, increased biomass in early development, reduced wilting, reduced senescence, reduced stress symptoms, and enhanced resistance to abiotic stress such as drought, salt stress, osmotic stress, cold stress, heat stress, great variations in temperature, unseasonable temperature, mechanical (e.g. wind) stress, extreme wetness, nutrient deficiency, nutrient excess, radiation stress (e.g. ultraviolet), atmospheric pollution (e.g. ozone), and soil pollution (e.g. heavy metals, herbicides).

According to another aspect of the disclosure, better stand establishment, improved yield of plant product, increased seedling survival, increased biomass in early development, reduced wilting, reduced senescence, reduced stress symptoms, and enhanced resistance to abiotic stress including any or any combination of drought, salt stress, osmotic stress, cold stress, heat stress, great variations in temperature, unseasonable temperature, mechanical (e.g. wind) stress, extreme wetness, nutrient deficiency, nutrient excess, radiation stress (e.g. ultraviolet), atmospheric pollution (e.g. ozone), and soil pollution (e.g. heavy metals, herbicides) is conferred or enhanced, by application of compositions comprising one or more stress tolerance peptides to a plant. In a preferred embodiment, resistance to drought conditions is conferred or enhanced by application of the compositions to a plant.

Where absolute protection against abiotic or other stresses is not to be conferred, the severity of the stress symptoms are reduced and symptom development is delayed. This method of imparting protection has the potential for enhancing plant tolerance to a variety of stresses for which other approaches were ineffective in providing effective control.

The polynucleotides, peptides, compositions, and methods of the present disclosure are useful in imparting tolerance to a wide variety of abiotic stresses including any or any combination of drought, salt stress, osmotic stress, cold stress, heat stress, great variations in temperature, unseasonable temperature, mechanical (e.g. wind) stress, extreme wetness, nutrient deficiency, nutrient excess, radiation stress (e.g. ultraviolet), atmospheric pollution (e.g. ozone), and soil pollution (e.g. heavy metals, herbicides). In a preferred embodiment, the polynucleotides, peptides, compositions, and methods of the present disclosure are particularly useful in imparting tolerance to drought conditions. The following summarizes some of these improved properties and non-limiting examples of polypeptides that the polynucleotides, peptides, compositions, and methods of the present disclosure may modulate in plants.

With regard to the use of the compositions and methods of the present disclosure to enhance plant growth, various forms of plant growth enhancement or promotion can be achieved. This can occur as early as when plant growth begins from seeds or later in the life of a plant. For example, plant growth according to the present disclosure encompasses greater yield, increased percentage of seeds germinated, increased plant size, greater biomass, more and bigger fruit, earlier fruit coloration, earlier flower opening, improved flower longevity (i.e., shelf-life), and earlier fruit and plant maturation. As a result, the present disclosure provides significant economic benefit to growers. For example, early germination and early maturation permit crops to be grown in areas where short growing seasons would otherwise preclude their growth in that locale. Increased percentage of seed germination results in improved crop stands and more efficient seed use. Greater yield, increased size, and enhanced biomass production allow greater revenue generation from a given plot of land.

To confer such enhanced tolerance, one may express a single gene copy, or in order to express a stress tolerance peptide or polypeptide at high levels, e.g., expression of multiple copies of a transgene encoding such a stress tolerance peptide or polypeptide and/or the use of strong promoters to drive expression may be employed. Expression of a transgene encoding a stress tolerance peptide or polypeptide in plant cells at a sufficiently high level may initiate the plant stress response constitutively in the absence of signals from the pathogen. A constitutive plant promoter can be used. Alternatively, an inducible promoter, or an organ- or tissue-specific promoter, or a stress responsive promoter, for example, can be used.

If a plant cell is selected to be transformed, it may be of any type capable of being transformed, preferably one with an agronomic, horticultural, ornamental, economic, or commercial value. Examples of such plant cells include, but are not limited to: acacia, alfalfa, aneth, apple, apricot, artichoke, arugula, asparagus, avocado, banana, barley, beans, beet, blackberry, blueberry, broccoli, brussels sprouts, cabbage, canola, cantaloupe, carrot, cassaya, castorbean, cauliflower, celery, cherry, chicory, cilantro, citrus, clementines, clover, coconut, coffee, corn, cotton, cucumber, Douglas fir, eggplant, endive, escarole, eucalyptus, fennel, figs, garlic, gourd, grape, grapefruit, honey dew, jicama, kiwifruit, lettuce, leeks, lemon, lime, Loblolly pine, linseed, mango, melon, mushroom, nectarine, nut, oat, oil palm, oil seed rape, okra, olive, onion, orange, an ornamental plant, palm, papaya, parsley, parsnip, pea, peach, peanut, pear, pepper, persimmon, pine, pineapple, plantain, plum, pomegranate, poplar, potato, pumpkin, quince, radiata pine, radicchio, radish, rapeseed, raspberry, rice, rye, sorghum, Southern pine, soybean, spinach, squash, strawberry, sugarbeet, sugarcane, sunflower, sweet potato, sweetgum, tangerine, tea, tobacco, tomato, triticale, turf grass, turnip, a vine, watermelon, wheat, yams, and zucchini, as well as miscanthus, switchgrass, and cannabis.

Compositions Comprising Stress Tolerance Peptides for Application to Plants.

According to one embodiment, compositions for application to plants comprise an aqueous solution or an oil flowable suspension, comprising purified stress tolerance peptides or unpurified forms of the peptides, including lysed or unlysed bacterial cells or fractions thereof that contain one or more of the stress tolerance peptides disclosed herein. Any such bacterial host cell expressing the novel polynucleotides disclosed herein and producing a stress tolerance peptide is contemplated to be useful, such as Bacillus spp., including B. thuringiensis, B. megaterium, B. subtilis, B. cereus, Escherichia spp., including E. coli, and/or Pseudomonas spp., including P. cepacia, P. aeruginosa, and P. fluorescens.

In another embodiment, compositions for application to plants comprise a water dispersible granule or powder comprising purified or unpurified stress tolerance peptides.

In another embodiment, compositions for application to plants comprise a wettable powder, spray, emulsion, colloid, aqueous or organic solution, dust, pellet, or colloidal concentrate comprising purified or unpurified stress tolerance peptides. Such dry forms of the insecticidal compositions may be formulated to dissolve immediately upon wetting, or alternatively, dissolve in a controlled-release, sustained-release, or other time-dependent manner. Alternatively, such a composition may consist of a combination of one or more of the following compositions: lysed or unlysed bacterial cells, spores, crystals, and/or purified crystal proteins.

In another embodiment, compositions for application to plants comprise an aqueous solution or suspension comprising purified or unpurified stress tolerance peptides. Such aqueous solutions or suspensions may be provided as a concentrated stock solution which is diluted prior to application, or alternatively, as a diluted solution ready-to-apply.

Such compositions may be formulated in a variety of ways. They may be employed as wettable powders, granules or dusts, by mixing with various inert materials, such as inorganic minerals (phyllosilicates, carbonates, sulfates, phosphates, and the like) or botanical materials (powdered corncobs, rice hulls, walnut shells, and the like). The formulations may include spreader-sticker adjuvants, stabilizing agents, other pesticidal additives, or surfactants. Liquid formulations may be aqueous-based or non-aqueous and employed as foams, suspensions, emulsifiable concentrates, or the like. The ingredients may include rheological agents, surfactants, emulsifiers, dispersants, or polymers. Detergents may be included to facilitate uptake of the stress tolerance peptides by plant tissues and cells.

Regardless of the method of application, the amount of the active component(s) are applied at an amount that is effective to confer enhanced abiotic stress tolerance to plants, which will vary depending on such factors as, for example, the specific stress, the specific plant or crop to be treated, the environmental conditions, and the method, rate, and quantity of application of the composition. The effective amount or concentration of the peptide can be determined and adjusted using routine well-known methods known by the person skilled in the art. Typically, the effective concentration of the peptide ranges from 0.01 to 1.0 g/l. In some cases the effective concentration may range from 0.01 to 0.1 g/l. In other cases, the effective concentration may be range from 0.015 to 0.09 g/l. In other cases the effective concentration may range from 0.02 to 0.08 g/l. In other cases the effective concentration may range from 0.03 to 0.07 g/l. In other cases the effective concentration may range from 0.035 to 0.06 g/l. In other cases the effective concentration may range from 0.04 to 0.05 g/l. In other cases, the effective concentration may range from 0.01 to 0.025 g/l. In other cases, the effective concentration may range from 0.025 to 0.05 g/l. In other cases the effective concentration may range from 0.05 to 0.075 g/l. In other cases the effective concentration may range from 0.075 g/l to 0.10 g/l. In other cases the effective concentration may range from 0.1 to 1.0 g/l. In other cases, the effective concentration may range from 0.15 to 0.9 g/l. In other cases the effective concentration may range from 0.2 to 0.8 g/l. In other cases the effective concentration may range from 0.3 to 0.7 g/l. In other cases the effective concentration may range from 0.35 to 0.6 g/l. In other cases the effective concentration may range from 0.4 to 0.5 g/l. In other cases, the effective concentration may range from 0.1 to 0.25 g/l. In other cases, the effective concentration may range from 0.25 to 0.5 g/l. In other cases the effective concentration may range from 0.5 to 0.75 g/l. In other cases the effective concentration may range from 0.75 g/l to 1.0 g/l. In other cases the effective concentration may range from 0.25 to 25 nM. In other cases the effective concentration may range from 0.25 to 2.5 nM. In other cases the effective concentration may range from 2.5 nM to 25 nM. In other cases the effective concentration may range from 25 nM to 500 μM. In other cases the effective concentration may range from 25 nM to 250 nM. In other cases the effective concentration may range from 250 nM to 2.5 μM. In other cases the effective concentration may range from 2.5 μM to 25 μM. In other cases the effective concentration may range from 25 μM to 100 μM. In other cases the effective concentration may range from 100 μM to 500 μM. Solutions or suspensions comprising effective concentrations of peptide can be made by appropriate dilutions of stock solutions or suspensions with a concentration of about 1.0 g/L to 10 g/L of peptide. Another aspect of the invention comprises a composition comprising a stress tolerance peptide within any of the concentration ranges cited in herein.

Such compositions may be made by formulating purified or unpurified stress tolerance peptides with the desired biologically-acceptable carrier. The compositions may be formulated prior to administration in an appropriate means such as lyophilized, freeze-dried, desiccated, or in an aqueous carrier, medium or suitable diluents(s), such as saline or other buffer, for example. The formulated compositions may be in the form of a dust or granular material, or a suspension in oil (vegetable or mineral), or water or oil/water emulsions, or as a wettable powder, or in combination with any other carrier material suitable for agricultural application. Suitable agricultural carriers can be solid or liquid and are well known in the art.

The term “biologically-acceptable carrier” refers to all carriers that are compatible with the growth and development of a cultured cell or tissue, an excised plant part, a seed, a plant grown under greenhouse or field conditions, or other biological entity, e.g., aqueous solutions, buffers, adjuvants, etc., that are ordinarily used in connection with the biological entity, including but not limited to any carrier used in bacterial or plant cell or tissue culture and agriculturally-acceptable carriers. The term “agriculturally-acceptable carrier” covers all adjuvants, non-limiting examples of which include inert components, surfactants, wetting agents, tackifiers, binders, solvents, diluents, buffering agents, acidifiers, dispersant agents, spreaders and stickers, anti-foaming agents, oils, compatibility agents, penetrants, thickeners, emulsifiers, anti-caking agents, lubricants, drift retardants, ultraviolet radiation filters and/or mixtures thereof that are ordinarily used in formulation technology for compositions used in agriculture to be applied to plants, soils, etc. Surfactants used in agricultural formulations are well known in the art, non-limiting examples of which include alcohol alkoxylates, alkylaryl ethoxylates, fatty amine ethoxylates, or organo-silicones. The formulations may be mixed with one or more solid or liquid adjuvant and prepared by various means, e.g., by homogeneously mixing, blending and/or grinding. Very preferably, the solvent is water.

The compositions can be presented in liquid form or in solid form. For example, in the case of liquid formulations, the composition of the invention may be in the form of a diluted composition ready to be used, or in the form of a concentrated agent, which requires its dilution before being used, typically with water.

In the case of the aqueous liquid compositions, the presence of wetting surfactant agents facilitates the wetting of the plants when they are sprayed with said composition.

An advantage of peptides of embodiments of the invention is that they can be dissolved in water easily, and they can be formulated generally as aqueous solutions without the need to use additional organic solvents.

The compositions in solid form can be in the form of granules or powders, wherein the peptides of the invention are mixed with inert fillers finely divided such as, for example, kaolin, diatomaceous earth, dolomite, calcium carbonate or talc. They can also be presented in the form of dispersible granules or powders, which comprise a wetting agent to facilitate the dispersion thereof in liquid.

Such compositions are applied to the environment of the plant for uptake into plant tissues and cells, typically onto the foliage of the plant or crop to be protected, by conventional methods, such as by spraying. The strength and duration of application will be set with regard to conditions specific to the particular pest(s), crop(s) to be treated and particular environmental conditions. The proportional ratio of active ingredient to carrier will naturally depend on the chemical nature, solubility, and stability of the stress tolerance protein(s), as well as the particular formulation contemplated.

Other application techniques, e.g., dusting, sprinkling, soaking, soil injection, seed coating, seedling coating, spraying, aerating, misting, atomizing, and the like, are also feasible and may be required under certain circumstances.

Particular embodiments of the present invention comprise seed coating and imbibition (e.g. soaking). “Coating” denotes any process that endows the outer surfaces of the seeds partially or completely with a layer or layers of non-plant material, and “imbibition” any process that results in penetration of the active ingredient(s) into the germinable parts of the seed and/or its natural sheath, (inner) husk, hull, shell, pod and/or integument. The invention therefore also relates to a treatment of seeds which comprises providing seeds with a coating that comprises one or more compound or composition of the invention such as one or more defense activators including the stress tolerance peptides used according to the invention, and to a treatment of seeds which comprises imbibition of seeds with one or more defense activator of the invention such as the stress tolerance peptides used according to the invention. In this context, the compounds and compositions for any method of treating described in this specification can include one or more defense activators, including but not limited to, jasmonates, such as methyl jasmonate, methyl dihydrojasmonate, jasmonic acid, and/or derivatives of jasmonates; salicylic acid and derivatives; chitin; acibenzolar-S-methyl; harpins; and defense peptides, especially one or more defense peptides described in this specification.

Coating is particularly effective in accommodating high loads of the stress tolerance peptides, as may be required to treat typically refractory fungal pathogens, while at the same time excessive phytotoxicity is avoided.

Coating may be applied to the seeds using conventional coating techniques and machines, such as fluidized bed techniques, the roller mill method, rotostatic seed treaters, and drum coaters. Other methods such as the spouted beds technique may also be useful. The seeds may be pre-sized before coating. After coating, the seeds are typically dried and then transferred to a sizing machine for sizing.

Such procedures are known in the art. Seed coating methods and apparatus for their application are disclosed in, for example, U.S. Pat. No. 5,918,413, U.S. Pat. No. 5,891,246, U.S. Pat. No. 5,554,445, U.S. Pat. No. 5,389,399, U.S. Pat. No. 5,107,787, U.S. Pat. No. 5,080,925, U.S. Pat. No. 4,759,945 and U.S. Pat. No. 4,465,017, which patents are incorporated by reference herein in their entireties.

Non-germinated seeds, germinating seeds (in water, soil or other growth medium) or propagules can be contacted with any defense activator of the present invention, such as any peptide disclosed in this specification. The peptide, used interchangeably with polypeptide, can be full-length or comprise an amino acid sequence that differs from a wild type amino acid sequence as a result of one or more insertions, deletions, duplications, substitutions, or additions of at least one amino acid, or have additional tags/amino acids connected to the peptide.

The defense activator, such as the peptide, can be applied as a soak for any length of time, or as a spray (or multiple sprays followed by a drying time), vacuum infiltrated or to scarified seeds (thus the peptide/defense activator contacts layers beneath the seed coat). The seed can be planted immediately or dried down for storage prior to germinating in soil or a growth medium. The peptide/defense activator can be applied to seed that has already started the process of germinating.

In embodiments, the defense activators such as peptides can be applied to plant tissues, roots, flowers and/or developing seed on the parent plant. Concentrations of defense activator/peptide applied can be from picomolar concentrations, or 0.1 microgram/L (to seeds, flowers, roots or leaves or any other part of the plant).

In another particular embodiment, the stress tolerance peptides used according to the invention can be mixed directly with seeds, for instance as a solid fine particulate formulation, e.g. a powder or dust. Optionally, a sticking agent can be used to support the adhesion of the solid, e.g. the powder, to the seed surface. For example, a quantity of seed can be mixed with a sticking agent (which increases adhesion of the particles on the surface of the seed) and optionally agitated to encourage uniform coating of the seed with the sticking agent. For example, the seed can be mixed with a sufficient amount of sticking agent, which leads to a partial or complete coating of the seed with sticking agent. The seed pretreated in this way is then mixed with a solid formulation containing the stress tolerance peptides used according to the invention to achieve adhesion of the solid formulation on the surface of the seed material. The mixture can be agitated, for example by tumbling, to encourage contact of the sticking agent with the solid formulation of stress tolerance peptides used according to the invention, thereby causing the stress tolerance peptides used according to the invention to stick to the seed.

Another particular method of treating seed with the stress tolerance peptides used according to the invention is imbibition. For example, seed can be combined for a period of time with an aqueous solution comprising from about 1% by weight to about 75% by weight of the stress tolerance peptides in a solvent such as water. Preferably the concentration of the solution is from about 5% by weight to about 50% by weight, more preferably from about 10% by weight to about 25% by weight. In embodiments, for example, the concentration of the peptide in the aqueous solution can range from 15-90% by weight, or from 2-80% by weight, or from 8-20% by weight, or from 12-18% by weight, or from 22-30% by weight, or from 27-40% by weight, or from 32-45% by weight, or from 55-70% by weight, such as from 60-85% by weight and so on. During the period in which the seed is combined with the solution, the seed takes up (imbibes) at least a portion of the stress tolerance peptides present in the solution. Optionally, the mixture of seed and solution can be agitated, for example by shaking, rolling, tumbling, or other means. After the imbibition process, the seed can be separated from the solution and optionally dried in a suitable manner, for example by patting or air-drying.

In yet another particular embodiment of the present invention, the stress tolerance peptides used according to the invention can be introduced onto or into a seed by use of solid matrix priming. For example, a quantity of the stress tolerance peptides can be mixed with a solid matrix material, and then the seed can be placed into contact with the solid matrix material for a period to allow the stress tolerance peptides to be introduced to the seed. The seed can then optionally be separated from the solid matrix material and stored or used, or, preferably, the mixture of solid matrix material plus seed can be stored or planted/sown directly.

The stress tolerance peptides (this term may be used interchangeably with defense activators throughout this specification and when referring to peptides or polypeptides, this term is also meant to include any of the defense peptides of the invention) may be employed in such compositions singly, in a mixture of stress tolerance peptides, or in combination with other compounds, including and not limited to other proteins or chemical compounds used for treatment of plants, including but not limited to proteins or chemical compounds used to treat plants for pathogens, insect pests, etc. The method may also be used in conjunction with other treatments such as surfactants, detergents, polymers or time-release formulations.

The compositions of the present disclosure may be formulated for either systemic or topical use. The concentration of stress tolerance peptide composition which is used for environmental, systemic, or foliar application will vary widely depending upon the nature of the particular formulation, means of application, environmental conditions, and degree of activity. Typically, the composition will be present in the applied formulation at a concentration of at least about 0.1% by weight and may be up to and including about 99% by weight, such as from 0.2-10%, or from 0.3-15%, or from 0.4-20%, or from 0.5-25%, or from 0.6-30%, or from 0.7-35%, or from 0.8-40% or from 0.9-45%, or from 1-50%, such as from 2-60%, or from 3-65%, or from 4-70%, or from 5-80%, or from 6-85%, or from 7-90%, or from 8-95%, or from 9-98%, or from 10-18%, or from 11-55%, or from 12-75%, or from 13-98%, or from 14-92%, or from 16-84%, and so on. In the context of this specification, where numerical limitations are provided, it is noted that every number included within a recited range is also expressly included. Dry formulations of the compositions may be from about 0.1% to about 99% or more by weight of the composition, while liquid formulations may generally comprise from about 0.1% to about 99% or more of the active ingredient by weight, or any of the recited ranges indicated above.

The formulation may be administered to a particular plant or target area in one or more applications as needed, with a typical field application rate per hectare ranging on the order of from about 0.1 g to about 1 kg, 2 kg, 5 kg, 10 kg or more of active ingredient.

An embodiment of the invention includes a method to prevent and treat plant abiotic stress symptoms comprising contacting a plant with an effective amount of a composition which includes the peptides of the invention.

In an embodiment of a method of the invention, the compositions can be applied in preventive form to the plants to avoid symptoms caused by abiotic stress. Alternatively or in addition, in an embodiment of a method of the invention, the compositions can also be used to treat plant abiotic stress symptoms once their presence has been detected in the plants. Likewise, alternatively or in addition, in an embodiment of a method of the invention, the compositions can also be used to prevent or treat symptoms caused by abiotic stress that are localized or systemic. Even further, in an embodiment of a method of the invention, the compositions can be placed in contact with the parts of the plants selected among the group formed by seeds, roots, stems, leaves or fruit, or with the soil or any method of growth which surrounds the routes of the plants.

In an embodiment of a method of the invention, the compositions can be placed in contact with the plant by any conventional technique, among which are highlighted spraying, immersion or watering. For example, an aqueous solution can be prepared of the peptides of the invention and the parts of the plant affected or susceptible of being affected being sprayed. If they are fruit from a fruit tree, for example, their treatment can also be performed by the spraying or immersion before their harvesting or in the post-harvest.

The treatment of the roots can be carried out, for example, using a solid composition wherein the peptides are dispersed in an inert filler, or by spraying with said aqueous solution or by its application by watering.

The frequency of applying or contacting the plant or part thereof with one or more composition comprising one or more stress tolerance peptide(s) and/or derivatives thereof can be as frequent as necessary to impart the desired effect of increased tolerance to, and/or reduced consequences of, abiotic stress and/or reducing the consequence of abiotic stress. For example, the composition(s) can be contacted with the plant or part thereof one, two, three, four, five, six, seven, or more times per day, one, two, three, four, five, six, seven, eight, nine, ten, or more times per week, one, two, three, four, five, six, seven, eight, nine, ten, or more times per month, and/or one, two, three, four, five, six, seven, eight, nine, ten, or more times per year, as necessary to achieve increased tolerance to abiotic stress. According to embodiments of the invention, compositions can be applied to plants in any manner including alternating application of one or more compositions with the application of other composition(s) to achieve a desired result. Thus, in some embodiments the composition comprising stress tolerance peptide(s) is contacted with the plant or part thereof 1 to 10 times per season, 1 to 11 times per season, 1 to 12 times per season, 1 to 13 times per season, 1 to 14 times per season, 1 to 15 times per season, and the like. In some embodiments, number of days between applications of (i.e., contacting the plant or part thereof with) the stress tolerance peptide(s) and/or derivatives thereof is 1 day to 100 days, 1 day to 95 days, 1 day to 90 days, 1 day to 85 days, 1 day to 80 days, 1 day to 75 days, 1 day to 70 days, 1 day to 65 days, 1 day to 60 days, 1 day to 55 days, 1 day to 50 days, 1 day to 45 days, 1 day to 40 days, and the like, and any combination thereof. In still other embodiments of the present invention, the number of days between applications of the stress tolerance peptide(s) and/or derivatives thereof is 1 day, 4 days, 7 days, 10 days, 13 days, 15 days, 18 days, 20 days, 25, days, 28, days, 30 days, 32, days, 35 days, 38 days, 40 days, 45 days, and the like, and any combination thereof. Accordingly, as one of skill in the art would recognize, the amount and frequency of application or contacting of the compositions of this invention to a plant or part thereof will vary depending on the plant/crop type, the condition of the plant/crop, the abiotic stress or consequences thereof being alleviated and the like. As one of skill in the art would additionally recognize based on the description provided herein, a composition of this invention can be effective for increasing tolerance to abiotic stress and/or reducing the consequence of abiotic stress in a plant or part thereof regardless of whether the initial application of the composition of the present invention is applied to the plant prior to, during, and/or after the initiation of the abiotic stress(es).

Treating plant parts and/or seeds according to embodiments of the invention can be used to produce one or more of the following effects in the plants/seeds: an effect on phenotype, vigor, germination, rate of germination, percent of seeds that germinate, biomass (above-ground or roots), yield, biotic stress tolerance (microbial, herbivore, nematode, fungal, bacterial), abiotic stress tolerance (as stated above), rate of seedling and plant development, rate of maturity, Brix, water content of harvested product, chemical content and concentration of harvested product, yield, photosynthesis, nutrient and mineral and water utilization, chemical composition, chlorophyll level, defense molecule composition, root/seed/leaf exudate (which may impact rhizosphere and biotic or abiotic composition in the soil surrounding roots), volatile emissions, chemical attractants and repellents for other organisms, pollination, staygreen, senescence and necrosis, trichomes, cell wall composition, lignin and cellulose content, post-harvest quality, shelf life, nutritional value/content of the plant derived from treating the seed (or any other part of the plant) such as the nutritional value of harvested plant product, and/or fertility.

Additionally, it is noted that a peptide from one species may be used with another species of plant to activate and/or impact stress tolerance (such as any of the factors listed above) of that plant. For example, cross-activation techniques can be used to apply a corn peptide to a rice, grass or other plant to achieve a desired result.

Identifying Stress Tolerance Peptides.

According to one aspect of the disclosure, methods are provided for identifying native stress tolerance peptides from plants and also for screening synthetic peptides for stress tolerance peptide activity.

A sensitive, rapid “alkalinization assay” (see Examples) is useful for isolate native stress tolerance peptides from plants or synthetic stress tolerance peptides produced by chemical synthesis or other means. Cultured plant cells, for example suspension cell cultures that grow at about pH 5 are used. Several laboratories have developed such cell cultures for Arabidopsis, tomato (Lycopersicon esculentum), tobacco (Nicotiana tabacum), alfalfa (Medicago sativa), maize (Zea mays), petunia (Petunia hybrida), nightshade (Solanum nigrum), and sweet potato (Ipomoea batatus), for example. Within minutes after adding systemin to cells, an ATP-driven proton pump is inhibited, causing the extracellular medium of the cells to become alkaline. When 1-10 μL aliquots from fractions from plant tissues, e.g., leaves, that have eluted from HPLC columns are added to 1 mL of suspension cultured cells, some fractions cause the cell medium to increase in pH. In order to confirm that a candidate peptide is a stress tolerance peptide, the peptide is applied to a plant as described in the Examples below or a polynucleotide sequence encoding the candidate peptide is expressed in a plant in order to observe whether stress tolerance is enhanced in the plant. Confirmation of the identity of a candidate peptide may be obtained by determining whether the peptide induces defense or stress tolerance gene expression (for example, of PDF1.2 and PR-1), e.g., by supplying a solution of the peptide to excised leaves through their cut petioles then analyzing transcript levels, e.g., by semi-quantitative RT-PCR.

Identifying Compounds that Interact with Receptors for Stress Tolerance Proteins and that Enhance Plant Stress Tolerance.

According to another aspect of the disclosure, substances other than peptides and polypeptides, for example, chemical compounds, are screened for their ability to enhance plant tolerance against stresses. In one approach, the alkalinization assay is used to screen such substances. Candidate substances are added to cultured plant cells and a rise in pH indicates that a candidate substance interacts with a receptor. In a second approach, candidate substances are assayed for binding by a ZmPep1 or ZmPep3 receptor or another receptor for a stress tolerance peptide. A composition comprising one or more candidate substances that are selected after being screened in an alkalinization assay or receptor binding assay may then be administered to plants in a greenhouse or field trial to assess whether the candidate substance(s) confer enhanced plant tolerance against an abiotic stress. Substances that have activity in conferring enhanced plant tolerance may be formulated according to standard formulation approaches for application to plants, to seeds, to the soil, etc. The present disclosure also includes compositions comprising an amount of such substances that is effective to enhance plant tolerance against a stress and a biologically (including agriculturally) compatible carrier. Such compositions may also include other ingredients that are used in formulations for application to plants as detailed above.

Preferred embodiments will be better understood by reference to the following examples, which are intended to merely illustrate the best mode now known for practicing the embodiments. The scope of the disclosure is not to be considered limited thereto.

### EXAMPLES

### Compositions and Methods

To further illustrate the invention, the following non-limiting examples describe embodiments of compositions and methods according to the invention.

### Example 1

An exemplary embodiment of a composition according to the invention comprises a stock solution of any one or more of ZmPep1, ZmPep3, or their analogues, homologs, paralogs, orthologs, equivalogs, fragments, variants, peptidomimetics, fusion proteins, or other derivatives at a concentration of 1.0 g/l in water.

### Example 2

An exemplary embodiment of a composition according to the invention comprises a spray solution of any one or more of ZmPep1, ZmPep3, or their analogues, homologs, paralogs, orthologs, equivalogs, fragments, variants, fusion proteins, peptidomimetics, or other derivatives at a concentration of 0.01 g/l in water.

### Example 3

An exemplary embodiment of a composition according to the invention comprises a stock solution comprising purified or isolated ZmPep1 at a concentration of 2.0 g/l and/or purified or isolated ZmPep3 at a concentration of 2.0 g/l in water.

### Example 4

An exemplary embodiment of a composition according to the invention comprises an aqueous stock solution comprising one or more of unpurified ZmPep1, unpurified ZmPep3, or their analogues, homologs, paralogs, orthologs, equivalogs, fragments, fusion proteins, or variants obtained from a lysate of E. coli. bacteria expressing the peptide at a concentration of 2.5 g/l peptide in water.

### Example 5

An exemplary embodiment of a composition according to the invention comprises an aqueous spray solution comprising any one or more of ZmPep1, ZmPep3, or their analogues, homologs, paralogs, orthologs, equivalogs, fragments, variants, fusion proteins, peptidomimetics, or other derivatives at a concentration of 0.05 g/l and the non-ionic surfactant alkylphenol ethoxylate at a concentration of 0.2% v/v.

### Example 6

An exemplary embodiment of a composition according to the invention comprises an aqueous spray solution comprising any one or more of ZmPep1, ZmPep3, or their analogues, homologs, paralogs, orthologs, equivalogs, fragments, variants, fusion proteins, peptidomimetics, or other derivatives at a concentration of 0.02 g/l and the non-ionic surfactant nonylphenol polyethylene glycol ether at a concentration of 0.15% v/v.

### Example 7

An exemplary embodiment of a composition according to the invention comprises a stock suspension comprising any one or more of ZmPep1, ZmPep3, or their analogues, homologs, paralogs, orthologs, equivalogs, fragments, variants, fusion proteins, peptidomimetics, or other derivatives at a concentration of 1 g/l in an emulsified vegetable oil such as CODACIDE (Microcide Limited, Shepherds Grove, Stanton, Bury St. Edmunds, Suffolk IP31 2AR).

### Example 8

An exemplary embodiment of a composition according to the invention comprises an aqueous spray solution comprising any one or more of ZmPep1, ZmPep3, or their analogues, homologs, paralogs, orthologs, equivalogs, fragments, variants, fusion proteins, peptidomimetics, or other derivatives at a concentration of 0.01 g/l and the commercially available non-ionic surfactant ACTIVATOR 90 (Alkylphenol ethoxylate, alcohol ethoxylate and tall oil fatty acid) (Loveland Products, Inc. P.O. Box 1286 Greeley, Colo. 80632) at a concentration of 0.125% v/v.

### Example 9

An exemplary embodiment of a composition according to the invention comprises an aqueous spray solution comprising a 1:50 dilution of the stock solution of Example 7 in water.

### Example 10

An exemplary embodiment of a composition according to the invention is a granule formulation obtained by milling and mixing 5 g of any one or more of ZmPep1, ZmPep3, or their analogues, homologs, paralogs, orthologs, equivalogs, fragments, variants, fusion proteins, peptidomimetics, or other derivatives, 2 g of synthetic hydrated silicon oxide, 2 g of calcium lignin sulfonate, 30 g of bentonite and 62 g of kaolin clay, and then fully kneading the mixture with adding water, followed by granulation and drying of the mixture.

### Example 11

An exemplary embodiment of a composition according to the invention is a powder formulation obtained by milling and mixing 3 g of any one or more of ZmPep1, ZmPep3, or their analogues, homologs, paralogs, orthologs, equivalogs, fragments, variants, fusion proteins, peptidomimetics, or other derivatives, 87 g of kaolin clay and 10 g of talc.

### Example 12

An exemplary embodiment of a composition according to the invention is a wettable powder obtained by mixing 22 g of any one or more of ZmPep1, ZmPep3, or their analogues, homologs, paralogs, orthologs, equivalogs, fragments, variants, fusion proteins, peptidomimetics, or other derivatives, 3 g of calcium lignin sulfonate, 2 g of sodium lauryl sulfate and 73 g of synthetic hydrated silicon oxide.

### Example 13

An exemplary embodiment of a method according to the invention comprises application of a spray solution of Example 6 to stalks and leaves of 5 week old Zea mays var. saccharata using an agricultural sprayer.

### Example 14

An exemplary embodiment of a method according to the invention comprises application of a spray solution of Example 8 to stems and leaves of 4 week old Glycine max (var. A3525) using an agricultural sprayer.

### Experiments

The following non-limiting, examples describe experiments that can be used to identify effective compositions and peptides, further illustrating the effectiveness of the polynucleotides, peptides, compositions, and methods of the invention.

### Example 15

### Alkalinization Assay with Soybean Suspension Cells

Soybean suspension cells, varieties A3525 (AsGrow, Monsanto) and PI 553039 (Davis) are maintained in Murashige and Skoog medium as previously described with tobacco cells (Pearce et al., 2001a). Cultures are maintained by transferring 2.5-5 ml of 15 cells to 40 ml of media every 7 days and shaking at 160 rpm. Soybean suspension cells are used 4-6 days after transfer. Before assaying for alkalinizing activity, a flask of cells is aliquoted into 24-well cell culture cluster plates (1 ml/well) and allowed to equilibrate at 160 rpm until the pH of the cells ceased to decline (approximately 2 hrs).

Aliquots of HPLC fractions or purified ZmPep1 or ZmPep3 peptide, or their analogues, homologs, paralogs, orthologs, equivalogs, fragments, variants, fusion proteins, peptidomimetics, or other derivatives (1-10 μl) are added and the pH is recorded after 15 min.

Alkalinization of the media by the stress tolerance peptides and derivatives tested reveals effective peptides that can be used in embodiments of the invention.

### Example 16

### Alkalinization Assay with Arabidopsis Suspension Cells

Alkalinization Assay. Arabidopsis suspension cells are grown with shaking in the dark in 125 mL flasks, using 40 mL NT media as previously described (Pearce et al., Proc. Natl. Acad. Sci. USA 98:12843-12847, 2001). The cells are transferred weekly (2.5 mL) and used for assays 3-5 days after transfer. One mL aliquots of cells are transferred to wells of 24-well culture plates and allowed to equilibrate for one hour while agitated on a rotary shaker at 160 rpm. Aliquots of 1-10 μL from extracts or fractions eluted from HPLC columns or purified ZmPep1 or ZmPep3 peptide, or their analogues, homologs, paralogs, orthologs, equivalogs, fragments, variants, fusion proteins, peptidomimetics, or other derivatives are added to cells and the pH of the media is monitored after 20 min.

Alkalinization of the media by the stress tolerance peptides and derivatives tested reveals effective peptides that can be used in embodiments of the invention.

### Example 17

### Cold Stress, Heat Stress, Drought Stress, and Ozone Stress Studies in Arabidopsis and Zea mays (Maize)

Plant growth conditions—Arabidopsis. Arabidopsis thaliana ecotype Columbia seeds are grown in soil in four-inch square pots for six days under low light at approximately 18° C. Germinated seedlings are then grown under day lengths of 16 hours at 21° C.

Plant growth conditions—Maize. Seeds of wild-type maize are planted into pots (15×15×20 cm deep) filled with a mixture of vermiculite and sand (11; v/v) and grown in a growth chamber with a 14 h photoperiod at a 25/30° C. night/day temperature cycle, 400 μmol m−2 s−1 irradiance (enhanced with high-pressure sodium lamps), and relative humidity of 60%.

Plant abiotic stress and peptide treatments. Before stress conditions are simulated, 0.01, 0.025, 0.05, 0.075, and 0.1 g/L solutions of ZmPep1 or ZmPep3, or analogues, homologs, paralogs, orthologs, equivalogs, fragments, variants, fusion proteins, peptidomimetics, or other derivatives of ZmPep1 or ZmPep3 are applied daily in 0.1% Triton X-100 (or plain 0.1% Triton X-100 as control) to the upper surface of leaves and the plants are incubated until 4 weeks of age. To examine effects of cold stress, plants are placed in a refrigerated growth chamber set to 2° C. for 12 hours. To simulate drought stress conditions, plants are grown under standard growth chamber conditions are grown without watering for 7 days (Arabidopsis) or 10 days (maize). To simulate heat stress, plants are exposed to elevated temperatures (32° C. day/28° C. night) for 3 days. Simulating ozone exposure, plants are exposed to ozone fumigation of 300 ppb for six hours.

After stress conditions are simulated, treated plants are evaluated for symptoms of cold stress, heat stress, drought stress, and/or ozone stress and compared to control plants. Stress symptoms evaluated can include number of wilted plants, reduced size of the leaf area, lower plant height, lower plant weight, and earlier senescence. Senescence is measured 2, 4, 6, and 8 days after cessation of stress conditions and is indicated by chlorosis and necrosis affecting greater than 50% of an individual leaflet.

Results showing a significant reduction of stress symptoms in plants treated with stress tolerance peptides and derivatives compared to control plants reveal effective compositions and/or peptides that can be used according to embodiments of the invention.

### Example 18

### Salt and Osmotic Stress Studies

Salt and osmotic stress conditions are performed according to the protocol of Zhang et al., Int J Mol Sci. 2013 April; 14(4): 7032-7047, which reference is incorporated by reference herein in its entirety, modified for testing concentrations of peptides. Briefly, for sterilized media growth, seeds of wild-type Arabidopsis thaliana Columbia-o ecotype are surface sterilized with 70% ethanol for 1 min and then with 10% bleach for 5 min before being washed five times with sterilized water. The seeds are germinated and grown on vertically placed petri dishes containing sterilized half strength MS media (pH 5.7), as described in Wang et al. Plant Biol. 2008; 10:548-562, which reference is incorporated by reference herein in its entirety. Uniform 3-day-old plants are transplanted into 1/2 MS media supplemented with 150 mM NaCl or 300 mM sorbitol, and 0, 0.01, 0.025, 0.050, 0.075, and 0.1 g/L ZmPep1 or ZmPep3, or analogues, homologs, paralogs, orthologs, equivalogs, fragments, variants, fusion proteins, peptidomimetics, or other derivatives of ZmPep1 or ZmPep3 and grown for 10 days or 30 days, respectively.

After stress conditions are simulated, treated plants are evaluated for effects of symptoms of salt and osmotic stress and compared to control plants.

Resulting showing a significant reduction of stress symptoms in plants treated with stress tolerance peptides and derivatives compared to control plants are promising active agents.

### Example 19

### UV Stress Studies

Arabidopsis (Arabidopsis thaliana) ecotype Col-0 seedlings are grown on vertical plates [1×LS salts, 0.8% phytoblend (Caisson), 0.6% sucrose] in long-day conditions for 3 days. Half the plants are treated with 0.1 g/L of ZmPep1 or ZmPep3, or analogues, homologs, paralogs, orthologs, equivalogs, fragments, variants, fusion proteins, peptidomimetics, or other derivatives of ZmPep1 or ZmPep3 applied in the media. Half the treated and untreated plants are then irradiated with 600 J m-2 of UV-C using a Model XX-15S UV lamp (UV Products). Plates are rotated by 90°, grown in long-day for an additional 2 days, and then scanned. NIH image is used to measure new root growth beyond the bend and data expressed as relative to unirradiated controls.

Results showing a significant reduction of stress symptoms in plants treated with stress tolerance peptides and derivatives compared to control plants are promising active agents.

### Example 20

### Heavy Metal Stress Studies

Experiments are conducted on Arabidopsis thaliana (var. Col-0) plants. For in vitro experiments, seeds are sterilized in 15% bleach, 0.01% Triton X-100, and sown on half-strength MS medium [0.22% (w/v) Murashige and Skoog basal medium (Sigma #M0404), 0.5% (w/v) sucrose, 0.05% (w/v) MES (pH 5.7), and 0.8% (w/v) agar type A]. After 4 d at 4° C. for stratification, plates are placed in a growth chamber, vertically, under 16 h of day (120 μE m−2 s−1, 56% humidity, 21° C.) and 8 h of night (56% humidity, 20° C.). After 4 d or 7 d, depending on the experiment, plants are transferred to half-strength MS medium with or without Cd (CdNO3), Pb (PbSO₄), or Ni (NiCl₂) at a concentrations of 50 μM and 200 μM. Half the heavy-metal treated plants are treated with 0.1 g/L of ZmPep1 or ZmPep3, or analogues, homologs, paralogs, orthologs, equivalogs, fragments, variants, fusion proteins, peptidomimetics, or other derivatives of ZmPep1 or ZmPep3 applied in the media. After 3-6 more days of growth, root elongation is measured as an indicator of heavy metal stress.

Results showing a significant reduction of stress symptoms in plants treated with stress tolerance peptides and derivatives compared to control plants are promising active agents.

### Example 21

### Phosphate Starvation Studies

Arabidopsis (Arabidopsis thaliana) plants used in this study are derived from the Columbia-0 ecotype. Seeds are surface sterilized and stratified at 4° C. for 3 to 4 days. Plants are grown as follows. Seeds are germinated in a full nutrient Murashige and Skoog (MS) liquid medium in a controlled-environment chamber on a shaker at 25° C. under fluorescent lights (100 μmol m−2 s−1) with a long-day photoperiod (16 h of light). After 2 weeks, plantlets are transferred into Magenta boxes or onto petri plates with MS medium (1.25 mm KH2PO4) containing 2% (w/v) Suc and 0.75% (w/v) phytagar (Murashige and Skoog, 1962) for the indicated periods. This medium is referred to as +P medium. For −P medium, KH2PO4 is omitted from the nutrient solution and the plantlets are rinsed with the same liquid solution prior to transfer. Half the phosphate deprived plants are treated with 0.1 g/L of ZmPep1 or ZmPep3, or analogues, homologs, paralogs, orthologs, equivalogs, fragments, variants, fusion proteins, peptidomimetics, or other derivatives of ZmPep1 or ZmPep3 applied in the medium. The phytagar (commercial grade; Gibco-BRL) contributes about 25 μm total P to the final medium.

After washing with distilled water and mounting in 50% glycerol, root tips are viewed using a Olympus SZX12 stereomicroscope and images are recorded and imported into Photoshop Image software. A portion of the roots are embedded in an epoxy resin (Spurr AR (1969) J Ultrastruct Res 26: 31-43, which reference is incorporated by reference herein in its entirety.). The root tips, from root cap to root hair zone (approximately 2 mm in length), are cut and fixed overnight in 5% (v/v) glutaraldehyde in 0.1 m sodium cacodylate buffer (pH 7.4) at 4° C., postfixed in 1% (w/v) aqueous osmium tetroxide for 3 h at room temperature, and rinsed three times with distilled water. After dehydration through a graded ethanol series, the samples are rinsed in propylene oxide, infiltrated, and embedded in Spurr's resin. Ultrathin sections are cut to a 50- to 70-nm thickness with a diamond knife on a Leica UCT ultramicrotome. The sections are stained with uranyl acetate (2.5%, w/v) and lead citrate. After staining, the sections in the middle longitudinal direction are viewed and photographed using a Philips FEI-Technai 12 transmission electron microscope.

Results showing a significant reduction of stress symptoms in plants treated with stress tolerance peptides and derivatives compared to control plants are preferred.

### Example 22

### Construction of Expression Vectors Containing Polynucleotide Sequences Encoding Stress Tolerance Peptides

Polynucleotide sequences encoding ZmPep1 or ZmPep3, or analogues, homologs, paralogs, orthologs, equivalogs, fragments, variants are amplified using primers specific to sequences upstream and downstream of the coding region for cloning into an expression vector. The expression vector is pMEN20 or pMEN65, which are both derived from pMON316 (Sanders et al. (1987) Nucleic Acids Res. 15:1543-1558, which reference is incorporated by reference herein in its entirety) and contain the CAMV 35S promoter to express transgenes. To clone the sequence into the vector, both pMEN20 and the amplified DNA fragment are digested separately with SalI and NotI restriction enzymes at 37° C. for 2 hours. The digestion products are subject to electrophoresis in a 0.8% agarose gel and visualized by ethidium bromide staining. The DNA fragments containing the sequence and the linearized plasmid are excised and purified by using a QIAQUICK gel extraction kit (Qiagen, Valencia Calif.). The fragments of interest are ligated at a ratio of 3:1 (vector to insert). Ligation reactions using T4 DNA ligase (New England Biolabs, Beverly Mass.) are carried out at 16° C. for 16 hours. The ligated DNAs are transformed into competent cells of the E. coli strain DHSalpha by using the heat shock method. The transformations are plated on LB plates containing 50 mg/l kanamycin (Sigma Chemical Co. St. Louis Mo.). Individual colonies are grown overnight in five milliliters of LB broth containing 50 mg/l kanamycin at 37° C. Plasmid DNA is purified by using Qiaquick Mini Prep kits (Qiagen).

### Example 23

### Transformation of Agrobacterium with the Expression Vectors

After the plasmid vector containing the polynucleotide sequence encoding stress tolerance peptides are constructed, the vector is used to transform Agrobacterium tumefaciens cells expressing the gene products. The stock of Agrobacterium tumefaciens cells for transformation is made as described by Nagel et al. (1990) FEMS Microbiol Letts. 67: 325-328, which reference is incorporated by reference herein in its entirety. Agrobacterium strain ABI is grown in 250 ml LB medium (Sigma) overnight at 28° C. with shaking until an absorbance over 1 cm at 600 nm (A600) of 0.5-1.0 is reached. Cells are harvested by centrifugation at 4,000×g for 15 min at 4° C. Cells are then resuspended in 250 μl chilled buffer (1 mM HEPES, pH adjusted to 7.0 with KOH). Cells are centrifuged again as described above and resuspended in 125 μl chilled buffer. Cells are then centrifuged and resuspended two more times in the same HEPES buffer as described above at a volume of 100 μl and 750 μl respectively. Resuspended cells are then distributed into 40 111 aliquots, quickly frozen in liquid nitrogen, and stored at −80° C.

Agrobacterium cells are transformed with plasmids prepared as described above following the protocol described by Nagel et al. (supra). For each DNA construct to be transformed, 50-100 ng DNA (generally resuspended in 10 mM Tris-HCl, 1 mM EDTA, pH 8.0) is mixed with 40 μl of Agrobacterium cells. The DNA/cell mixture is then transferred to a chilled cuvette with a 2 mm electrode gap and subject to a 2.5 kV charge dissipated at 25 μF and 200 μF using a Gene Pulser II apparatus (Bio-Rad, Hercules, Calif.). After electroporation, cells are immediately resuspended in 1.0 ml LB and allowed to recover without antibiotic selection for 2-4 hours at 28° C. in a shaking incubator. After recovery, cells are plated onto selective medium of LB broth containing 100 μg/ml spectinomycin (Sigma) and incubated for 24-48 hours at 28° C. Single colonies are then picked and inoculated in fresh medium. The presence of the plasmid construct is verified by PCR amplification and sequence analysis.

### Example 24

### Transformation of Arabidopsis Plants with Agrobacterium tumefaciens with Expression Vector

After transformation of Agrobacterium tumefaciens with plasmid vectors containing polynucleotides encoding stress tolerance peptides, single Agrobacterium colonies are identified, propagated, and used to transform Arabidopsis plants. Briefly, 500 ml cultures of LB medium containing 50 mg/l kanamycin are inoculated with the colonies and grown at 28° C. with shaking for 2 days until an optical absorbance at 600 nm wavelength over 1 cm (A600) of >2.0 is reached. Cells are then harvested by centrifugation at 4,000×g for 10 min, and resuspended in infiltration medium (½× Murashige and Skoog salts (Sigma), 1× Gamborg's B-5 vitamins (Sigma), 5.0% (w/v) sucrose (Sigma), 0.044 JIM benzylamino purine (Sigma), 200 μl/l Silwet L-77 (Lehle Seeds) until an A600 of 0.8 is reached.

Prior to transformation, Arabidopsis thaliana seeds (ecotype Columbia) are sown at a density of ^{˜}10 plants per 4″ pot onto Pro-Mix BX potting medium (Hummert International) covered with fiberglass mesh (18 mm×16 mm). Plants are grown under continuous illumination (50-75 μE/m2/sec) at 22-23° C. with 65-70% relative humidity. After about 4 weeks, primary inflorescence stems (bolts) are cut off to encourage growth of multiple secondary bolts. After flowering of the mature secondary bolts, plants are prepared for transformation by removal of all siliques and opened flowers.

The pots are then immersed upside down in the mixture of Agrobacterium infiltration medium as described above for 30 sec, and placed on their sides to allow draining into a 1′×2′ flat surface covered with plastic wrap. After 24 h, the plastic wrap is removed and pots are turned upright. The immersion procedure is repeated one week later, for a total of two immersions per pot. Seeds are then collected from each transformation pot and analyzed following the protocol described below.

### Example 25

### Identification of Arabidopsis Primary Transformants

Seeds collected from the transformation pots are sterilized essentially as follows. Seeds are dispersed into in a solution containing 0.1% (v/v) Triton X-100 (Sigma) and sterile water and washed by shaking the suspension for 20 min. The wash solution is then drained and replaced with fresh wash solution to wash the seeds for 20 min with shaking. After removal of the ethanol/detergent solution, a solution containing 0.1% (v/v) Triton X-100 and 30% (v/v) bleach (CLOROX; Clorox Corp. Oakland Calif.) is added to the seeds, and the suspension is shaken for 10 min. After removal of the bleach/detergent solution, seeds are then washed five times in sterile distilled water. The seeds are stored in the last wash water at 4° C. for 2 days in the dark before being plated onto antibiotic selection medium (1× Murashige and Skoog salts (pH adjusted to 5.7 with 1M KOH), 1× Gamborg's B-5 vitamins, 0.9% phytagar (Life Technologies), and 50 mg/l kanamycin). Seeds are germinated under continuous illumination (50-75 μE/m2/sec) at 22-230 C. After 7-10 days of growth under these conditions, kanamycin resistant primary transformants (T1 generation) are visible and obtained. These seedlings are transferred first to fresh selection plates where the seedlings continued to grow for 3-5 more days, and then to soil (Pro-Mix BX potting medium).

Primary transformants are crossed and progeny seeds (T2) collected; kanamycin resistant seedlings are selected and analyzed. The expression levels of the recombinant polynucleotides in the transformants vary from about a 5% expression level increase to a least a 100% expression level increase, such as from about 10-95%, or from about 15-90%, or from about 20-85%, such as from about 25-80%, or from about 30-75%, or from about 35-70%, or from about 40-65%, such as from about 45-60%, or from about 50-55%, and so on. Similar observations are made with respect to polypeptide level expression.

### Example 26

### Identification of Modified Phenotypes in Overexpression Plants

Experiments are performed to identify those transformants that exhibit an improved abiotic stress tolerance. For such studies, the transformants are exposed to a variety of abiotic stresses.

Germination assays can follow modifications of the same basic protocol. Sterile seeds are sown on the following conditional media. Plates are incubated at 22° C. under 24-hour light (120-130 μEin/m2/s) in a growth chamber. Evaluation of germination and seedling vigor is conducted 3 to 15 days after planting. The basal media is 80% Murashige-Skoog medium (MS)+vitamins.

For salt and osmotic stress experiments, the medium is supplemented with 150 mM NaCl or 300 mM mannitol.

Temperature stress cold germination experiments are carried out at 8° C. Heat stress germination experiments are conducted at 32° C. to 37° C. for 6 hours of exposure.

For stress experiments conducted with more mature plants, seeds are germinated and grown for seven days on MS+vitamins+1% sucrose at 22° C. and then transferred to chilling and heat stress conditions. The plants are either exposed to chilling stress (6 hour exposure to 4-8° C.), or heat stress (32° C. is applied for five days, after which the plants are transferred back 22° C. for recovery and evaluated after 5 days relative to controls not exposed to the depressed or elevated temperature). For drought stress, water is withheld for 168 hours.

The following describes the media for nutrient limitation experiments (nitrogen, phosphate, and potassium) (nitrogen: all components of MS medium remained constant except N is reduced to 20 mg/l of NH4NO3; phosphate: all components of MS medium except KH2PO4, which is replaced by K2SO4; potassium: all components of MS medium except removal of KNO3 and KH2PO4, which are replaced by NaH4PO4).

Results showing a significant reduction of stress symptoms in transgenic plants expressing stress tolerance peptides compared to control plants are of great promise.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Other embodiments of the invention will be apparent to those skilled in the art from consideration of the specification and practice of the invention. The description of the invention provided is merely exemplary in nature and, thus, variations that do not depart from the essence of the invention are intended to be within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A method of seed production comprising:
providing a plant or part thereof;
exposing the plant to a composition comprising one or more defense activators present in a concentration ranging from 0.01 mg/l to 25 g/l or from 0.25 nM to 10 mM and chosen from jasmonates, salicylic acid, chitin, acibenzolar-S-methyl, harpins, microbes, and one or more defense peptides comprising a consensus amino acid sequence: 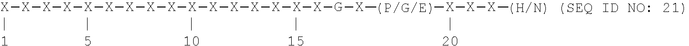
wherein:
X is an amino acid chosen from Alanine (A), Cysteine (C), Aspartic acid (D), Glutamic acid (E), Phenylalanine (F), Glycine (G), Histidine (H), Isoleucine (I), Lysine (K), Leucine (L), Methionine (M), Asparagine (N), Proline (P), Glutamine (Q), Arginine (R), Serine (S), Threonine (T), Valine (V), Tryptophan (W), or Tyrosine (Y);
growing the plant to produce developed seeds from the plant;
wherein the developed seeds comprise one or more defenses induced by the one or more defense activators, which defenses are capable of protecting progeny of the seeds against one or more biotic or abiotic stressors.

2. The method of claim 1, wherein the plant is growing and is developing seeds, or is at a stage of growth prior to developing seeds.

3. The method of claim 1, wherein the stressor is drought and wherein the developed seeds are capable of producing progeny with an increased tolerance to drought as compared with progeny of non-treated seeds.

4. The method of claim 1, wherein the stressor is one or more of salt, cold, UV Stress, heat, overwatering, or biotic stressors and wherein the developed seeds are capable of producing progeny with an increased tolerance to the stressor as compared with progeny of non-treated seeds.

5. The method of claim 1, wherein the exposing comprises applying the composition to one or more of a leaf, stem, seed, propagule, root, flower, or fruit of the plant.

6. The method of claim 5, wherein the exposing comprises applying the composition to a developing seed.

7. The method of claim 1, comprising providing the plant in a planting medium and exposing the planting medium to the composition.

8. The method of claim 7, wherein the plant is a seed and the planting medium is soil.

9. The method of claim 1, wherein the one or more defense activators are jasmonates chosen from one or more of methyl jasmonate, methyl dihydrojasmonate, jasmonic acid, and/or derivatives of jasmonates.

10. The method of claim 1, wherein the exposing of the plant to the composition comprises one or multiple applications of the composition separated by a period of time.

11. The method of claim 1, wherein the concentration ranges from 0.1 g/l to 0.5 g/l.

12. The method of claim 1, wherein the concentration ranges from 0.25 nM to 25 nM.

13. The method of claim 1, wherein the concentration ranges from 25 nM to 500 μM.

14. The method of claim 1, wherein the one or more defense peptides are chosen from ZmPep1, ZmPep2, ZmPep3, ZmPep4, or ZmPep5.

15. The method of claim 14, wherein the one or more defense peptides are chosen from ZmPep1 or ZmPep3.

16. A method of seed production comprising:
providing a plant or part thereof;
exposing the plant to a composition comprising one or more defense activators present in a concentration ranging from 0.01 mg/l to 25 g/l or from 0.25 nM to 10 mM and chosen from jasmonates, salicylic acid, chitin, acibenzolar-S-methyl, harpins, microbes, and one or more defense peptides comprising a consensus amino acid sequence: 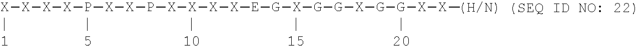
wherein:
X is an amino acid chosen from Alanine (A), Cysteine (C), Aspartic acid (D), Glutamic acid (E), Phenylalanine (F), Glycine (G), Histidine (H), Isoleucine (I), Lysine (K), Leucine (L), Methionine (M), Asparagine (N), Proline (P), Glutamine (Q), Arginine (R), Serine (S), Threonine (T), Valine (V), Tryptophan (W), or Tyrosine (Y);
or exposing the plant to a 10, 11, 12, 13, 14, 15, 16, 17, 18, 19, 20, 21, or 22 amino acid fragment of the sequence;
growing the plant to produce developed seeds from the plant;
wherein the developed seeds comprise one or more defenses induced by the one or more defense activators, which defenses are capable of protecting progeny of the seeds against one or more biotic or abiotic stressors.

17. A method of seed production comprising:
providing a plant or part thereof;
exposing the plant to a composition comprising one or more defense activators present in a concentration ranging from 0.01 mg/l to 25 g/l or from 0.25 nM to 10 mM and chosen from jasmonates, salicylic acid, chitin, acibenzolar-S-methyl, harpins, microbes, and one or more defense peptides comprising a consensus amino acid sequence: 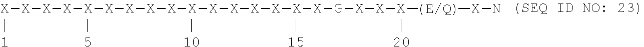
wherein:
residue 7 and 11 are independently Lysine, Glycine, or Arginine;
residue 12 is Threonine, Proline, or Serine;
residue 14 is Leucine, Isoleucine, or Valine;
residue 15 is Serine, Threonine, Glycine;
residue 19 is Glutamic acid, Glycine, or Proline; and
residue 22 is Histidine, Isoleucine, or Asparagine;
X is an amino acid chosen from Alanine (A), Cysteine (C), Aspartic acid (D), Glutamic acid (E), Phenylalanine (F), Glycine (G), Histidine (H), Isoleucine (I), Lysine (K), Leucine (L), Methionine (M), Asparagine (N), Proline (P), Glutamine (Q), Arginine (R), Serine (S), Threonine (T), Valine (V), Tryptophan (W), or Tyrosine (Y);
or exposing the plant to a 10, 11, 12, 13, 14, 15, 16, 17, 18, 19, 20, 21, or 22 amino acid fragment of the sequence;
growing the plant to produce developed seeds from the plant;
wherein the developed seeds comprise one or more defenses induced by the one or more defense activators, which defenses are capable of protecting progeny of the seeds against one or more biotic or abiotic stressors.

18. The method of claim 17, wherein the one or more defense peptides are chosen from GmPep1, GmPep2, or GmPep3.

19. The method of claim 1, wherein the plant is exposed to one or more microbe.

20. The method of claim 19, wherein the composition comprises the one or more microbe, and wherein the one or more microbe is one or more fungus or bacteria.


SEQUENCE LISTING (34 sequences)

SEQ ID NO: 1 - protein, 23 aa, Zea mays
VRRRPTTPGRPREGSGGNGGNHH

SEQ ID NO: 2 - protein, 23 aa, Zea mays
RRPRPRPPDHAREGSGGNGGVHH

SEQ ID NO: 3 - protein, 23 aa, Zea mays
TRTPPWPPCPPEEGSGGNGGSHN

SEQ ID NO: 4 - protein, 23 aa, Zea mays
LMRGPAPPGHPAEGAGGRGGSIH

SEQ ID NO: 5 - protein, 23 aa, Zea mays
RARGPTPPGLPAEGSGGNGGTKH

SEQ ID NO: 6 - protein, 23 aa, Oryza sativa
ARLRPKPPGNPREGSGGNGGHHH

SEQ ID NO: 7 - protein, 23 aa, Oryza sativa
DDSKPTRPGAPAEGSGGNGGAIH

SEQ ID NO: 8 - protein, 23 aa, Oryza sativa
ADSAPQRPGAPAEGAGGNGGAVH

SEQ ID NO: 9 - protein, 23 aa, Sorghum bicolor
ARRPPTQPGPPEEGSGGHGGSHN

SEQ ID NO: 10 - protein, 23 aa, Sorghum bicolor
AVRTPRPPDHAREGSGGHGGAHH

SEQ ID NO: 11 - protein, 23 aa, Sorghum bicolor
VRRRPPPPNRPREGPGGDGGKHN

SEQ ID NO: 12 - protein, 23 aa, Solanum melongena
ATRRRGRPPPKPPIGSGSPPQNN

SEQ ID NO: 13 - protein, 23 aa, Capsicum annuum
TGRRRGRPPSRPGVGRGPPPENN

SEQ ID NO: 14 - protein, 23 aa, Solanum tuberosum
PTERRGRPPSRPKVGSGPPPQNN

SEQ ID NO: 15 - protein, 23 aa, Glycine max
ASLMATRGSRGSKISDGSGPQHN

SEQ ID NO: 16 - protein, 23 aa, Glycine max
ASSMARRGNRGSRISHGSGPQHN

SEQ ID NO: 17 - protein, 23 aa, Glycine max
PSHGSVGGKRGSPISQGKGGQHN

SEQ ID NO: 18 - protein, 23 aa, Medicago truncatula
LSSMGRGGPRRTPLTQGPPPQHN

SEQ ID NO: 19 - protein, 23 aa, Medicago truncatula
IISRAFKRPPKPRLSAGRGAQIN

SEQ ID NO: 20 - protein, 23 aa, Arachis hypogaea
HNVTSLKEITKTLLSQGRESQIN

SEQ ID NO: 21 - protein, 23 aa, Artificial Sequence
  synthetic
XXXXXXXXXXXXXXXXGXXXXXX

SEQ ID NO: 22 - protein, 23 aa, Artificial Sequence
  synthetic
XXXXPXXPXXXXEGXGGXGGXXX

SEQ ID NO: 23 - protein, 23 aa, Artificial Sequence
  synthetic
XXXXXXXXXXXXXXXXGXXXXXN

SEQ ID NO: 24 - protein, 23 aa, Artificial Sequence
  synthetic
XXXXXXXXXXXXXXSSGXXXQXN

SEQ ID NO: 25 - protein, 22 aa, Brassica napus
VARLTRRRPRPPYSSGQPGQIN

SEQ ID NO: 26 - protein, 23 aa, Solanum tuberosum
PTERRGRPPSRPKVGSGPPPQNN

SEQ ID NO: 27 - protein, 23 aa, Populus balsamifera
DAAVSALARRTPPVSRGGGGQTN

SEQ ID NO: 28 - protein, 23 aa, Betula spp.
DLVMAVNAPPRPSLTPGSGAQIN

SEQ ID NO: 29 - protein, 23 aa, Glycine max
ASLMATRGSRGSKISDGSGPQHN

SEQ ID NO: 30 - protein, 23 aa, Medicago sativa
LSSMGRGGPRRTPLTQGPPPQHN

SEQ ID NO: 31 - protein, 23 aa, Vitis vinifera
EKVREKQKKGEDGESVGRPGKKN

SEQ ID NO: 32 - protein, 23 aa, Arabidopsis thaliana
ATKVKAKQRGKEKVSSGRPGQHN

SEQ ID NO: 33 - protein, 23 aa, Populus balsamifera
AVTVSALARRTPPVSSGSGGQIN

SEQ ID NO: 34 - protein, 23 aa, Helianthus annuus
RGLTRRPPPPRGPISSGGGGQTN